(19) United States
(12) Patent Application Publication
(10) Pub. No.: US 2021/0257658 A1
(43) Pub. Date: Aug. 19, 2021

(54) SOLID-STATE LI-S BATTERIES AND METHODS OF MAKING SAME

(71) Applicant: UNIVERSITY OF MARYLAND, COLLEGE PARK, College Park, MD (US)

(72) Inventors: Eric D. WACHSMAN, Fulton, MD (US); Liangbing HU, Hyattsville, MD (US); Chunsheng WANG, Silver Spring, MD (US); Yang WEN, Hyattsville, MD (US); Kun FU, College Park, MD (US); Fudong HAN, Greenbelt, MD (US); Chengwei WANG, College Park, MD (US); Venkataraman THANGADURAI, Calgary (CA); Gregory Thomas HITZ, Riverdale Park, MD (US); Dennis MCOWEN, Bowie, MD (US)

(73) Assignee: UNIVERSITY OF MARYLAND, COLLEGE PARK, College Park, MD (US)

(21) Appl. No.: 17/184,500

(22) Filed: Feb. 24, 2021

Related U.S. Application Data
(63) Continuation-in-part of application No. 15/779,930, filed on May 30, 2018, now abandoned.
Application No. 15/779,930 is a continuation-in-part of application No. 16/882,536, filed on May 24, 2020.
Application No. 16/882,536 is a continuation-in-part of application No. 16/847,582, filed on Apr. 13, 2020.
Application No. 16/847,582 is a continuation-in-part of application No. 14/222,306, filed on Mar. 21, 2014, now Pat. No. 10,622,666.
Application No. 14/222,306 is a continuation-in-part of application No. 16/847,582, filed on Apr. 13, 2020.
Application No. 16/847,582 is a continuation-in-part of application No. 15/364,528, filed on Nov. 30, 2016, now abandoned.
(60) Provisional application No. 62/260,955, filed on Nov. 30, 2015.
(60) Provisional application No. 62/852,442, filed on May 24, 2019.
(60) Provisional application No. 61/803,981, filed on Mar. 21, 2013.
(60) Provisional application No. 62/260,817, filed on Nov. 30, 2015.

(51) Int. Cl. H01M 10/0562; H01M 10/0525; H01M 4/134; H01M 4/62; H01M 10/058

(52) U.S. Cl. CPC H01M 10/0562; H01M 10/0525; H01M 4/134; H01M 2004/027; H01M 10/058; H01M 2300/0071; H01M 4/625

(57) ABSTRACT

Disclosed is a method of fabricating a battery or battery component having a solid state electrolyte. A scaffold is provided, the scaffold comprising: a dense central layer comprising a dense electrolyte material, the dense central layer having a first surface, and a second surface opposite the first surface; a first porous layer comprising a first porous electrolyte material, the first porous layer disposed on the first surface of the dense central layer, the porous electrolyte material having a first network of pores therein; wherein each of the dense electrolyte material and the first porous electrolyte material are independently selected from garnet materials. Carbon is infiltrated into the first porous layer. Sulfur is also infiltrated into the first porous layer. The battery component may be used in a variety of battery configurations.

### CROSS-REFERENCE TO RELATED APPLICATIONS

This application is a continuation-in-part of U.S. patent application Ser. No. 15/779,930, filed on May 30, 2018, which is a national phase of PCT/US2016/064232, filed on Nov. 30, 2016, which claims the benefit of U.S. Provisional Appl. No. 62/260,955, filed on Nov. 30, 2015; this application is also a continuation-in-part of U.S. patent application Ser. No. 16/882,536, filed on May 24, 2020, which is a non-provisional of U.S. Provisional Appl. No. 62/852,442, filed on May 24, 2019; this application is also a continuation-in-part of U.S. patent application Ser. No. 16/847,582, filed on Apr. 13, 2020, which is a continuation-in-part application of U.S. patent Appl. Ser. No. 14/222,306, filed on Mar. 21, 2014, issued as U.S. Pat. No. 10,622,666 on Apr. 14, 2020, which is a non-provisional of U.S. Provisional Patent Appl. No. 61/803,981, filed Mar. 21, 2013; U.S. patent application Ser. No. 16/882,5536 is also a continuation in part of U.S. patent Appl. Ser. No. 16/847,582; U.S. patent application Ser. No. 16/847,582 is also a continuation-in-part application of U.S. Patent Appl. Ser. No. 15/364,528, filed on Nov. 30, 2016 which is a non-provisional of U.S. Provisional Patent Appl. No. 62/260,817, filed on Nov. 30, 2015, the benefit and priority of all of these applications are claimed and the disclosures of all of these applications are incorporated by reference herein in their entireties.

### STATEMENT REGARDING FEDERALLY SPONSORED RESEARCH

This invention was made with government support under contract no. DEAR0000384 under the ARPA-E Robust Affordable Next Generation Energy Storage Systems program, contract no. DEAR0000787 awarded under the ARPA-E Robust Affordable Next Generation Energy Storage Systems program, under contract no. NNC16CA03C awarded by NASA, and under contract no. DEEE0006860 by the U.S. Department of Energy. The government has certain rights in the invention.

### FIELD OF THE DISCLOSURE

The present disclosure generally relates to ion conducting batteries with solid-state electrolytes.

### BACKGROUND OF THE DISCLOSURE

Lithium ion batteries (LiBs) have the highest volumetric and gravimetric energy densities compared to all other rechargeable batteries making LiBs the prime candidate for a wide range of applications, from portable electronics to electric vehicles (EVs). Current LiBs are based mainly on LiCoO₂ or LiFePO₄ type positive electrodes, a Li⁺ conducting organic electrolyte (e.g., LiPF₆ dissolved in ethylene carbonate-diethyl carbonate), and a Li metal or graphitic anode. Unfortunately, there are several technological problems that exist with current state-of-the art LiBs: safety due to combustible organic components; degradation due to the formation of reaction products at the anode and cathode electrolyte, interfaces (solid electrolyte interphase—SEI); and power/energy density limitations by poor electrochemical stability of the organic electrolyte. Other batteries based sodium, magnesium, and other ion conducting electrolytes have similar issues.

Sulfur is a promising cathode for lithium batteries due to its high theoretical specific capacity (1673 mAh/g), low cost and environmental friendliness. With a high theoretical specific energy density of 2500 Wh/kg that is 10 times greater energy density than conventional Li-ion battery, Li—S battery hold great potential for next-generation high energy storage system. However, wide-scale commercial use is so far limited because of some key challenges, such as the dissolution of the intermediate discharge product (Li₂Sx, 2<X<8) in conventional liquid electrolytes, remained unsolved. On the other hand, all-solid-state batteries (SSB) are considered to be ultimate power supply for pure electric vehicles (EVs). SSB system demonstrates a new approach for novel Li—S battery. Replacing the organic electrolyte with solid state electrolyte (SSEs) will intrinsically eliminate the dissolution of polysulfide. However, all of the solid state Li—S batteries incorporating current state-of-the-art SSEs suffer from high interfacial impedance due to their low surface area.

### BRIEF SUMMARY OF THE DISCLOSURE

In a first aspect disclosed herein a battery is provided. The battery comprising: a dense central layer comprising a dense electrolyte material, the dense central layer having a first surface, and a second surface opposite the first surface; a first electrode disposed on the first surface of the dense central layer, the first electrode hosting a sulfur-based material, the first electrode comprising: a first porous electrolyte material having a first network of pores therein and conductive material comprising carbon located on a surface of the pores; a cathode material infiltrated throughout the first network of pores and deposited on the conductive material comprising carbon, wherein each of the first porous electrolyte material and the cathode material percolate through the first electrode; a second electrode disposed on the second surface of the dense central layer, the second electrode being a lithium-metal anode comprising: a second porous electrolyte material having a second network of pores therein; an anode material infiltrated throughout the second network of pores, the anode material comprising lithium, wherein each of the second porous electrolyte material and the anode material percolate through the second electrode; wherein each of the dense electrolyte material, the first porous electrolyte material, and the second porous electrolyte material are independently selected from garnet materials, and the first porous electrolyte material and the second porous electrolyte material and the dense central layer are sintered together.

In a first embodiment of the first aspect, each of the dense electrolyte material, the first porous electrolyte material, and the second porous electrolyte material are the same.

In a second embodiment of the first aspect, each of the dense electrolyte material, the first porous electrolyte material, and the second porous electrolyte material are different.

In a third embodiment of the first aspect, the dense central layer has a thickness of 1 to 30 microns, the first electrode has a thickness of 10 to 200 microns, and the second electrode has a thickness of 10 to 200 microns.

In a fourth embodiment of the first aspect, each of the dense electrolyte material, the first porous electrolyte material, and the second porous electrolyte material are independently selected from cation-doped Li₅ La₃M¹₂O₁₂, where M¹ is Nb, Zr, Ta, or combinations thereof, cation-doped Li₆La₂BaTa₂O₁₂, cation-doped Li₇La₃Zr₂O₁₂, and cation-doped Li₆BaY₂M¹₂O₁₂, where cation dopants are barium, yttrium, zinc, iron, gallium, and combinations thereof.

In a fifth embodiment of the first aspect, each of the dense electrolyte material, the first porous electrolyte material, and the second porous electrolyte material are independently selected from Li₅La₃Nb₂O₁₂, Li₅La₃Ta₂O₁₂, Li₇La₃Zr₂O₁₂, Li₆La₂SrNb₂O₁₂, Li₆La₂BaNb₂O₁₂, Li₆La₂SrTa₂O₁₂, Li₆La₂BaTa₂O₁₂, Li₇Y₃Zr₂O₁₂, Li_{6.4}Y₃Z_{1.4}Ta_{0.6}O₁₂, Li_{6.5}La_{2.5}Ba_{0.5}TaZrO₁₂, Li₆BaY₂M¹₂O₁₂, Li₇Y₃Zr₂O₁₂, Li_{6.75}BaLa₂Nb_{1.75}Zn_{0.25}O₁₂, or Li_{6.75}BaLa₂Ta_{1.75}Zn_{0.25}O₁₂, and combinations thereof.

In a sixth embodiment of the first aspect, the anode material is Li metal, or the anode material is Li metal and the cathode material is S.

In a seventh embodiment of the first aspect, (i) the sulfur-based material is selected from the group consisting of: sulfides, S, Li₂S, Li₂S₂, Li₂S₃, Li₂S₄, Li₂S₆, and Li₂S₈, and combinations thereof, (ii) the sulfur-based material is selected from the group consisting of: sulfides, S, Li₂S, Li₂S₂, Li₂S₃, Li₂S₄, Li₂S₆, and Li₂S₈, and combinations thereof and the cathode further comprises a conductive material comprising carbon, or (iii) the sulfur-based material is selected from the group consisting of: sulfides, S, Li₂S, Li₂S₂, Li₂S₃, Li₂S₄, Li₂S₆, and Li₂S₈, and combinations thereof and the cathode further comprises a conductive material selected from the group consisting of conductive polymers, carbon nanotubes, or carbon fibers.

In an eighth embodiment of the first aspect, the battery further comprising a current collector wherein the current collector is attached to the first or second electrode with a carbon sponge.

In a ninth embodiment of the first aspect, the conductive material comprising carbon is selected from the group consisting of conductive polymers, carbon nanotubes, and carbon fibers.

In a tenth embodiment of the first aspect, (i) the sulfur-based material is selected from the group consisting of: sulfides, S, Li₂S, Li₂S₂, Li₂S₃, Li₂S₄, Li₂S₆, and Li₂S₈, and combinations thereof, (ii) the sulfur-based material is selected from the group consisting of: sulfides, S, Li₂S, Li₂S₂, Li₂S₃, Li₂S₄, Li₂S₆, and Li₂S₈, and combinations thereof and the cathode further comprises a conductive material comprising carbon, or (iii) the sulfur-based material is selected from the group consisting of: sulfides, S, Li₂S, Li₂S₂, Li₂S₃, Li₂S₄, Li₂S₆, and Li₂S₈, and combinations thereof and the cathode further comprises a conductive material selected from the group consisting of conductive polymers, carbon nanotubes, or carbon fibers, and the cathode material and the conductive material comprising carbon together are filled to 40 to 60 percent of the volume of the pores in the first porous electrolyte material

In an eleventh embodiment of the first aspect, (i) the sulfur-based material is selected from the group consisting of: sulfides, S, Li₂S, Li₂S₂, Li₂S₃, Li₂S₄, Li₂S₆, and Li₂S₈, and combinations thereof, (ii) the sulfur-based material is selected from the group consisting of: sulfides, S, Li₂S, Li₂S₂, Li₂S₃, Li₂S₄, Li₂S₆, and Li₂S₈, and combinations thereof and the cathode further comprises a conductive material comprising carbon, or (iii) the sulfur-based material is selected from the group consisting of: sulfides, S, Li₂S, Li₂S₂, Li₂S₃, Li₂S₄, Li₂S₆, and Li₂S₈, and combinations thereof and the cathode further comprises a conductive material selected from the group consisting of conductive polymers, carbon nanotubes, or carbon fibers, and the cathode material and the conductive material comprising carbon together are filled to 40 to 60 percent of the volume of the pores in the first porous electrolyte material, and the cathode material is S.

In a twelfth embodiment of the first aspect, the conductive material comprising carbon forms a coating on the surface of the pores.

In a thirteenth embodiment of the first aspect, the coating is a conformal coating.

In a second aspect, a method of fabricating a battery or a battery component having a solid state electrolyte is provided. The method comprising: providing a scaffold comprising: a dense central layer comprising a dense electrolyte material, the dense central layer having a first surface, and a second surface opposite the first surface; a first porous layer comprising a first porous electrolyte material, the first porous layer disposed on the first surface of the dense central layer, the first porous electrolyte material having a first network of pores therein; wherein each of the dense electrolyte material and the first porous electrolyte material are independently selected from garnet materials; locating a conductive material comprising carbon on a surface of the pores of the first porous layer; infiltrating sulfur-based material into the first porous layer to deposit on the conductive material comprising carbon and form a cathode; wherein the dense central layer and the first porous layer are sintered together.

In a first embodiment of the second aspect, infiltrating sulfur-based material into the first porous layer is performed after infiltrating carbon into the first porous layer.

In a second embodiment of the first aspect, infiltrating carbon into the first porous layer comprises: (i) exposing the first porous layer to carbon nanotubes in solution; (ii) growing carbon nanofibers inside the first porous layer by microwave synthesis; (iii) exposing the first porous layer to graphene flakes in solution; (iv) exposing the first porous layer to a solution of polyacrylonitrile in dimethylformamide, and subsequently carbonizing the polyacrylonitrile by exposure to heat, or (v) exposing the first porous layer to a solution of polyacrylonitrile in dimethylformamide, and subsequently carbonizing the polyacrylonitrile by exposure to a temperature of 500 to 700° C. for time period in the range of 30 minutes to 3 hours.

In a third embodiment of the second aspect, infiltrating sulfur-based material into the first porous layer is performed: (i) by vapor deposition; (ii) by exposure to gaseous sulfur; (iii) by exposure to gaseous sulfur in an inert atmosphere or vacuum for a time period of 30 minutes to 6 hours; (iv) by exposure to gaseous sulfur in an inert atmosphere or vacuum for a time period of 30 minutes to 6 hours at a temperature of 225 to 700° C.; (v) by exposure to gaseous sulfur in an argon atmosphere at a temperature of 200 to 300° C. for a time period in the range of 30 minutes to 2 hours; (vi) by contacting the first porous layer with a sulfur-containing liquid; (vii) by contacting the first porous layer with a solution of S dissolved in CS₂; or (viii) by contacting the first porous layer with a solution of S dissolved in CS₂, followed by evaporating the CS₂ by vacuum drying.

In a fourth embodiment of the second aspect, after infiltrating carbon into the first porous layer and infiltrating the sulfur-based material into the first porous layer, the cathode material and the conductive material comprising carbon together fill 40 to 60 percent of the volume of pores in the first porous electrolyte material.

In a fifth embodiment of the second aspect, after infiltrating carbon into the first porous layer and infiltrating the sulfur-based material into the first porous layer, the cathode material and the conductive material comprising carbon together fill 40 to 60 percent of the volume of pores in the first porous electrolyte material, and the cathode material is S.

In a sixth embodiment of the second aspect, the scaffold further comprises a second porous layer comprising a second porous electrolyte material, the second porous layer disposed on the second surface of the dense central layer, the second porous electrolyte material having a second network of pores therein; the method further comprising infiltrating lithium into the second porous layer.

In a seventh embodiment of the second aspect, the sulfur infiltrated into the first porous layer is S, Li₂S, and combinations thereof.

### BRIEF DESCRIPTION OF THE FIGURES

The following figures are given by way of illustration only, and thus are not intended to limit the scope of the present disclosure.

FIG. 1. Ionic conductivity vs. diffusion coefficient of garnet-type compounds: (1) Li₅La₃Ta₂O₁₂, (2) Li₅La₃Sb₂O₁₂, (3) Li₅La₃Nb₂O₁₂, (4) Li_{5.5}BaLa₂Ta₂O_{11.75}, (5) Li₆La₂BaTaO₁₂, (6) Li_{6.5}BaLa₂Ta₂O_{12.25}, (7) Li₇La₃Zr₂O₁₂, (8)Li_{6.5}La_{2.5}Ba_{0.5}TaZrO₁₂ (sintered at 900° C.), and (9) Li_{6.5}La_{2.5}Ba_{0.5}TaZrO₁₂ (sintered at 1100° C.).

FIG. 2. Example of optimization of Li ion conduction in garnet-type solid state electrolytes (SSEs): (a) and (b) path of Li⁺ conduction and (c) effect of Li⁺ site occupancy on conductivity.

FIG. 3. Schematic of an example of the solid-state lithium battery (SSLiB) showing thin (˜10 μm) garnet SSE layer extending as a tailored nano/microstructured scaffold into (Li metal filled) anode and (Li₂MMn₃O₈, M=Fe, Co, mixed with graphene) cathode to provide structural support for solid-state electrolyte (SSE) layer, and high surface area and continuous ion transport path for reduced polarization. The multi-purpose ˜40 μm Al current collector (with ˜200 Å Cu on anode side) provides strength and thermal and electrical conduction. The ˜170 μm repeat units are stacked in series to provide desired battery pack voltage and strength (300V pack would be <1 cm thick). Highly porous SSE scaffold creates large interface area significantly decreasing cell impedance.

FIG. 4. (a) Ionic conductivity of examples of Li-garnets. (b) PXRD of an example of a Li_{6.75}La₂BaTa_{1.75}Zn_{0.25}O₁₂.

FIG. 5. Electrochemical impedance spectroscopy (EIS) of an example of a SSE battery with LiFePO₄ cathode (20% carbon black), dense SSE, Li infiltrated SSE scaffold, and Al current collector. The absence of additional low-frequency intercept indicates electrolyte interface is reversible for Li ions.

FIG. 6. PXRD showing the formation of a garnet-type Li_{6.75}La₂BaTa_{1.75}Zn_{0.25}O₁₂ as a function of temperature, SEM images and conductivity show sintering temperature can control the density, particle size, and conductivity.

FIG. 7. Examples of multilayer ceramic processing: (a) tape cast support; (b) thin electrolyte on layered porous anode support with bimodally integrated anode functional layer (BI-AFL); and (c) magnification of BI-AFL showing ability to integrate nano-scale features for reduced interfacial impedance with conventional ceramic processing.

FIG. 8. (a) Cross section and (b) top view of an example of a SSE with porous scaffold, in which anode and cathode materials will be filled. (c) Cross-section of SSE scaffold after Li metal infiltration. (d) Cross section at Li-metal-dense SSE interface. Images demonstrate excellent Li wetting of SSE was obtained.

FIG. 9. Schematic of the LGTS (Li-Garnet-TiS₂) all solid state battery. The 2D structure of TiS2 ensures good contact with the garnet surface and between sheets, which improves Li ion transport. The CNTs (coated or not-coated) facilitate electron transport as an enhanced current collector.

FIG. 10. Fabrication and Characterization of LGTS all solid state batteries. (a) Photographs of the CNT and TiS₂ solutions dispersed in NMP solvent. (b) The solution process to coat the TiS₂ cathode and CNTs on the garnet surface. (c) Cross-sectional SEM image of the Li-garnet interface, with conformal contact of Li on the garnet surface. (d) SEM image of the sonicated TiS₂ flakes. (e) Cross-sectional SEM image of the 2 μm CNT current collector film on the TiS₂ cathode. Voltage profiles of the LGTS batteries cycled at 100° C. (f) between 1 and 4 V, (g) with deep discharge activation to 0.35 V at a current density of 20 mA/g, and (h) between 0.5 and 4 V at a current density of 50 mA/g.

FIG. 11. Investigating the change in conductivity of the TiS₂ film. (a) Voltage profile of the LGTS battery during the first cycle at 100° C. (b) EIS spectra of LGTS batteries before cycling (black) and after lithiation (blue), corresponding to the marked states in (a). The inset is the zoomed-in spectra marked by a red dashed line. (c) Schematic of the I-V measurement and lithiation process. (d) I-V curves of the TiS₂ film before and after lithiation, showing a significant improvement in the electronic conductivity after lithiation.

FIG. 12. Electrochemical performance of the LGTS batteries at high temperatures up to 150° C. (a) EIS spectra of the LGTS batteries between 60° C. and 150° C. The inset shows the zoomed-in, low resistance spectra. (b) Voltage profiles and (c) the corresponding cycling performance of the LGTS batteries cycled under 300, 500, and 100 mA/g, respectively. (d-f) Results from the flame test of a LGTS battery while powering a LED. After direct exposure to the flame, the apparent performance of the LGTS battery improves.

FIG. 13. Characterization of the LGTS batteries after observed short-circuits. The unstable voltage profiles while charging (a), and stable voltage profiles while discharging (b) indicate an asymmetrical short-circuit. (c, d) EIS spectra measured under a charged state of 2 V with positive and negative bias voltages, respectively. (e, f) Schematic of the dynamic short-circuit evolution during the charge and discharge processes, respectively. Li deposition on the Li metal anode leads to the dynamic short-circuit, while the stripping of Li during discharge temporarily heals the short-circuit.

FIGS. 14A-D and 15 show specific capacity and Coulombic efficiency characteristics of an embodiment of a battery at different temperatures and current densities for multiple charge/discharge cycles.

FIG. 16 shows an embodiment of an all solid state battery. The mixed electron-ion conductive cathode ensures good contact with the garnet surface and between themselves, which improves Li ion and electron transport. The coated CNTs facilitate electron transport as an enhanced current collector.

FIG. 17 shows SEM micrographs of (a) a triple layer ceramic with ˜5 μm pores, (b) a triple layer ceramic with ˜10 μm pores, (c) a close-up of highly interconnected porosity in a triple layer, and (d) an ordered structure on the bottom of a bilayer.

FIG. 18 shows an analysis of calcined LLCZN showing phase via (a) X-ray diffraction and particle size via (b) scanning electron microscopy and (c) dynamic light scattering.

FIG. 19 shows (a) a diagram and photograph of reactor setup used for testing LLZ under varying gas conditions. (b) XRD patterns of LLZ powders heated to 500° C. in zero-grade air. (c) XRD patterns of LLZ powders heated in CO₂. (d) XRD pattern of LLZ tape heated in compressed air.

FIG. 20 show (a) SEM micrograph of solid state LLCZN after milling in 5 mm and 2 mm media. (b) Dilatometer curve of a pressed LLCZN pellet during heating at 1° C./minute.

FIG. 21 shows XRD of LLCZN tapes after burn out in dry air and sintering at 1050° C. for 1 hour in various gases.

FIG. 22 shows SEM micrographs of an example of an ordered structure by 3D printing garnet on top of a dense garnet tape after sintering, such as a 10 layer print on top of a dense tape after sintering.

FIG. 23 shows (a) ASR vs running time data, current vs. time data, and voltage vs. time data for an example of a ceramic ion-conducting structure. (b) Additional ASR vs running time data, current vs. time data, and voltage vs. time data for an example of a ceramic ion-conducting structure.

FIG. 24 shows ASR vs. dense layer thickness for examples of ceramic ion-conducting structures.

FIG. 25 shows a schematic (top left) and corresponding SEM image (top right, bottom left, and bottom right) showing the designed trilayer garnet structure with more Li cycled at one side.

FIG. 26 shows a colormap of grid scanned trilayer sintered with starting point sintering setup.

FIG. 27 shows a 3D plot of a grid scan background and the curve fit to the background.

FIG. 28 shows a colormap of grid scans of two cells sintered using (a) a finely ground powder and (b) a ceramic pellet on top and bottom.

FIG. 29 is a graph showing ionic conductivity vs. diffusion coefficient of garnet-type compounds: (1) Li₅La₃Ta₂O₁₂, (2) Li₅La₃Sb₂O₁₂, (3) Li₅La₃Nb₂O₁₂, (4) Li_{5.5}BaLa₂Ta₂O_{11.75}, (5) Li₆La₂BaTaO₁₂, (6) Li_{6.5}BaLa₂Ta₂O_{12.25}, (7) Li₇La₃Zr₂O₁₂, (8) Li_{6.5}La_{2.5}Ba_{0.5}TaZrO₁₂ (sintered at 900° C.), and (9) Li_{6.5}La_{2.5}Ba_{0.5}TaZrO₁₂ (sintered at 1100° C.).

FIGS. 30 (a)-2(c)depict garnet-type solid-state electrolytes (SSEs) with optimized Li ion conduction: FIG. 30(a) and FIG. 30(b) path of Li⁺ conduction and FIG. 30(c) effect of Li⁺ site occupancy on conductivity.

FIG. 31 is a schematic of an example of the solid-state lithium battery (SSLiB) showing thin (˜10 μm) garnet SSE layer extending as a tailored nano/microstructured scaffold into (Li metal filled) anode and (Li₂MMn₃O₈, M=Fe, Co, mixed with graphene) cathode to provide structural support for solid-state electrolyte (SSE) layer, and high surface area and continuous ion transport path for reduced polarization. The multi-purpose ˜40 μm Al current collector (with ˜200 Å Cu on anode side) provides strength and thermal and electrical conduction. The ˜170 μm repeat units are stacked in series to provide desired battery pack voltage and strength (300V pack would be <1 cm thick). Highly porous SSE scaffold creates large interface area significantly decreasing cell impedance.

FIG. 32(a) depicts a graph showing ionic conductivity of examples of Li-garnets. FIG. 32(b) depicts a PXRD showing an example of a Li_{6.75}La₂BaTa_{1.75}Zn_{0.25}O₁₂.

FIG. 33 depicts an electrochemical impedance spectroscopy (EIS) of an example of a SSE battery with LiFePO₄ cathode (20% carbon black), dense SSE, Li infiltrated SSE scaffold, and Al current collector. The absence of additional low-frequency intercept indicates electrolyte interface is reversible for Li ions.

FIG. 34 depicts a PXRD showing the formation of a garnet-type Li_{6.75}La₂BaTa_{1.75}Zn_{0.25}O₁₂ as a function of temperature, SEM images and conductivity show sintering temperature can control the density, particle size, and conductivity.

FIGS. 35(a)-(c) depict examples of multilayer ceramic processing: FIG. 35(a) tape cast support; FIG. 35(b) thin electrolyte on layered porous anode support with bimodally integrated anode functional layer (BI-AFL); and FIG. 35(c) magnification of BI-AFL showing ability to integrate nano-scale features for reduced interfacial impedance with conventional ceramic processing.

FIGS. 36(a)-36(d) depict micrograph of SSE scaffold: FIG. 36(a) Cross section and FIG. 8(b) top view of an example of a SSE with porous scaffold, in which anode and cathode materials will be filled. FIG. 36(c) Cross-section of SSE scaffold after Li metal infiltration. FIG. 36(d) Cross section at Li-metal-dense SSE interface. Images demonstrate excellent Li wetting of SSE was obtained.

FIG. 37 shows a schematic of solid state batteries showing thin garnet SSE layer extending as a tailored nano/micro-structured scaffold into (Li metal filled) anode and sulfur cathode to provide structural support for solid state electrolyte layer, and high surface area and continuous ion transport path for reduced polarization. A highly porous SSE scaffold creates large interface area significantly decreasing cell impedance.

FIG. 38A shows a cross-section SEM image of Li-infiltrated porous garnet.

FIG. 38B shows an elemental mapping of S/C co-infiltration.

FIG. 38C shows a schematic of a cell assembly for electrochemical testing.

FIG. 39(a) shows a graph of cycling performance for a trilayer SSE enabled Li—S battery under a constant current density of 1 mA/mg.

FIG. 39(b) shows a graph of extended cycling stability for the Li—S battery of FIG. 11(a).

FIG. 40 shows a schematic of a solid state battery with a thin (10 μm) garnet SSE layer extending as a tailored nano/micro-structured scaffold into Liₘₑₜₐₗ filled anode and sulfur filled cathode to provide structural support for SSE layer, and high surface area and continuous ion transport path for reduced polarization. A multi-purpose 10 μm Ti current collector provides strength and thermal and electrical conduction. The highly porous SSE scaffold creates large interface area significantly decreasing cell impedance.

FIG. 41 shows Arrhenius conductivity plots for Li_{6.4}La₃Zr_{1.4}T_{0.6-x}NbₓO₁₂ (0<=x<=0.3), Li_{6.65}La_{2.75}Ba_{0.25}Zr_{1.4}Ta_{0.5}Nb_{0.1}O₁₂, and undoped Li₇La₃Zr₂O₁₂ (LLZ).

FIG. 42(a) shows a photograph of a large garnet tape. The inserted image shows the flexibility of the tape.

FIG. 42(b) shows a laminated tri-layer tape.

FIG. 42(c) shows a sintered trilayer pellet.

FIG. 42(d) shows an SEM image of a sintered tri-layer showing a dense central SSE layer and porous outer layers.

FIG. 43(a) shows schematics of symmetric cells with and without a 1 nm ALD-AL₂O₃ coating on LLCZN.

FIG. 43(b) shows Nyquist electrochemical impedence spectroscopy (EIS) plots for the cells of FIG. 43(a). The inset in FIG. 43(b) shows the magnified EIS at high frequency.

FIG. 43(c) shows a plot illustrating galvanostatic cycling with a current density of 71 μA/cm².

FIG. 44(a) shows SEM images of a triple-layer garnet structure with Liₘₑₜₐₗfilling (and wetting) the pores, after 360 cycles at a current density of 3 mA/cm².

FIG. 44(b) shows a plot of measurements taken during galvanostatic cycling of the structure of FIG. 44(a) at current densities of 1, 2, and 3 mA/cm², demonstrating stable voltage response corresponding to an ASR of ˜2 Ωcm² independent of current density and without Li dendrite formation.

FIG. 45(a) shows a SEM image of carbon and sulfur infiltrated triple-layer garnet.

FIG. 45(b) shows element mapping of the structure of FIG. 45(a).

FIG. 45(c) shows Raman spectroscopy results for the structure of FIG. 45(a).

FIG. 45(d) shows an XRD pattern for the structure of FIG. 45(a).

FIG. 46(a) is a photograph showing a working Li—S cell with a garnet electrolyte that lights up a LED device.

FIG. 46(b) shows the voltage-capacity profile of the Li—S cell of FIG. 46(a).

FIG. 47(a) shows the structure of a 28 V stack having 14 cells in series with titanium bipolar layers between cells.

FIG. 47(b) shows an assembly of stack layers of FIG. 47(a) in a pile.

FIG. 47(c) shows a fully assembled pile.

FIG. 47(d) shows a 100 kg device consisting of 9 piles.

FIG. 48(a) shows a SEM of a carbon nanotube sponge.

FIG. 48 (b) shows a first picture of a compressible carbon nanotube (CNT) sponge.

FIG. 48(c) shows a second picture of a compressible carbon nanotube (CNT) sponge.

FIG. 49(a) is a schematic of 10 cm×10 cm Li—S cell with tri-layer Garnet.

FIG. 49(b) is a picture of a 10 cm×10 cm solid oxide fuel cell (SOFC) fabricated by the inventors.

FIG. 50 is a schematic showing a packaging design for stacked cells in series.

FIG. 51(a) is a picture of a dilatometer.

FIG. 51(b) shows carbon nanotube (CNT) growth on metal plate.

FIGS. 52 (a)-(d) shows measured results on the stability window of garnet electrolyte and stability of C/S cathodes.

FIG. 53(a) is a picture of Garnet electrolyte sintered at 1050° C. and its dense microstructure.

FIG. 53(b) is a first SEM of a dense layer of the electrolyte of FIG. 53(a).

FIG. 53(c) is a second SEM of a dense layer of the electrolyte of FIG. 53(a).

FIG. 54(a) shows XRD patterns of LLCZN.

FIG. 54(b) is a graph showing impedance measured from room temperature to 50° C. for LLCZN.

FIG. 54(c) is a graph showing lithium ion conductivity as function of temperature for LLCZN.

FIG. 55(a) is a picture of a large Garnet tape fabricated by tape casting.

FIG. 55(b) is an SEM image of highly porous Garnet.

FIG. 56(a) shows an SEM image of conformal CNT coating on a porous Garnet surface.

FIG. 56(b) is an SEM image of CNF grown by microwave method.

FIG. 57A is a first SEM image of sulfur infusion in a nanocarbon coated Garnet electrolyte.

FIG. 57B is a second SEM image of sulfur infusion in a nanocarbon coated Garnet electrolyte.

FIG. 57C is an XRD measurement after infilling S in Garnet electrolyte, which confirms there is no reactions between S and Garnet.

FIG. 58(a) is an SEM image of lithium-infiltrated lithium garnet scaffold showing metallic lithium (dark) conformally coating the porous garnet scaffold (light).

FIG. 58(b) is a cross section at Li-metal-dense SSE interface. The images show that excellent Li wetting of the SSE was obtained.

FIG. 59 shows a plot of current vs. voltage for a Garnet electrolyte with a configuration of Gold∥Garnet∥Lithium, which shows Li is stable up to 5.5 V.

FIG. 60(a) is an SEM image of sulfur and carbon co-infiltrated into the cathode porous side of a triple-layer garnet electrolyte.

FIG. 60(b) shows element mapping of sulfur in the structure of FIG. 60(a).

FIG. 60(c) shows element mapping of zirconium in the structure of FIG. 60(a).

FIG. 60(d) shows an overlap of S and C mapping of cathode materials with Zrfor the structure of FIG. 60(a).

FIG. 61(a) is a graph showing cell performance of a lithium-sulfur garnet electrolyte battery. The 3rd, 4th, 5th and 10th charge-discharge curves of the cell are shown.

FIG. 61(b) is a graph showing the specific capacity and coulombic efficiency with cycle number dependence for the cell of FIG. 61(a).

FIG. 62(a) is a plot of electrochemical impedance spectroscopy (EIS) for a Lid triple-layer garnets Li electrode cell at room temperature. The equivalent circuit fitting result is shown as a solid line in FIG. 62(a). But, the line overlaps the measured data so closely that it may not be easily visible.

FIG. 62(b) is a plot of electrochemical impedance spectroscopy (EIS) for a Lid triple-layer garnets H S cell at room temperature. The equivalent circuit fitting result is shown as a solid line in FIG. 34(b). But, the line overlaps the measured data so closely that it may not be easily visible, except at higher values on the X-axis where the equivalent circuit fitting result line deviates and becomes visible.

FIG. 63(a) is a graph showing cycling stability for the first 27 cycles of a battery cell. The cell was cycled between 1V-3V at constant current of 10 uA in total.

FIG. 63(b) is a graph showing a charge-discharge curve for the 26th cycle and discharge curve for the 27th cycle.

FIG. 64 is a graph showing pre-charge-discharge curves for a battery cell. The total testing current was 50 uA for the 1st discharge and 2nd charge, and 10 uA for the 2nd discharge.

### DETAILED DESCRIPTION OF THE DISCLOSURE

The present disclosure provides ion conducting batteries having a solid state electrolyte. For example, the batteries are lithium-ion, solid-state electrolyte batteries, sodium-ion, solid-state electrolyte batteries, or magnesium-ion solid-state electrolyte batteries. Lithium-ion (Li⁺) batteries are used, for example, in portable electronics and electric cars, sodium-ion (Na⁺) batteries are used, for example, for electric grid storage to enable intermittent renewable energy deployment such as solar and wind, and magnesium-ion (Mg²⁺) batteries are expected to have higher performance than Li⁺ and Na⁺ because Mg²⁺ carries twice the charge for each ion.

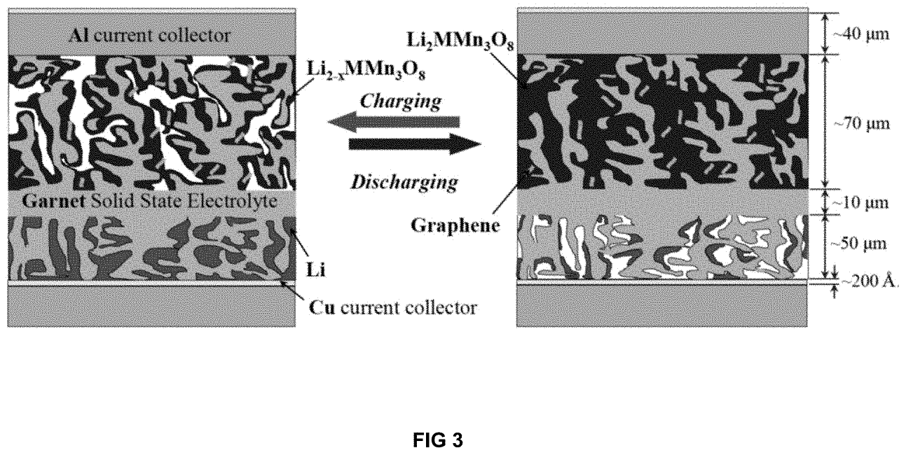

The solid-state batteries have advantages over previous batteries. For example, the solid electrolyte is non-flammable providing enhanced safety, and also provides greater stability to allow high voltage electrodes for greater energy density. The battery design (FIG. 3) provides additional advantages in that it allows for a thin electrolyte layer and a larger electrolyte/electrode interfacial area, both resulting in lower resistance and thus greater power and energy density. In addition, the structure eliminates mechanical stress from ion intercalation during charging and discharging cycles and the formation of solid electrolyte interphase (SEI) layers, thus removing the capacity fade degradation mechanisms that limit lifetime of current battery technology.

The solid state batteries comprise a cathode material, an anode material, and an ion-conducting, solid-state electrolyte material. The solid-state electrolyte material has a dense region (e.g. a layer) and one or two porous regions (layers). The porous region(s) can be disposed on one side of the dense region or disposed on opposite sides of the dense region. The dense region and porous region(s) are fabricated from the same solid-state electrolyte material. The batteries conduct ions such as, for example, lithium ions, sodium ions, or magnesium ions.

The cathode comprises cathode material in electrical contact with the porous region of the ion-conducting, solid-state electrolyte material. For example, the cathode material is an ion-conducting material that stores ions by mechanisms such as intercalation or reacts with the ion to form a secondary phase (e.g., an air or sulfide electrode). Examples of suitable cathode materials are known in the art.

The cathode material, if present, is disposed on at least a portion of a surface (e.g., a pore surface of one of the pores) of a porous region of the ion-conducting, solid-state electrolyte material. The cathode material, when present, at least partially fills one or more pores (e.g., a majority of the pores) of a porous region or one of the porous regions of the ion-conducting, solid-state electrolyte material. In an embodiment, the cathode material is infiltrated into at least a portion of the pores of the porous region of the ion-conducting, solid-state electrolyte material.

In an embodiment, the cathode material is disposed on at least a portion of the pore surface of the cathode side of the porous region of the ion-conducting, SSE material, where the cathode side of the porous region of ion-conducting, SSE material is opposed to an anode side of the porous region of ion-conducting, SSE material on which the anode material is disposed.

In an embodiment, the cathode material is a lithium ion-conducting material. For example, the lithium ion-conducting cathode material is, lithium nickel manganese cobalt oxides (NMC, LiNiₓMn_{y}Co₂O₂, where x+y+z=1), such as LiCoO₂, LiNi_{1/3}Co_{1/3}Mn_{1/3}O₂, LiNi_{0.5}Co_{0.2}Mn_{0.3}O₂, lithium manganese oxides (LMOs), such as LiMn₂O₄, LiNi_{0.5}Mn_{1.5}O₄, lithium iron phosphates (LFPs) such as LiFePO₄, olivine cathode materials (which includes materials such as LiFePO₄, LiMnPO₄, LiNiPO₄, LiCoPO₄ and the like) and Li₂MMn₃O₈, where M is selected from Fe, Co, and combinations thereof. In an embodiment, the ion-conducting cathode material is a high energy ion-conducting cathode material such as Li₂MMn₃O₈, wherein M is selected from Fe, Co, and combinations thereof.

In an embodiment, the cathode material is a sodium ion-conducting material. For example, the sodium ion-conducting cathode material is Na₂V₂O₅, P2-Na_{2/3}Fe_{1/2}Mn_{1/2}O₂, Na₃V₂(PO₄)₃, NaMn_{1/3}Co_{1/3}Ni_{1/3}PO₄ and composite materials (e.g., composites with carbon black) thereof such as Na_{2/3}Fe_{1/2}Mn_{1/2}O₂@graphene composite.

In an embodiment, the cathode material is a magnesium ion-conducting material. For example, the magnesium ion-conducting cathode material is doped manganese oxide (e.g., MgₓMnO_{2.y}H₂O).

In an embodiment, the cathode material is an organic sulfide or polysulfide. Examples of organic sulfides include carbynepolysulfide and copolymerized sulfur.

In an embodiment, the cathode material is an air electrode. Examples of materials suitable for air electrodes include those used in solid-state lithium ion batteries with air cathodes such as large surface area carbon particles (e.g., Super P which is a conductive carbon black) and catalyst particles (e.g., alpha-Mno₂ nanorods) bound in a mesh (e.g., a polymer binder such as PVDF binder).

It may be desirable to use an electrically conductive material as part of the ion-conducting cathode material. In an embodiment, the ion-conducting cathode material also comprises an electrically conducting carbon material (e.g., graphene or carbon black), and the ion-conducting cathode material, optionally, further comprises a organic or gel ion-conducting electrolyte. (In general, where carbon materials such as carbon nanotubes, carbon black, graphene are described or used throughout this disclosure, and where electrical conductivity is beneficial, other electrically conductive carbon materials can also be used, such as elemental carbon materials or others described herein.) The electrically conductive material may separate from the ion-conducting cathode material. For example, electrically conductive material (e.g., graphene) is disposed on at least a portion of a surface (e.g., a pore surface) of the porous region of the ion-conducting, SSE electrolyte material and the ion-conducting cathode material is disposed on at least a portion of the electrically conductive material (e.g., graphene).

The anode comprises anode material in electrical contact with the porous region of the ion-conducting, SSE material. For example, the anode material is the metallic form of the ion conducted in the solid state electrolyte (e.g., metallic lithium for a lithium-ion battery) or a compound that intercalates the conducting ion (e.g., lithium carbide, Li₆C, for a lithium-ion battery). Examples of suitable anode materials are known in the art.

The anode material, if present, is disposed on at least a portion of a surface (e.g., a pore surface of one of the pores) of the porous region of the ion-conducting, SSE material. The anode material, when present, at least partially fills one or more pores (e.g., a majority of the pores) of the porous region of ion-conducting, SSE electrolyte material. In an embodiment, the anode material is infiltrated into at least a portion of the pores of the porous region of the ion-conducting, solid-state electrolyte material.

In an embodiment, the anode material is disposed on at least a portion of the pore surface of an anode-side porous region of the ion-conducting, SSE electrolyte material, where the anode side of the ion-conducting, solid-state electrolyte material is opposed to a cathode side of the porous, ion-conducting, SSE on which the cathode material is disposed.

In an embodiment, the anode material is a lithium-containing material. For example, the anode material is lithium metal, or an ion-conducting lithium-containing anode material such as lithium titanates (LTOs) such as Li₄Ti₅O₁₂.

In an embodiment, the anode material is a sodium-containing material. For example, the anode material is sodium metal, or an ion-conducting sodium-containing anode material such as Na₂C₈H₄O₄ and Na_{0.66}Li_{0.22}Ti_{0.78}O₂.

In an embodiment, the anode material is a magnesium-containing material. For example, the anode material is magnesium metal.

In an embodiment, the anode material is a conducting material such as graphite, hard carbon, porous hollow carbon spheres and tubes, and tin and its alloys, tin/carbon, tin/cobalt alloy, or silicon/carbon.

The ion-conducting, solid-state electrolyte material has a dense regions (e.g., a dense layer) and one or two porous regions (e.g., porous layer(s)). The porosity of the dense region is less than that of the porous region(s). In an embodiment, the dense region is not porous. The cathode material and/or anode material is disposed on a porous region of the SSE material forming a discrete cathode material containing region and/or a discrete anode material containing region of the ion-conducting, solid-state electrolyte material. For example, each of these regions of the ion-conducting, solid-state electrolyte material has, independently, a dimension (e.g., a thickness perpendicular to the longest dimension of the material) of 20 μm to 200 μm, including all integer micron values and ranges therebetween.

The dense regions and porous regions described herein can be discrete dense layers and discrete porous layers. Accordingly, in an embodiment, the ion-conducting, solid-state electrolyte material has a dense layer and one or two porous layers.

The ion-conducting, solid-state electrolyte material conducts ions (e.g., lithium ions, sodium ions, or magnesium ions) between the anode and cathode. The ion-conducting, solid-state electrolyte material is free of pin-hole defects. The ion-conducting solid-state electrolyte material for the battery or battery cell has a dense region (e.g., a dense layer) that is supported by one or more porous regions (e.g., porous layer(s)) (the porous region(s)/layer(s) are also referred to herein as a scaffold structure(s)) comprised of the same ion-conducting, solid-state electrolyte material.

In an embodiment, the ion-conducting solid state electrolyte has a dense region (e.g., a dense layer) and two porous regions (e.g., porous layers), where the porous regions are disposed on opposite sides of the dense region and cathode material is disposed in one of the porous regions and the anode material in the other porous region.

In an embodiment, the ion-conducting solid state electrolyte has a dense region (e.g., a dense layer) and one porous region (e.g., porous layer), where the porous regions are disposed on one sides of the dense region and either cathode material or anode material is disposed in the porous region. If cathode material is disposed in the porous region, a conventional battery anode (e.g., a conventional solid-state battery anode) is formed on the opposite side of the dense region by known methods. If anode material is disposed in the porous region, a conventional battery cathode (e.g., a conventional solid-state battery cathode) is formed on the opposite side of the dense region.

The porous region (e.g., porous layer) of the ion-conducting, solid-state electrolyte material has a porous structure. The porous structure has microstructural features (e.g., microporosity) and/or nanostructural features (e.g., nanoporosity). For example, each porous region, independently, has a porosity of 10% to 90%, including all integer % values and ranges therebetween. In another example, each porous region, independently, has a porosity of 30% to 70%, including all integer % values and ranges therebetween. Where two porous regions are present the porosity of the two layers may be the same or different. The porosity of the individual regions can be selected to, for example, accommodate processing steps (e.g., higher porosity is easier to fill with electrode material (e.g., charge storage material) (e.g., cathode)) in subsequent screen-printing or infiltration step, and achieve a desired electrode material capacity, i.e., how much of the conducting material (e.g., Li, Na, Mg) is stored in the electrode materials. The porous region (e.g., layer) provide structural support to the dense layer so that the thickness of the dense layer can be reduced, thus reducing its resistance. The porous layer also extends ion conduction of the dense phase (solid electrolyte) into the electrode layer to reduce electrode resistance both in terms of ion conduction through electrode and interfacial resistance due to charge transfer reaction at electrode/electrolyte interface, the later improved by having more electrode/electrolyte interfacial area.

In an embodiment, the solid-state, ion-conducting electrolyte material is a solid-state electrolyte, lithium-containing material. For example, the solid-state electrolyte, lithium-containing material is a lithium-garnet SSE material.

In an embodiment, the solid-state, ion-conducting electrolyte material is a Li-garnet SSE material comprising cation-doped Li₅La₃M′₂O₁₂, cation-doped Li₆La₂BaTa₂O₁₂, cation-doped Li₇La₃Zr₂O₁₂, and cation-doped Li₆BaY₂M′₂O₁₂. The cation dopants are barium, yttrium, zinc, or combinations thereof and M′ is Nb, Zr, Ta, or combinations thereof.

In an embodiment, the Li-garnet SSE material comprises Li₅La₃Nb₂O₁₂, Li₅La₃Ta₂O₁₂, Li₇La₃Zr₂O₁₂, Li₆La₂SrNb₂O₁₂, Li₆La₂BaNb₂O₁₂, Li₆La₂SrTa₂O₁₂, Li₆La₂BaTa₂O₁₂, Li₇Y₃Zr₂O₁₂, Li_{6.4}Y₃Zr_{1.4}Ta_{0.6}O₁₂, Li_{6.5}La_{2.5}Ba_{0.5}TaZrO₁₂, Li₆BaY₂M¹₂O₁₂, Li₇Y₃Zr₂O₁₂, Li_{6.75}BaLa₂Nb_{1.75}Zn_{0.25}O₁₂, or Li_{6.75}BaLa₂Ta_{1.75}Zn_{0.25}O₁₂.

In an embodiment, the, solid-state, ion-conducting electrolyte material sodium-containing, solid-state electrolyte, material. For example, the sodium-containing, solid-state electrolyte is Na₃Zr₂Si₂PO₁₂ (NASICON) or beta-alumina.

In an embodiment, the, solid-state, ion-conducting electrolyte material is a, solid-state electrolyte, magnesium-containing material. For example, the magnesium ion-conducting electrolyte material is MgZr₄P₆O₂₄.

The ion-conducting, solid-state electrolyte material has a dense region that free of the cathode material and anode material. For example, this region has a dimension (e.g., a thickness perpendicular to the longest dimension of the material) of 1 μm to 100 μm, including all integer micron values and ranges therebetween. In another example, this region has a dimension of 5 μm to 40 μm.

In an embodiment, the solid state battery comprises a lithium-containing cathode material and/or a lithium-containing anode material, and a lithium-containing, ion-conducting, solid-state electrolyte material. In an embodiment, the solid state battery comprises a sodium-containing cathode material and/or a sodium-containing anode material, and a sodium-containing, ion-conducting, solid-state electrolyte material. In an embodiment, the solid state battery comprises a magnesium-containing cathode material and/or a magnesium-containing anode material, and a magnesium-containing, ion-conducting, solid-state electrolyte material.

The solid-state, ion-conducting electrolyte material is configured such that ions (e.g., lithium ions, sodium ions, or magnesium ions) diffuse into and out of the porous region(s) (e.g., porous layer(s)) of the solid-state, ion-conducting electrolyte material during charging and/or discharging of the battery. In an embodiment, the solid-state, ion-conducting battery comprises a solid-state, ion-conducting electrolyte material comprising one or two porous regions (e.g., porous layer(s)) configured such that ions (e.g., lithium ions, sodium ions, or magnesium ions) diffuse into and out of the porous region(s) of solid-state, ion-conducting electrolyte material during charging and/or discharging of the battery.

One of ordinary skill in the art would understand that a number of processing methods are known for processing/forming the porous, solid-state, ion-conducting electrolyte material such as high temperature solid-state reaction processes, co-precipitation processes, hydrothermal processes, sol-gel processes.

The material can be systematically synthesized by solid-state mixing techniques. For example, a mixture of starting materials may be mixed in an organic solvent (e.g., ethanol or methanol) and the mixture of starting materials dried to evolve the organic solvent. The mixture of starting materials may be ball milled. The ball milled mixture may be calcined. For example, the ball milled mixture is calcined at a temperature between 500° C. and 2000° C., including all integer ° C. values and ranges therebetween, for least 30 minutes to at least 50 hours. The calcined mixture may be milled with media such as stabilized-zirconia or alumina or another media known to one of ordinary skill in the art to achieve the prerequisite particle size distribution. The calcined mixture may be sintered. For example, the calcined mixture is sintered at a temperature between 500° C. and 2000° C., including all integer ° C. values and ranges therebetween, for at least 30 minutes to at least 50 hours. To achieve the prerequisite particle size distribution, the calcined mixture may be milled using a technique such as vibratory milling, attrition milling, jet milling, ball milling, or another technique known to one of ordinary skill in the art, using media such as stabilized-zirconia, alumina, or another media known to one of ordinary skill in the art.

One of ordinary skill in the art would understand that a number of conventional fabrication processing methods are known for processing the ion-conducting SSE materials such as those set forth above in a green-form. Such methods include, but are not limited to, tape casting, calendaring, embossing, punching, laser-cutting, solvent bonding, lamination, heat lamination, extrusion, co-extrusion, centrifugal casting, slip casting, gel casting, die casting, pressing, isostatic pressing, hot isostatic pressing, uniaxial pressing, and sol gel processing. The resulting green-form material may then be sintered to form the ion-conducting SSE materials using a technique known to one of ordinary skill in the art, such as conventional thermal processing in air, or controlled atmospheres to minimize loss of individual components of the ion-conducting SSE materials. In some embodiments of the present invention it is advantageous to fabricate ion-conducting SSE materials in a green-form by die-pressing, optionally followed by isostatic pressing. In other embodiments it is advantageous to fabricate ion-conducting SSE materials as a multi-channel device in a green-form using a combination of techniques such as tape casting, punching, laser-cutting, solvent bonding, heat lamination, or other techniques known to one of ordinary skill in the art.

Standard x-ray diffraction analysis techniques may be performed to identify the crystal structure and phase purity of the solid sodium electrolytes in the sintered ceramic membrane.

The solid state batteries (e.g., lithium-ion solid state electrolyte batteries, sodium-ion solid state electrolyte batteries, or magnesium-ion solid state electrolyte batteries) comprise current collector(s). The batteries have a cathode-side (first) current collector disposed on the cathode-side of the porous, solid-state electrolyte material and an anode-side (second) current collector disposed on the anode-side of the porous, solid-state electrolyte material. The current collector are each independently fabricated of a metal (e.g., aluminum, copper, or titanium) or metal alloy (aluminum alloy, copper alloy, or titanium alloy).

The solid-state batteries (e.g., lithium-ion solid state electrolyte batteries, sodium-ion solid state electrolyte batteries, or magnesium-ion solid state electrolyte batteries) may comprise various additional structural components (such as bipolar plates, external packaging, and electrical contacts/leads to connect wires. In an embodiment, the battery further comprises bipolar plates. In an embodiment, the battery further comprises bipolar plates and external packaging, and electrical contacts/leads to connect wires. In an embodiment, repeat battery cell units are separated by a bipolar plate.

The cathode material (if present), the anode material (if present), the SSE material, the cathode-side (first) current collector (if present), and the anode-side (second) current collector (if present) may form a cell. In this case, the solid-state, ion-conducting battery comprises a plurality of cells separated by one or more bipolar plates. The number of cells in the battery is determined by the performance requirements (e.g., voltage output) of the battery and is limited only by fabrication constraints. For example, the solid-state, ion-conducting battery comprises 1 to 500 cells, including all integer number of cells and ranges therebetween.

In an embodiment, the ion-conducting, solid-state battery or battery cell has one planar cathode and/or anode-electrolyte interface or no planar cathode and/or anode—electrolyte interfaces. In an embodiment, the battery or battery cell does not exhibit solid electrolyte interphase (SEI).

The following examples are presented to illustrate the present disclosure. They are not intended to limiting in any manner.

### Example 1

The following is an example describing the solid-state lithium ion batteries of the present disclosure and making same.

The flammable organic electrolytes of conventional batteries can be replaced with non-flammable ceramic-based solid-state electrolytes (SSEs) that exhibit, for example, room temperature ionic conductivity of ≥10⁻³ Scm⁻¹ and electrochemical stability up to 6V. This can further allow replacement of typical LiCoO₂ cathodes with higher voltage cathode materials to increase power/energy densities. Moreover, the integration of these ceramic electrolytes in a planar stacked structure with metal current collectors will provide battery strength.

Intrinsically safe, robust, low-cost, high-energy-density all-solid-state Li-ion batteries (SSLiBs), can be fabricated by integrating high conductivity garnet-type solid Li ion electrolytes and high voltage cathodes in tailored micro/nano-structures, fabricated by low-cost supported thin-film ceramic techniques. Such batteries can be used in electric vehicles.

Li-garnet solid-state electrolytes (SSEs) that have, for example, a room temperature (RT) conductivity of ˜10⁻³ Scm⁻¹ (comparable to organic electrolytes) can be used. The can be increased to ˜10⁻² Scm⁻¹ by increasing the disorder of the Li-sublattice. The highly stable garnet SSE allows use of Li₂MMn₃O₈ (M=Fe, Co) high voltage (˜6V) cathodes and Li metal anodes without stability or flammability concerns.

Known fabrication techniques can be used to form electrode supported thin-film (10 μm) SSEs, resulting in an area specific resistance (ASR) of only ˜0.01 Ωcm⁻². Use of scalable multilayer ceramic fabrication techniques, without need for dry rooms or vacuum equipment, provide dramatically reduced manufacturing cost.

Moreover, the tailored micro/nanostructured electrode support (scaffold) will increase interfacial area, overcoming the high impedance typical of planar geometry solid-state lithium ion batteries (SSLiBs), resulting in a C/3 IR drop of only 5.02 mV. In addition, charge/discharge of the Li-anode and Li₂Mn₃O₈ cathode scaffolds by pore-filling provides high depth of discharge ability without mechanical cycling fatigue seen with typical electrodes.

At ˜170 μm/repeat unit, a 300V battery pack would only be <1 cm thick. This form factor with high strength due to Al bipolar plates allows synergistic placement between framing elements, reducing effective weight and volume. Based on the SSLiB rational design, targeted SSE conductivity, high voltage cathode, and high capacity electrodes the expected effective specific energy, including structural bipolar plate, is ˜600 Wh/kg at C/3. Since bipolar plates provide strength and no temperature control is necessary this is essentially a full battery pack specification other than the external can. The corresponding effective energy density is 1810 Wh/L.

All the fabrication processes can be done with conventional ceramic processing equipment in ambient air without the need of dry rooms, vacuum deposition, or glove boxes, dramatically reducing cost of manufacturing.

For the all solid-state battery with no SEI or other performance degradation mechanisms inherent in current state-of-art Li-batteries, the calendar life of the instant battery is expected to exceed 10 years and cycle life is expected to exceed 5000 cycles.

Solid-state Li-garnet electrolytes (SSEs) have unique properties for SSLiBs, including room temperature (RT) conductivity of ˜10⁻³ Scm⁻¹ (comparable to organic electrolytes) and stability to high voltage (˜6V) cathodes and Li-metal anodes without flammability concerns.

Use of SSE oxide powders can enable use of low-cost scalable multilayer ceramic fabrication techniques to form electrode supported thin-film (˜10 μm) SSEs without need for dry rooms or vacuum equipment, as well as engineered micro/nano-structured electrode supports to dramatically increase interfacial area. The later will overcome the high interfacial impedance typical of planar geometry SSLiBs, provide high depth of discharge ability without mechanical cycling fatigue seen with typical electrodes, as well as avoid SEI layer formation.

The SSE scaffold/electrolyte/scaffold structure will also provide mechanical strength, allowing for the integration of structural metal interconnects (bipolar plates) between planar cells, to improve strength, weight, thermal uniformity, and form factor. The resulting strength and form factor provides potential for the battery pack to be load bearing.

Highly Li⁺ conducting and high voltage stable garnet type solid electrolytes can be made by doping specific cations for Ta and Zr in Li₅La₃Ta₂O₁₂, Li₆La₂BaTa₂O₁₂ and Li₇La₃Zr₂O₁₂, to extend RT conductivity from ˜10⁻³ to ˜10⁻² Scm⁻¹. Compositions having desirable conductivity, ionic transference number, and electrochemical stability up to 6V against elemental Li can be determined.

Electrode supported thin film SSEs can be fabricated. Submicron SSE powders and SSE ink/paste formulations thereof can be made. Tape casting, colloidal deposition, and sintering conditions can be developed to prepare dense thin-film (˜10 μm) garnet SSEs on porous scaffolds.

Cathode and anode can be integrated. Electrode-SSE interface structure and SSE surface can be optimized to minimize interfacial impedance for targeted electrode compositions. High voltage cathode inks can be made to fabricate SSLiBs with high voltage cathode and Li-metal anode incorporated into the SSE scaffold. The SSLiB electrochemical performance can be determined by measurements including CV, energy/power density and cycling performance.

Stacked multi-cell SSLiBs with Al/Cu bipolar plates can be assembled. Energy/power density, cycle life, and mechanical strength as a function of layer thicknesses and area for the stacked multi-cell SSLiBs can be determined.

Li-Stuffed Garnets SSEs. Conductivity of Li-Garnet SSEs can be improved doping to increase the Li content (“stuffing”) of the garnet structure. Li-stuffed garnets exhibit desirable physical and chemical properties for SSEs including:
RT bulk conductivity (˜10⁻³ S/cm) for cubic Li₇La₃Zr₂O₁₂.
High electrochemical stability for high voltage cathodes (up to 6 V), about 2 V higher than current organic electrolytes and about 1 V higher than the more popular LiPON.
Excellent chemical stability in contact with elemental and molten Li anodes up to 400° C.
Li⁺ transference number close to the maximum of 1.00, which is important to battery cycle efficiency, while typical polymer electrolytes are only ˜0.35.
Wide operating temperature capability, electrical conductivity that increases with increasing temperature reaching 0.1 Scm⁻¹ at 300° C., and maintains appreciable conductivity below 0° C. In contrast, polymer electrolytes are flammable at high temperature
Synthesizable as simple mixed oxide powders in air, hence easy scale up for bulk synthesis.

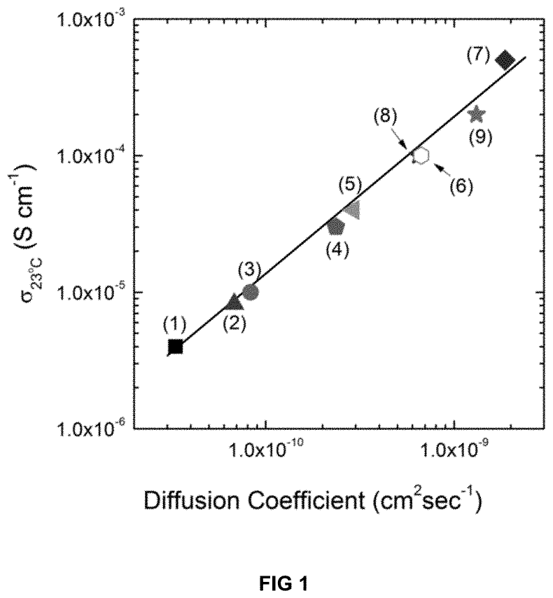

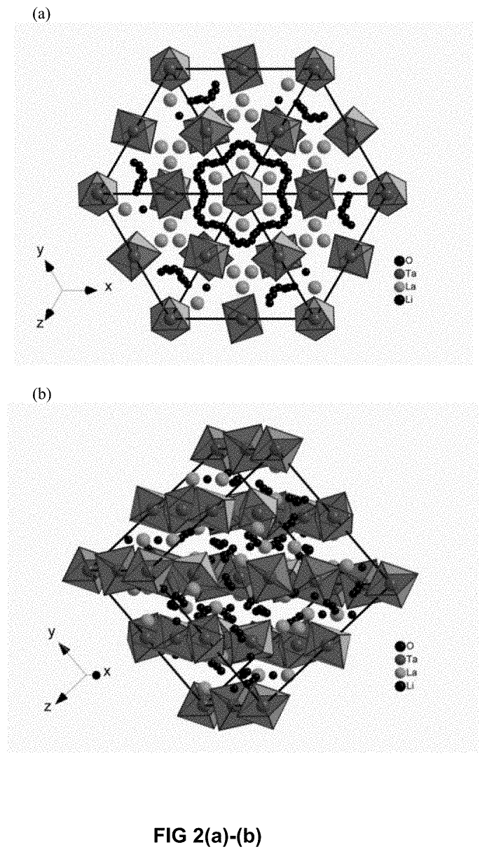

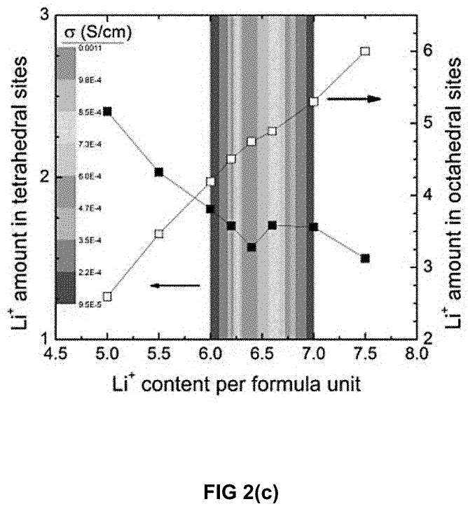

Li⁺ conductivity of garnet SSEs can be further increased. The Li ion conductivity of garnet is highly correlated to the concentration of Li⁺ in the crystal structure. FIG. 1 shows the relationship between the Li⁺ conductivity and diffusion coefficient for various Li-stuffed garnets. The conductivity increases with Li content, for example, the cubic Li₂-phase (Li₇La₃Zr₂O₁₂) exhibits a RT conductivity of 5×10-4 S/cm. However, conductivity also depends on synthesis conditions, including sintering temperature. The effects of composition and synthesis method can be determined to achieve a minimum RT conductivity of ˜10⁻³ S/cm for the scaffold supported SSE layer. It is expected the RT conductivity can be increased to ˜10⁻² S/cm through doping to increase the disorder of the Li sub lattice. Ionic conduction in the garnet structure occurs around the metal-oxygen octahedron, and site occupancy of Li ions in tetrahedral vs. octahedral sites directly controls the Li ion conductivity (FIG. 2). For example, in Li₅La₃Ta₂O₁₂, about 80% of Li ions occupy the tetrahedral sites while only 20% occupy octahedral sites. Increasing the Li⁺ concentration at octahedral sites while decreasing occupancy of the tetrahedral sides has been shown to result in an order of magnitude increase in ionic conductivity (FIG. 2b). Smaller-radii metal ions (e.g., Y3⁺), which are chemically stable in contact with elemental Li and isovalent with La, can be doped to develop a new series of garnets: Li₆BaY₂M₂O₁₂, Li_{6.4}Y₃Zr_{1.6}Ta_{0.6}O₁₂, Li₇Y₃Zr₂O₁₂, and their solid solutions; to increase ionic conductivity. The enthalpy of formation of Y₂O₃ (−1932 kJ/mol) is lower than that of La₂O₃ (−1794 kJ/mol), hence, doping Y for La will increase Y—O bond strength and weaken Li—O bonds. Thus increasing Li⁺ mobility due to weaker lithium to oxygen interaction energy. Further, it is expected that Y will provide a smoother path for ionic conduction around the metal oxygen octahedral due to its smaller ionic radius (FIG. 2a).

In another approach, we can substitute M²⁺ cations (e.g., Zn²⁺, a 3d° cation known to form distorted metal-oxygen octandera) for the M⁵⁺ sites in Li₆BaY₂M₂O₁₂. ZnO is expected to play a dual role of both further increasing the concentration of mobile Li ions in the structure and decreasing the final sintering temperature. Each M²⁺ will add three more Li⁺ for charge balance and these ions will occupy vacant Li⁺ sites in the garnet structure. Thus, further increase Li⁺ conduction can be obtained by modifying the garnet composition to control the crystal structure, Li-site occupancy, and minimize the conduction path activation energy.

Due to the ceramic powder nature of Li-garnets, SSLiBs can be fabricated using conventional fabrication techniques. This has tremendous advantages in terms of both cost and performance. All the fabrication processes can be done with conventional ceramic processing equipment in ambient air without the need of dry rooms, vacuum deposition, or glove boxes, dramatically reducing cost of manufacturing.

The SSLiBs investigated to date suffer from high interfacial impedance due to their low surface area, planar electrode/electrolyte interfaces (e.g., LiPON based SSLiBs). Low area specific resistance (ASR) cathodes and anodes can be achieved by integration of electronic and ionic conducting phases to increase electrolyte/electrode interfacial area and extend the electrochemically active region farther from the electrolyte/electrode planar interface. It is expected that modification of the nano/microstructure of the electrolyte/electrode interface (for example, by colloidal deposition of powders or salt solution impregnation) can reduce overall cell area specific resistance (ASR), resulting in an increase in power density relative to identical composition and layer thickness cells. These same advances can be applied to decrease SSLiB interfacial impedance. The SSLiB will be made by known fabrication techniques Low-cost, high speed, scalable multi-layer ceramic processing can be used to fabricate supported thin-film (10 μm) SSEs on tailored nano/micro-structured electrode scaffolds. ˜50 and 70 μm tailored porosity (nano/micro features) SSE garnet support layers (scaffolds) can be tape cast, followed by colloidal deposition of a ˜10 μm dense garnet SSE layer and sintering. The resulting pinhole-free SSE layer is expected to be mechanically robust due to support layers and have a low area specific resistance ASR, for example, only ˜0.01 ΩCm⁻². Li₂MMn₃O₈ will be screen printed into the porous cathode scaffold and initial Li-metal will be impregnated in the porous anode scaffold (FIG. 3). For example, Li₂(Co,Fe)Mn₃O₈ high voltage cathodes can be prepared in the form of nano-sized powders using wet chemical methods. The nano-sized electrode powders can be mixed with conductive materials such as graphene or carbon black and polymer binder in NMP solvent. Typical mass ratio for cathode, conductive additive or binder is 85%: 10%: 5% by weight. The slurry viscosity can be optimized for filling the porous SSE scaffold, infiltrated in and dried. An Li-metal flashing of Li nanoparticles may be infiltrated in the porous anode scaffold or the Li can be provided fully from the cathode composition so dry room processing can be avoided.

Another major advantage of this structure is that charge/discharge cycles will involve filling/emptying of the SSE scaffold pores (see FIG. 3), rather than intercalating and expanding carbon anode powders/fibers. As a result there will be no change in electrode dimensions between charged and discharged state. This is expected to remove both cycle fatigue and limitations on depth of discharge, the former allowing for greater cycle life and the later for greater actual battery capacity.

Moreover, there will be no change in overall cell dimensions allowing for the batteries to be stacked as a structural unit. Light-weight, ˜40 micron thick Al plates will serve not only as current collectors but also provide mechanical strength. ˜20 nm of Cu can be electrodeposited on the anode side for electrochemical compatibility with Li. The bipolar current collector plates can be applied before the slurry is fully dried and pressed to improve the electrical contact between bipolar current collector and the electrode materials.

Compared to current LiBs with organic electrolytes, the SSLiB with intrinsically safe solid state chemistry is expected to not only increase the specific energy density and decrease the cost on the cell level, but also avoid demanding packing level and system level engineering requirements. High specific energy density at both cell and system level can be achieved, relative to the state-of-the-art, by the following:
Stable electrochemical voltage window of garnet SSE allows for high voltage cathodes resulting in high cell voltage (˜6 V).
Porous SSE scaffold allows use of high specific capacity Li-metal anode.
Porous 3-dimensionally networked SSE scaffolds allows electrode materials to fill volume with a smaller charge transfer resistance, increasing mass percentage of active electrode materials.
Bipolar plates will be made by electroplating ˜200 Å Cu on 40 μm Al plates. Given the 3× lower density of Al vs. Cu the resulting plate will have same weight as the sum of the ˜10 μm Al and Cu foils used in conventional batteries. However, with 3× the strength (due to ˜9× higher strength-to-weight ratio of Al vs. Cu).
The repeat unit (SSLiB/bipolar plate) will then be stacked in series to obtain desired battery pack voltage (e.g., fifty 6V SSLiBs for a 300V battery pac would be <1 cm thick).
Thermal and electrical control/management systems are not needed as there is no thermal runaway concern.
The proposed intrinsically safe SSLiBs also drastically reduces mechanical protection needs.

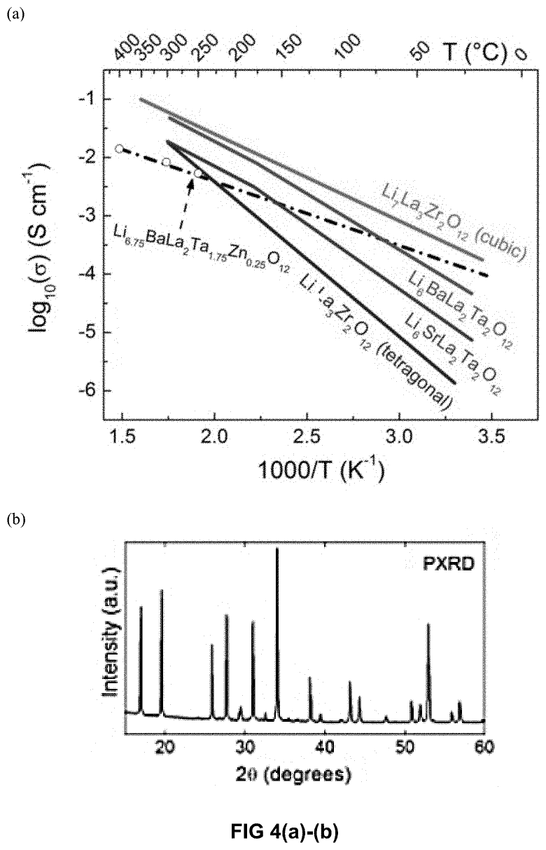

The energy density is calculated from component thicknesses of device structure (FIG. 4) normalized to 1 cm² area (see data in Table 1). The estimated SSE scaffold porosity is 70% for the cathode and 30% for the anode. The charge/capacity is balanced for the anode and cathode by: m_{Li}×C_{Li}=m_{LMFO}×C_{LMFO} where LFMO stands for Li₂FeMn₃O₈. Therefore, the total mass (cathode-scaffold/SSE/scaffold and bipolar plate) is calculated to be 50.92 mg per cm² area. Note it is our intent to fabricate charged cells with all Li in cathode to avoid necessity of dry room. Thus, anode-scaffold would be empty of Li metal for energy density calculations.

TABLE 1
Material parameters for energy density calculation.

| | Density | mass per | Capacity | Voltage |
|---|---|---|---|---|
| Material | (g/cm3) | cm2 (mg) | (mA/g) | (Vs. Li) (V) |
| Cathode LFMO | 3.59 | 17.00 | 300 | 6 |
| Anode Li | 0.54 | 0 | 3800 | 0 |
| SSE | 5.00 | 27.5 | N/A | N/A |
| Al | 2.70 | 5.40 | N/A | N/A |
| Cu | 8.69 | 0.02 | N/A | N/A |
| Carbon additive | 1.00 | 1.00 | N/A | N/A |
| Cell Total | | 50.92 | | |

The corresponding total energy is Eₜₒₜ=C×V=5.13 mAh×6 V=30.78 mWh. The total volume is 1.7×10⁻⁵ L for 1 cm² area. Therefore, the theoretical effective specific energy, including structural bipolar plate, is 603.29 Wh/kg. As calculated below, the overpotential at C/3 is negligible compared with the cell voltage, leading to an energy density at this rate close to theoretical. Since the bipolar plate provides strength and no temperature control is necessary this is essential the full battery pack specification other than external can. (In contrast, state-of-art LiBs have a ˜40% decrease in energy density from cell level to pack level.) The corresponding effective energy density of the complete battery pack is 1810 Wh/L.

A desirable rate performance is expected with the SSLiBs due to 3-dimensional (3D) networked scaffold structures, comparable to organic electrolyte based ones, and much better than traditional planar solid state batteries. The reasons for this include the following:
Porous SSE scaffolds provide extended 3D electrode-electrolyte interface, dramatically increasing the surface contact area and decreasing the charge-transfer impedance.
Use of SSE having a conductivity of 10⁻³-10⁻² S/cm in electrode scaffolds to provide continuous Li⁺ conductive path.
Use of high aspect ratio (lateral dimension vs. thickness) graphene in electrode pores to provide continuous electron conductive path.

To calculate the rate performance, the overpotential of SSLiB, shown in FIG. 3, was estimated, including electrolyte impedance (Z_{SSE}) and electrode-electrolyte-interface impedance (Z_{interface}).

The porous SSE scaffold achieves a smaller interfacial impedance by: 1/Z_{interface}=S*Gs, where S is the interfacial area close to the porous SSE and Gs is the interfacial conductance per specific area. The interfacial impedance is expected to be small since the porous SSE results in a large electrode-electrolyte interfacial area. For ion transport impedance through the entire SSE structure: ZSSE=Zcathode-scaffold+Zdense-SSE+Zanode-scaffold; and Z=(μL)/(A*(1−ε)), where p=100 Ωcm, L is thickness (FIG. 3), A is 1 cm², and c is porosity (70% for the cathode scaffold, 50% for the anode scaffold and 0% for the dense SSE layer). Therefore, Zcathode-scaffold=2.3 Ohm/cm², Zdense-SSE=0.01 Ohm/cm², and Zanode-scaffold=1 Ohm/cm²; resulting in Ztotal=3.31 Ohm/cm². At C/3, the current density=1.71 mA/cm² and the voltage drop is 5.02 mV/cm², which is negligible compared with a 6 V cell voltage.

Desirable cycling performance is expected due to the following advantages:
No structural challenges associated with intercalating and de-intercalating Li due to filling of 3D porous structure.
Excellent mechanical and electrochemical electrolyte-electrode interface stability due to 3D porous SSE structure.
No SEI formation inherent in current state-of-art LiBs, which consumes electrolyte and increase cell impedance.
NoLi dendrite formation (problematic for LiBs with Li anodes) due to dense ceramic SSE.
   Therefore, the calendar life should easily exceed 10 years and the cycle life should easily exceed 5000 cycles.

The SSLiB is an advancement in battery materials and architecture. It can provide the necessary transformational change in battery performance and cost to accelerate vehicle electrification. As a result it can improve vehicle energy efficiency, reduce energy related emissions, and reduce energy imports.

FIG. 4 shows the conductivity for Li garnets, including Li_{6.75}BaLa₂Ta_{1.75}Zn_{0.25}O₁₂. It is expected that the lower activation energy of this composition will provide a path to achieve RT conductivity of ˜10⁻² Scm⁻¹ when similar substitutions are made in Li₇La₃Zr₂O₁₂.

Since garnet SSEs can be synthesized as ceramic powders (unlike LiPON) high speed, scalable multilayer ceramic fabrication techniques can be used to fabricate supported thin-film (˜10 μm) SSEs on tailored nano/micro-structured electrode scaffolds (FIG. 3). Tape casting 50 and 70 μm tailored porosity (nano/micro features) SSE support layers, followed by colloidal deposition of a ˜10 μm dense SSE layer and sintering can be used. The resulting pinhole-free SSE layer will be mechanically robust due to support layers and have a low area specific resistance ASR, of only ˜0.01 Ωcm⁻².

The ˜6.0 volt cathode compositions (Li₂MMn₃O₈, M=Fe, Co) have been synthesized. These can be combined with SSE scaffold & graphene to increase ionic and electronic conduction, respectively, as well as to reduce interfacial impedance. Li₂MMn₃O₈ can be screen printed into the porous cathode scaffold and Li-metal impregnated in the porous anode scaffold.

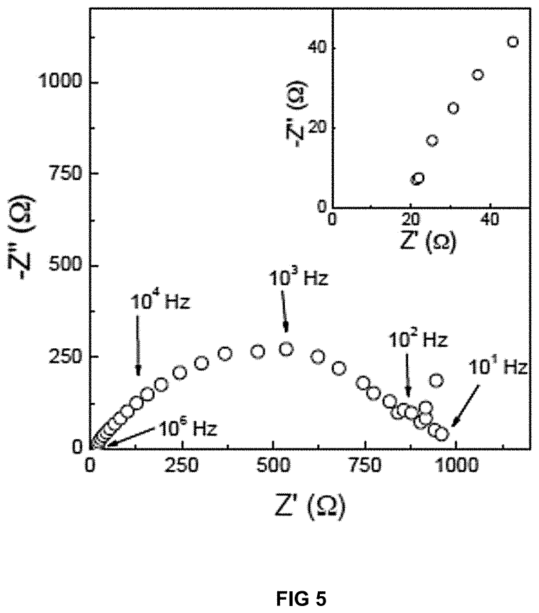

FIG. 5 shows EIS results for a solid state Li cell tested using the Li infiltrated porous scaffold anode, supporting a thin dense SSE layer, and screen printed LiFePO₄ cathode. The high-frequency intercept corresponds to the dense SSE impedance and the low frequency intercept the entire cell impedance.

Bipolar plates can be fabricated by electroplating ˜200 Å Cu on 40 μm Al. Given the 3× lower density of Al vs. Cu the resulting plate will have same weight as the sum of the ˜10 μm Al and Cu foils used in conventional batteries. However, with 3× the strength (due to ˜9× higher strength-to-weight ratio of Al vs. Cu). Increases in strength can be achieved by simply increasing Al plate thickness with negligible effect on gravimetric and volumetric energy density or cost. The repeat unit (SSLiB/bipolar plate) can be stacked in series to obtain desired battery pack voltage (e.g., fifty 6V SSLiBs for a 300V battery pack would be <1 cm thick).

In terms of performance and cost:
The energy density of SSLiBs shown in FIG. 3 is ˜600 Wh/kg based on a 6 V cell. A Li₂FeMn₃O₈ cathode has a voltage of 5.5 V vs. Li. With this cathode, energy density of 550 Wh/kg can be achieved.
The calculation for energy density in Table 3 does not include packing for protection of thermal runaway and mechanical damage as this is not necessary for SSLiBs. If 20% packaging is included, the total energy density is still 500 Wh/kg.
The voltage drop of ˜5 mV for C/3 was based on SSE with an ionic conductivity of ˜10⁻² S/cm (using the porous SSE scaffold with dense SSE layer and corresponding small interfacial charge transfer resistance). At an ionic conductivity of 5×10⁻⁴ S/cm, the voltage drop for C/3 rate is only ˜0.1 V, which is significantly less than the cell voltage of 6 V.
The materials cost for SSLiBs is only˜50 $/KWh due to the high SSLiB energy density and corresponding reduction in materials to achieve the same amount of energy. The non material manufacturing cost is expected, without the need of dry room, for our SSLiBs to be lower than that for current state-of-art LiBs.

The SSE materials can be synthesized using solid state and wet chemical methods. For example, corresponding metal oxides or salts can be mixed as solid-state or solution precursors, dried, and synthesized powders calcined between 700 and 1200° C. in air to obtain phase pure materials. Phase purity can be determined as a function of synthesis method and calcining temperature by powder X-ray diffraction (PXRD, D8, Bruker, Cuka). The structure can be determined by Rietveld refinements. Using structural refinement data, the metal-oxygen bond length and Li—O bond distance can be estimated to determine role of dopant in garnet structure on conductivity. In-situ PXRD can be performed to identify any chemical reactivity between the garnet-SSEs and the Li₂(Fe,Co)Mn₃O₈ high voltage cathodes as a function of temperature. The Li ion conductivity can be determined by electrochemical impedance spectroscopy (EIS-Solartron 1260) and DC (Solartron Potentiostat 1287) four-point methods. The electrical conductivity can be investigated using both Li⁺ blocking Au electrodes and reversible elemental Li electrodes. The Li reversible electrode measurement will provide information about the SSE/electrode interface impedance in addition to ionic conductivity of the electrolyte, while the blocking electrode will provide information as to any electronic conduction (transference number determination). The concentration of Li⁺ and other metal ions can be determined using inductively coupled plasma (ICP) and electron energy loss spectroscopy (EELS) to understand the role of Li content on ionic conductivity. The actual amount of Li and its distribution in the three different crystallographic sites of the garnet structure can be important to improve the conductivity and the concentration of mobile Li ions will be optimized to reach the RT conductivity value of 10⁻² S/cm.

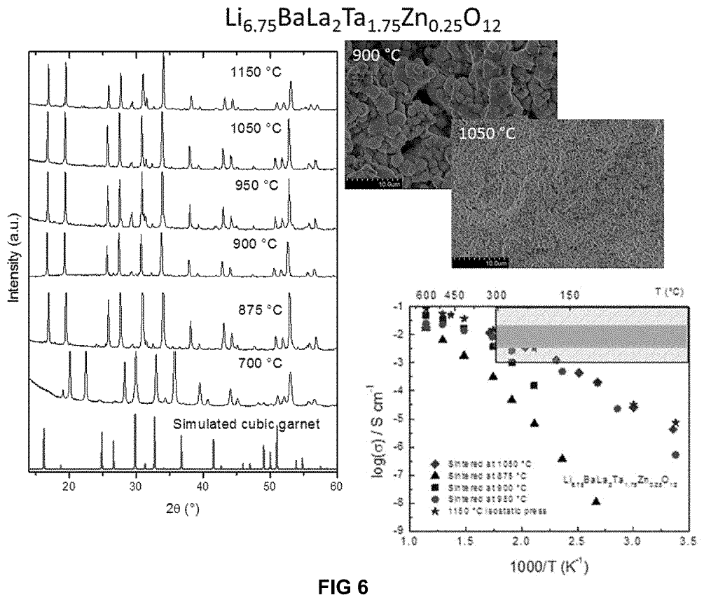

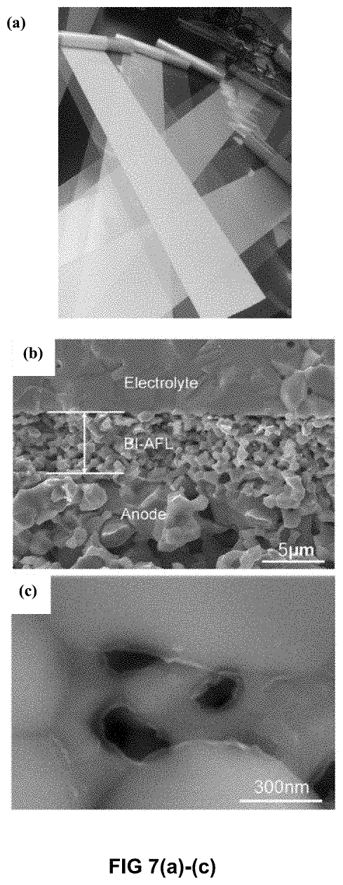

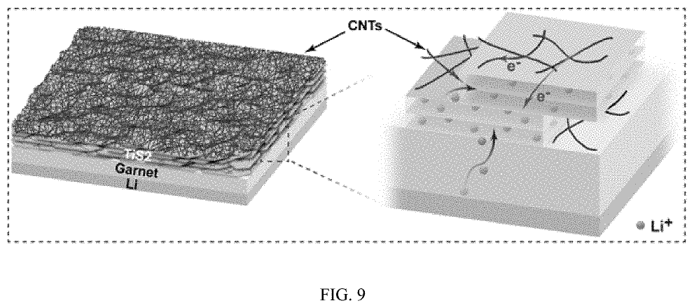

Sintering of low-density Li-garnet samples is responsible for a lot of the literature variability in conductivity (e.g., as shown in FIG. 6). The primary issue in obtaining dense SSEs is starting with submicron (or nano-scale) powders. By starting with nano-scale powders it is expected that the sintering temperature necessary to obtain fully dense electrolytes can be lowered. The nanoscale electrolyte and electrode powders can be made using co-precipitation, reverse-strike co-precipitation, glycine-nitrate, and other wet synthesis methods. These methods can be used to make desired Li-garnet compositions and to obtain submicron SSE powders. The submicron SSE powders can then be used in ink/paste formulations by mixing with appropriate binders and solvents to achieve desired viscosity and solids content. Dense thin-film (˜10 μm) garnet SSEs on porous SSE scaffolds (e.g., FIG. 9b) can be formed by tape casting (FIG. 7a), colloidal deposition, and sintering. The methods described can be used to create nano-dimensional electrode/electrolyte interfacial areas to minimize interfacial polarization (e.g., FIG. 7c). The symmetric scaffold/SSE/scaffold structure shown in FIG. 3 can be achieved by laminating a scaffold/SSE layer with another scaffold layer in the green state (prior to sintering) using a heated lamination press.

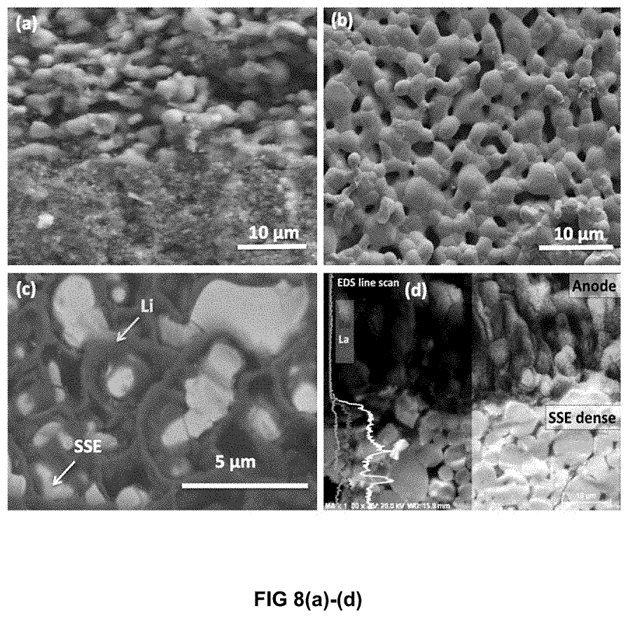

Cathode and anode integration. Nanosized (˜100 nm) cathode materials Li₂MMn₃O₈ (M=Fe, Co) can be synthesized. With the SSE that is stable up to 6V, a specific capacity of 300 mAh/g is expected. Slurries of cathode materials can be prepared by dispersing nanoparticles in N-Methyl-2-pyrrolidone (NMP) solution, with 10% (weight) carbon black and 5% (weight) Polyvinylidene fluoride (PVDF) polymer binder. The battery slurry can be applied to cathode side of porous SSE scaffold by drop casting. SSE with cathode materials can be heated at 100° C. for 2 hours to dry out the solvent and enhance electrode-electrolyte interfacial contact. Additional heat processing may be needed to optimize the interface. The viscosity of the slurry will be controlled by modifying solids content and binder/solvent concentrations to achieve a desired filling. The cathode particle size can be changed to control the pore filling in the SSE. In an example, all of the mobile Li will come from cathode (the anode SSE scaffold may be coated with a thin layer of graphitic material by solution processing to “start-up” electronic conduction in the cell). In another example, a thin layer of Li metal will be infiltrated and conformally coated inside anode SSE scaffold. Mild heating (˜400° C.) of Li metal foil or commercial nanoparticles can be used to melt and infiltrate the Li. Excellent wetting between Li-metal and SSE is important and was obtained by modifying the surface of the SSE scaffold (FIG. 8). To fill the SSE pores in the anode side with highly conductive graphitic materials, a graphene dispersion can be prepared by known methods. For example, 1 mg/mL graphene flakes can be dispersed in water/IPA solvent by matching the surface energy between graphene and the mixed solvent. Drop coating can be used to deposit conductive graphene with a thickness of ˜10 nm inside the porous SSE anode scaffold. After successfully filling the scaffold pores, the cell can be finished with metal current collectors. Al foil can be used for the cathode and Cu foil for the anode. Bipolar metals can be used for cell stacking and integration. To improve the electrical contact between electrodes and current collectors, a thin graphene layer may be applied. The finished device may be heated up to 100° C. for 10 minutes to further improve the electrical contact between the layers. The electrochemical performance of the SSLiB can be evaluated by cyclic voltammetry, galvanostatic charge-discharge at different rates, electrochemical impedance spectroscopy (EIS), and cycling performance at C/3. EIS can be used in a broad frequency range, from 1 MHz to 0.1 mHz, to investigate the various contributions to the device impedance, and reveal the interfacial impedance between the cathode and SSE by comparing the EIS of symmetrical cells with Li-metal electrodes. The energy density, power density, rate dependence, and cycling performance of each cell, as a function of SSE, electrode, SSE-electrolyte interface, and current collector-electrode interface can be determined.

Multi-cell (2-3 cells in series) SSLiBs with Al/Cu bipolar plates can be fabricated. The energy/power density and mechanical strength can be determined as a function of layer thicknesses and area.

### Further Embodiments

Recent advancements have been made in lithium-garnet interfaces, but improvements to the conductivity, thermal stability and/or capacity of cathode materials is desirable. The battery cells, systems and component elements described herein are directed toward improving these and other issues, offering a battery system capable of operating more safely and/or more reliably at high temperatures and with improved performance. The presently disclosed subject matter relates generally to a battery system, component electrodes and electrolytes, and their methods of use and manufacture. In certain embodiments, the battery system is a fully solid-state lithium-metal battery system. In certain embodiments, the battery system includes a garnet-based solid state electrolyte. In certain embodiments, the battery system includes a solution-processed cathode. In certain embodiments, the battery system includes an ionic liquid.

An all solid-state battery provides a promising option to use Li metal as anode for lithium batteries towards high energy and high power densities, compared to conventional lithium-ion batteries. Among all solid electrolyte materials ranging from sulfides to oxides and oxynitrides, cubic garnet Li₇La₃ZnO₁₂ (LLZO) phase based ceramic electrolyte should be the most superior candidate due to high ionic conductivity (10⁻³-10⁻⁴ S/cm) and good stability against Li. However, garnet solid electrolyte generally has a poor contact with cathode materials, which causes high surface resistance.

In an embodiment disclosed herein is a solution-coated cathode capable of achieving a truly all solid-state Li metal battery using garnet solid state electrolytes (SSEs). The two dimensional (2D) layered cathode materials can result in a low interfacial resistance and shows mixed ionic-electronic (MIE) conductivity especially after lithiation to enable cycling of all solid state batteries without a liquid or polymer electrolyte interface. Solution-processed carbon nanotubes offer a conformal coating for an efficient cathode-current collector interface with enhanced charge transport kinetics. Any MIE conductive materials, including TiS₂, MoS₂, WS₂, Vanadium sulfides, ZrS₂, NbS₂, TaS₂ CuS, FeS, NiS, and other metal sulfides and these metal sulfides coated cathode materials (Sulfur (S), Li₂S) or their mixture/composites cathodes, can be used as the cathodes for truly all solid state batteries with high MIE conductivity and low interfacial resistance. This disclosure discusses a main challenge of interface resistance between garnet solid state electrolytes and cathodes without using an unstable liquid or polymer interface, which can pave way to realize the truly all solid state Li metal batteries based on garnet SSEs.

The developed strategy can address the challenge of high interface resistance between cathode and solid state electrolyte. This battery system paves the way to the realization of a truly all solid state Li metal battery based on garnet SSEs for high energy densities and improved safety. An all solid state battery is a promising option to realize the use of Li metal as anode electrode due to the solid nature of electrolyte that can block Li dendrite effectively and meanwhile benefit from other prominent features including large electrochemical stability window (0-5V), superior thermal stability, and direct multiple stacking for high voltage. In addition, this non-liquid system allows battery to have better endurance at high voltage and high temperature, thus truly all solid state battery is featuring high energy and high safety compared to liquid electrolyte and some polymer electrolyte systems.

The following presents example embodiments of the battery system. The invention shall not be limited to the electrode and electrolyte materials presented hereafter.

One of the main challenges to develop all solid state lithium (Li) metal batteries is the poor contact and thus the high interfacial resistance between conventional slurry-based electrodes and solid state electrolytes (SSEs). Recently, significant improvements have been made toward effective Li-garnet interfaces. Due to the poor conductivity and rigid granular morphology of cathode materials, the cathode-garnet interface is much worse and has little progress. In this disclosure, among other things, we demonstrate an all solid state Li metal battery using a solution-coated TiS₂ cathode and garnet SSE. The two dimensional (2D) layered TiS₂ can result in a low interfacial resistance and shows mixed ionic-electronic (MIE) conductivity after lithiation to enable cycling of all solid state batteries without a liquid or polymer electrolyte interface, however this technology can also in some embodiments be used with a liquid or polymer electrolyte interface or an ionic liquid interface or electrolyte. Solution-processed carbon nanotubes offer a conformal coating for an efficient cathode-current collector interface with enhanced charge transport kinetics. Given the excellent chemical stability of the Li metal anode, garnet SSE, and TiS₂ cathode, the demonstrated all solid state batteries can work at high temperatures from 100° C. to 150° C. for 400 cycles at current densities up to 1 mA/cm².

Lithium (Li) metal batteries are one of the most promising and attractive candidates for future high energy density storage applications, given the high theoretical specific capacity (3.86 Ah/g) and the lowest reduction potential (−3.05 V) of Li metal. Solid state electrolytes (SSEs), especially cubic garnet phase SSEs, are one of the most effective and promising candidates to achieve safe Li metal batteries because of their non-flammability and ability to mechanically block Li dendrites. Moreover, garnet based SSEs also have excellent chemical stability with Li metal and high ionic conductivity comparable to liquid electrolytes. Nevertheless, unlike liquid-based systems, SSEs encounter new challenges including high interfacial resistance arising from the poor contact between SSE and electrodes. Due to the low melting point (180.5° C.) of Li metal, it can in some embodiments be advantages for the anode interface to be well addressed by a number of surface treatments to lower the Li-garnet interfacial resistance to several tens of Ω·cm² from greater than 1000 Ω·cm². Due to the high electronic and ionic conductivity of metallic Li, the poor contact and high interfacial resistance at the anode interface is possible, but can be improved or resolved after addressing the wetting of Li metal on garnet SSE.

Both the poor conductivity and rigid granular morphology of cathode powders result in high interfacial resistance and inefficient Li transport in solid state systems. Therefore, the cathode interface has become the main challenge to develop garnet-based all solid state batteries. To fabricate functional solid state batteries, polymer-ceramic composite electrolytes and solid-liquid hybrid electrolytes have been previously introduced to address the cathode-garnet interface in solid state batteries. However, these non-solid interfaces can in some embodiments introduce potential safety concerns in Li-metal batteries and/or sacrifice the temperature stability and/or wide potential window of all solid state electrolytes. Truly all solid state batteries do not use any liquid or gel electrolyte interface, but can face challenges such as poor interface contact and conductivities, especially at the cathode. There is no low-cost, high performance interface engineering solution at the cathode to date for garnet based all solid state batteries.

In an ideal solid state cathode for garnet based batteries, both the electronic and ionic conductivity of the cathode materials could be improved fundamentally to enable faster Li transport. In this work, we developed a truly all solid state Li metal battery using titanium sulfide (TiS₂), a mixed ionic-electronic conductor as the cathode material. As a two-dimensional (2D) material, TiS₂ has high electronic conductivity and was first studied for Li-ion battery cathodes by Stanley Whittingham four decades ago. Recently, it has been reapplied as a conductive coating to improve the performance of Li sulfur batteries. After lithiation, the layered structure enhances the ionic conductivity for Li transport. Therefore, TiS₂ is an effective cathode material for all solid state batteries and has been demonstrated by co-pressing with soft solid state electrolytes, including sulfide and LiBH₄ electrolytes. Here, we demonstrated a truly all solid state full battery with garnet-based SSE, which is known to be stable with Li metal and has a wide potential window. Unlike the former approaches requiring complex deposition techniques or post treatments, the cathode can be directly deposited on the surface of garnet SSE using a cost-effective and scalable solution-based process. Without any additional electrolytes, binders, or interfaces, all solid state batteries are successfully cycled at high temperatures from 100° C. to 150° C. with high current densities up to 1 mA/cm².

FIG. 9 illustrates a schematic of an embodiment of a Li-Garnet-TiS₂ (LGTS) all solid state battery. Note that each component in this embodiment is homogeneous, which simplifies the Li transport process. The Li metal anode was coated on the surface of the garnet SSE following a previously reported method. Metallic Li is an excellent electronic and ionic conductor therefore, there are no concerns regarding the Li transport and charge transfer with the anode. As a mixed electronic-ionic conductor, the TiS₂ cathode can in some embodiments avoid any conductive additives, electrolyte, or binder. The two-dimensional (2D) sheet structure enables the TiS₂ cathode to have good contact with the garnet SSE and also facilitates Li transport across the interface and along the TiS₂ flakes. During the lithiation process, both the electronic and ionic conductivities of TiS₂ can be improved, which will further promote the electrochemical reaction at the cathode. Therefore, lithiation can be a self-promoted electrochemical process in the TiS₂ based all solid state battery. To ensure good electronic contact with the current collector, a thin layer of carbon nanotubes (CNTs) was also coated using a solution-based process on the TiS₂ cathode. Compared to a conventional metal foil current collector, the solution-processed CNTs have much lighter weight and can form a conformal coating on the cathode. Due to the capillary effect of the porous TiS₂ layer, some CNTs can partially penetrate into TiS₂ flakes, which can enable an interconnected electron pathway and further facilitate electron transport from the CNT network to the TiS₂ cathode. The solution-processed cathode and current collector are facile yet effective and critical to achieve the truly all solid state Li metal batteries.

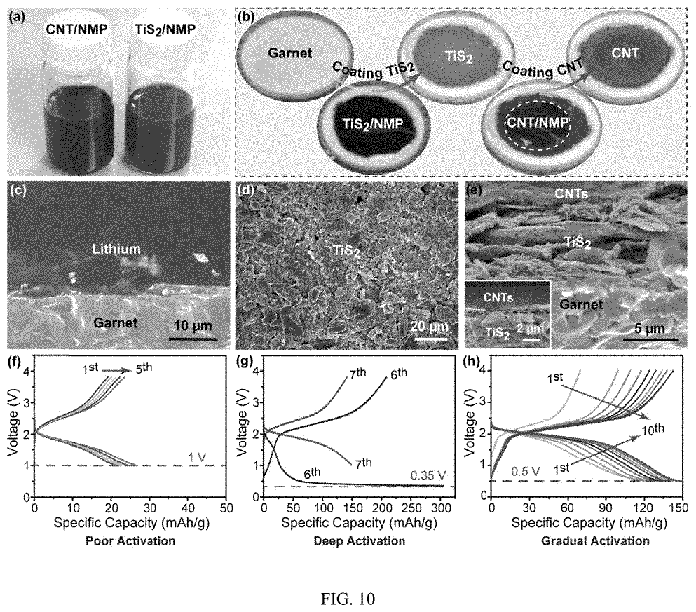

FIG. 10a shows a photograph of an embodiment of the CNT and TiS₂ solutions from commercially available TiS₂ and P3-CNTs. In this embodiment, the precursors are sonicated and dispersed in N-Methyl-2-pyrrolidone (NMP) solvent before directly coating on garnet SSE in two steps, as shown in FIG. 10b. Prior to the solution-based coating of the cathode, the anode electrode was prepared by melting Li metal on the garnet SSE following a method reported separately, and can be performed as disclosed herein. A typical cross-sectional scanning electron microscopy (SEM) image of the Li-garnet interface is shown in FIG. 10c, with conformal contact of Li on the garnet surface. The continuous and tight contact results in an interfacial resistance as low as tens of Ω·cm² at the Li metal anode interface. After sonication and coating of the TiS₂ precursor on the garnet SSE, there is no further treatment of the solution-coated TiS₂ cathode. FIG. 10d provides evidence that sonication partially breaks and exfoliates TiS₂ flakes into a wide size distribution from sub-micrometer to about 20 μm. In the cross-sectional SEM image (FIG. 10e), the TiS₂ flakes overlap and form a well-connected film which ensures continuous pathways for Li and electron transport. Due to the capillary effect, some of the solution-coated CNTs can also be found between TiS₂ flakes and form a thin film of approximately 2 μm on the top of TiS₂ layer (FIG. 10e). This 2 μm lightweight CNT film can offer a sheet resistance of several tens of Ω/□.

Unlike most garnet based solid state batteries that depend on a liquid or polymer interface to facilitate Li transport, the LGTS batteries presented in this disclosure are truly all solid state batteries. To ensure fast enough Li transport, the batteries were cycled at temperatures between 100 to 150° C. A self-activation process for the TiS₂ cathode is observed during cycling. FIGS. 10f and 2g exhibit the voltage profiles of a LGTS battery cycled at a current density of 20 mA/g within different voltage ranges at 100° C. Initially, the battery was cycled from 1 to 4 V. The capacity of the LGTS battery during the first five cycles slowly increases but remains less than 30 mAh/g (FIG. 10f). At the sixth cycle, the discharge voltage was decreased to 0.35 V, and a discharge plateau at about 0.35 V is observed, significantly increasing the specific capacity to more than 300 mAh/g (FIG. 10g). In the following charge stage, the specific charge capacity also increased up to 208 mAh/g. After setting the discharge voltage back to 1 V for the seventh cycle, the specific discharge and charge capacities are still as high as 150 mAh/g and 141 mAh/g, respectively. Moreover, the discharge plateau increases to between 1.5 to 2 V, and the overpotential decreases significantly. These attributes of the LGTS batteries are indicative of a self-facilitating process. Since the pristine TiS₂ flakes do not contain Li ions, the initial lithiation process requires additional energy to intercalate the TiS₂ flakes, leading to a low discharge plateau. When the discharge voltage was set above 1 V, the TiS₂ flakes were barely activated, which results in a poor activation process and low specific capacities. When the discharge voltage was set below 0.35 V, a deep activation process was achieved, where most of the TiS₂ flakes were lithiated in one step. Since the lithiated TiS₂ flakes are mixed electronic-ionic conductors that can further facilitate Li transport and the activation process, a gradual activation process is also possible. To demonstrate this gradual activation process, additional LGTS batteries were tested with a potential window from 0.5 to 4 V at a current density of 50 mA/g. The first ten cycles exhibit a similar activation process as the specific capacity increases and the overpotential decreases (FIG. 10h). The Columbic efficiency also increases from 56 to 96%) in the first ten cycles. The irreversible capacity is accredited to make TiS₂ a Li ion conductor, which enables the following cycles to have a high Columbic efficiency.

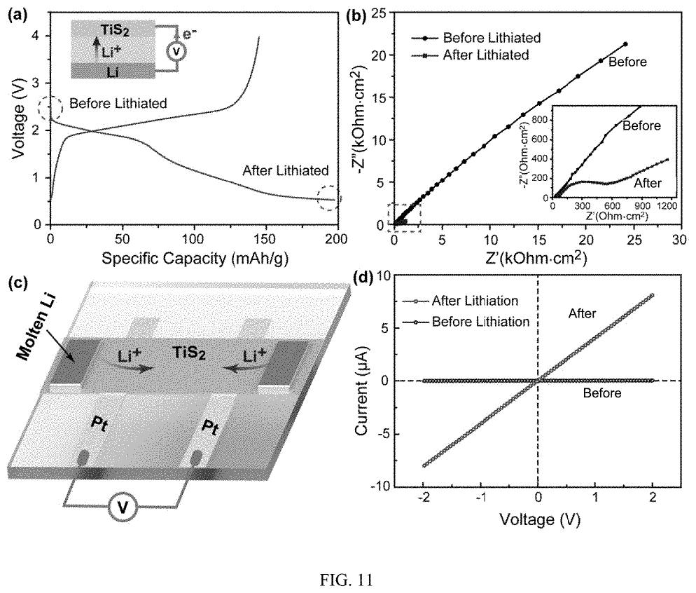

To better understand the self-improving behavior during the initial cycles in the LGTS batteries, we studied the change in ionic conductivity of TiS₂ after lithiation by electrochemical impedance spectroscopy (EIS) and the change in electronic conductivity by I-V measurements. The EIS spectra of the LGTS batteries measured before and after the first discharge at 100° C. are shown in FIG. 11b, and are marked on the voltage profile in FIG. 11a. The EIS of the as-made LGTS cell has a long diffusion tail indicating a large Li diffusion distance into the TiS₂ flakes before lithiation. After the first discharge, the EIS curve has a much shorter tail in the low frequency range and the overall resistance decreases 20 times from more than 25,000 Ω·cm² to only approximately 1,200 Ω·cm² (inset of FIG. 11b). A semicircle of approximately 600 Ω·cm² comes out, which should be the interfacial resistance between the lithiated TiS₂ cathode and garnet SSE. To further study the electronic conductivity change by I-V measurements, a TiS₂ thin film strip was coated on a glass substrate with two platinum electrodes (FIG. 11c). The lithiation process was simply performed by melting Li on the two ends of TiS₂ strip at about 250° C. so that Li can diffuse along the TiS₂ film. After contacting with molten Li for about 1 hour, even the TiS₂ film was not fully lithiated according to its color change, the electronic conductivity of the TiS₂ film significantly improves by a factor of 500 from 5.7×10⁻⁵ S/cm to 2.9×10^{0.2} S/cm (FIG. 11d). Therefore, the pristine TiS₂ has relatively low electronic and ionic conductivity, which limits its electrochemical performance at the beginning. As the lithiation process goes, TiS₂ becomes an excellent mix ionic-electronic conductor, which further facilitates the charge transfer during cycling and therefore improves the electrochemical performance.

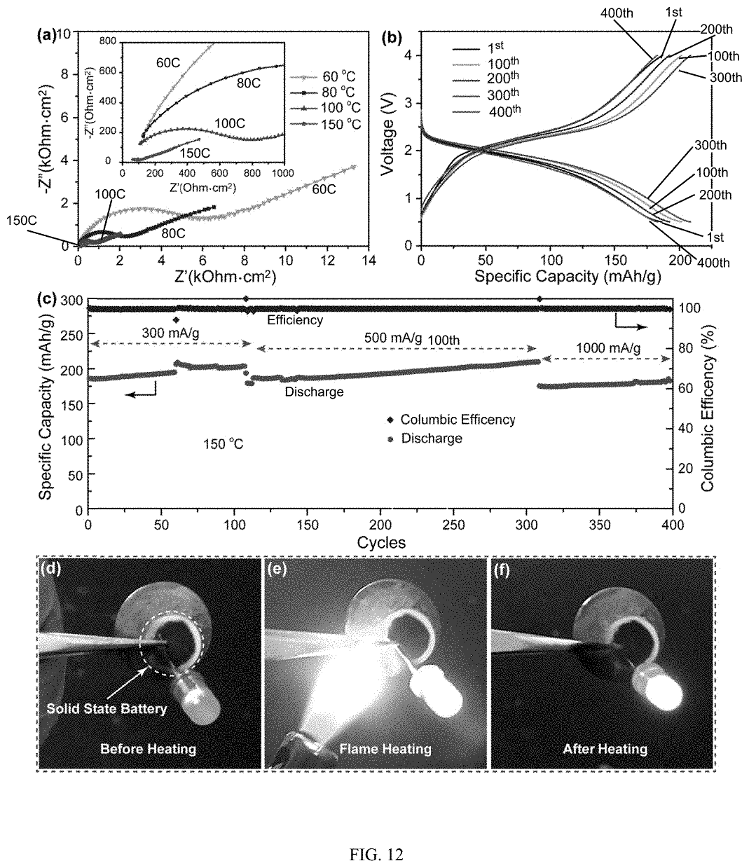

Given the good chemical stability of each component in a wide temperature range, one of the main advantages for the LGTS all solid state batteries is for high temperature applications. The ionic conductivity of garnet solid state electrolyte and the TiS₂ cathode are highly dependent on operating temperature. In this work, the LGTS all solid state batteries are tested at high temperatures up to 150° C., close to the melting point of lithium metal, 180.5° C. As shown in FIG. 12a, the EIS spectra of the LGTS batteries changes dramatically with temperature. When the temperatures were increased from 60° C. to 150° C., the resistance from the electrolyte and interfaces decreases from more than 6,000 Ω·cm² to less 100 Ω·cm². The diffusion tails also drop from more than 13,000Ω·cm² to less than 500 Ω·cm². Therefore, the high temperature can significantly facilitate the Li transport, which activates every component including the garnet SSE, interfaces, and the TiS₂ cathode in the LGTS all solid state batteries.

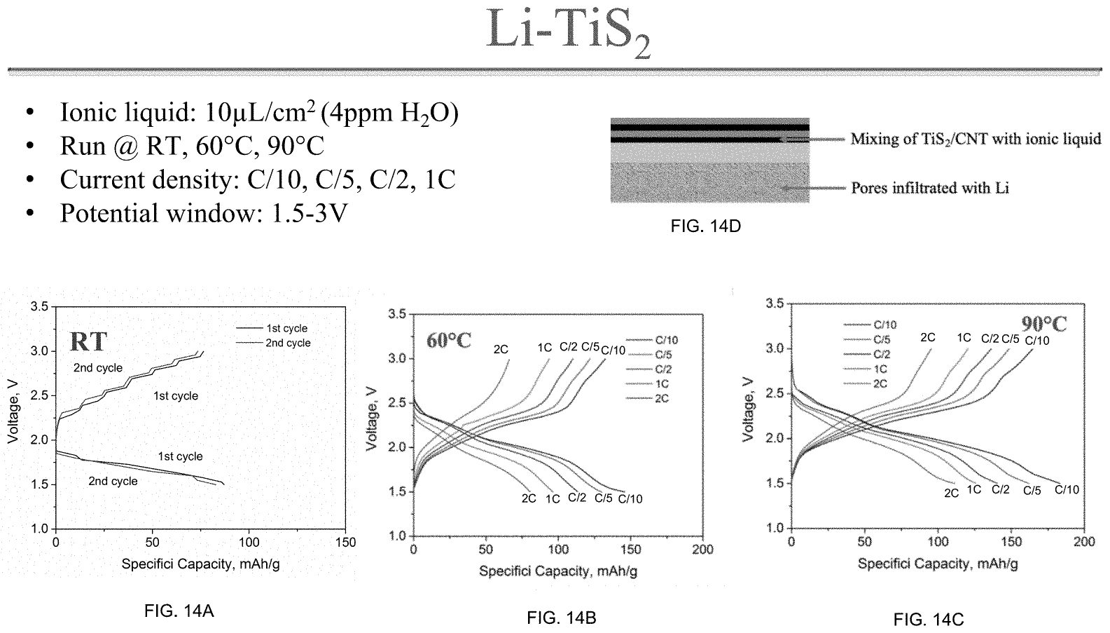

The LGTS battery activated at 100° C. in FIG. 10d was cycled at 150° C. under 300 mA/g, initially. The corresponding voltage profiles and cycling performance are shown in FIGS. 12b and 12c, respectively. Given the low overall resistance at high temperatures, the overpotential observed is relatively small for the LGTS batteries (FIG. 12b) and the specific capacity slowly increased from approximately 185 mAh/g to approximately 200 mAh/g after 60 cycles. The sudden increase in the specific capacity after the 60th cycle is due to unintended fluctuations in the heat source. When the current density was increased to 500 mA/g at 100th cycle, the specific capacity drops to approximately 180 mAh/g but then slowly increases to approximately 210 mAh/g in the next 200 cycles. A similar trend is observed after increasing the current density to 1000 mA/g, in which the initial and ending specific capacities are 175 and 185 mAh/g, respectively. The slow capacity increase should be due to the improvement of the interface and the further activation of the TiS₂ cathode during the cycling. The mass loading of the TiS₂ cathode is 1 mg/cm² and the current density for garnet SSE reaches 1 mA/cm², which is among the highest current densities achieved for garnet based all solid state batteries. As previously mentioned, the battery was pre-activated at 100° C. (FIG. 10d) and as a result, the Columbic efficiency during 400 cycles at 150° C. is dose to 100%. This confirms the good reversibility and stability of TiS₂ cathode at high temperatures after the cathode activation process and for applications at room temperature, the LGTS batteries are shown in FIGS. 14A and 15 are also shown to have sufficient ionic conductivity to function effectively. Given the porosity of the TiS₂ cathode, the interface and conductivity of the cathode can be improved to enable LGTS batteries at room temperature.

Regarding batteries with liquid or polymer electrolytes, high temperatures can result in malfunction as well as serious safety concerns due to the flammability or volatility of organic and aqueous components, respectively. The significantly improved cycling performance of the LGTS battery at high temperatures demonstrates the reliability of truly al solid state batteries for certain high temperature applications, such as electric vehicles, military and aerospace exploration. To further demonstrate the outstanding stability and safety of the LGTS all solid state battery for commercial applications, a flame test was conducted. More specifically, the Li metal anode was sealed in polydimethylsiloxane (PDMS), while the TiS₂ cathode and CNTs current collector are exposed as shown in FIG. 12d. The as-made LGTS battery can successfully light a green light-emitting diode (LED) without any noticeable change while being directly heated by a flame. Instead, the temperature increase due to the flame improved the conductivity of the garnet SSE and therefore made the green LED much brighter (FIG. 12e). After removing the flame, the remained high temperature still keep the LED brighter (FIG. 12f). Therefore, the LGTS all solid state battery demonstrates good stability and high safety for high temperature applications.

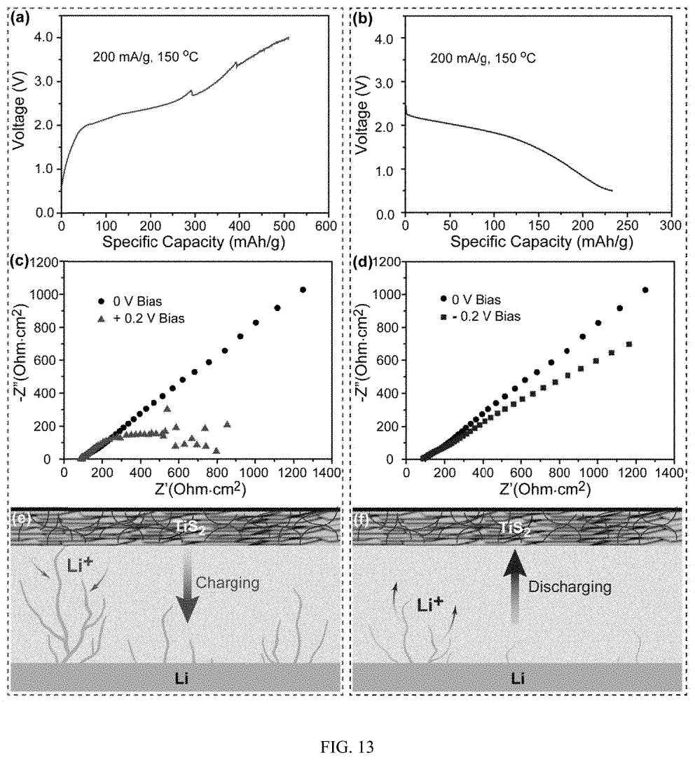

After 400 cycles, an unstable, asymmetrical short-circuit was noticed in the aforementioned LGTS all solid state battery. The voltage profiles after the occurrence of the short-circuit are shown in FIGS. 13a and 13b. In each subsequent cycle, the battery is still stable up to 2 V and then diverges such that the charge capacity exceeds the theoretical capacity (FIG. 13a). The discharge profile is stable and the discharge capacity remains close to the values before the short-circuit, around 230 mAh/g (FIG. 13b). Without wishing to be limited by theory, we believe that a dynamic short-circuit mechanism that occurs when charged above approximately 2 V. The short-circuit in the cell is then removed after Li cycled back to cathode in the following discharge stage.

To further characterize the dynamic properties of the short circuit, EIS measurements with a bias voltage were conducted and shown in FIGS. 13c and 13d. Specifically, the short-circuited LGTS batteries were stopped at 2 V during the charge process, before the noisy short-circuit is formed, and then the EIS spectra were measured while applying a small bias voltage. Under no applied bias voltage, the EIS curve of the respective battery is stable and has normal diffusion tail. However, when a positive bias voltage (+0.2 V) is applied, the LGTS battery is put under a charged state, and the EIS curve starts to deviate and degrade particularly in the low frequency range (FIG. 13c). When a negative bias voltage (−0.2 V) applied, the battery is put under a state of discharge and the EIS curve recovers (FIG. 13d). The analysis from EIS further confirms that the unstable dynamic short-circuit forms during the charging process. The illustrations in FIGS. 13e and 13f schematically show the dynamic short-circuit evolution during charge-discharge process. While charging, Li is plated on Li-rich filament phases of the Li metal anode, which continue to grow toward the cathode and lead to short-circuits (FIG. 13e). When the battery is discharging, Li on the Li-rich filaments will be stripped first, which eliminates the short-circuit temporarily heals the short-circuit (FIG. 13f). This is the first time that asymmetrical short-circuit behavior has been observed in garnet-based all solid state Li metal batteries. Our future work will delve deeper into the transport of Li and the properties of dynamic short-circuits in solid state batteries using advanced tools such as neutron depth profiling. This dynamic short-circuit may result in low energy efficiency, but does not produce any serious safety concerns.

In a further embodiment, FIG. 14D shows an embodiment of a battery having a bi-layer solid solid-state electrolyte (solid state electrolyte was garnet electrolyte of Li_{6.75}La_{2.75}Ca_{0.25}Zr_{1.75}Nb_{0.25}O₁₂ stoichiometry, produced by methods described herein to result in a porous-dense bilayer structure was used, but other solid-state electrolytes, including those described herein can also be used) with a porous region and a dense region. The pores of the porous region were infiltrated with lithium metal and a cathode was formed on a face of the dense region opposite the porous region. The cathode included a mixture of TiS₂ and carbon nanotubes (CNT) with ionic liquid (Pyr1,4TFSI was used, but other ionic liquids that are chemically compatible with the solid-state electrolyte and the cathode material can also be used) present at 10 μL/cm². Testing of specific capacity and Coulombic Efficiency are shown in FIGS. 14A-C-15. The battery was subjected to multiple charge/discharge cycles at different temperatures and different current densities. Temperatures tested were room temperature (RT), 60 and 90° C. Current densities tested included current densities to fully charge or discharge in 0.5 hr (2C), 1 hr (1C), 2 hr (C/2), 5 hr (C/5), and 10 hr (C/10.)

In a second further embodiment, FIG. 16 shows an embodiment of a battery having a lithium anode region located on a face of a solid-state electrolyte (SSE) (e.g. lithium-garnet), and a cathode on a face of the SSE opposite the anode, where the cathode include mixed ionic-electronic conductor (MIE) with sulfur particles embedded in the MIE. As shown in FIG. 16, the sulfur particle can be lithiated to a lithiated sulfur compound, such as Li₂S compounds having other ratios of lithium to sulfur. In this embodiment, the MIE provides both electrical and ionic conductivity between a charge collector and the SSE, respectively and the sulfur/lithiated sulfur embedded in the MIE.

In summary, we successfully demonstrated an all solid state Li metal battery with garnet solid state electrolyte. The sonication-dispersed TiS₂ solution was directly coated on the garnet surface without any additional treatments or additives. Due to the 2D sheet structure of the TiS₂ flakes, there is plenty of contact area between the solid state cathode and garnet surface as indicated by the electrochemical performance. The solution-coated light weight CNTs thin film acts as a conformal current collector for the TiS₂ cathode and successfully addresses previous cathode-current collector interface issues. After lithiation, the TiS₂ cathode has sufficient MIE conductivity to cycle in LGTS all solid state batteries without any liquid or polymer electrolyte interfaces at 150° C. for 400 cycles. The excellent stability of the garnet SSEs and electrode materials in the LGTS all solid state batteries is confirmed at current densities up to 1 mA/cm².

The non-flammability of each component is further demonstrated by flame tests under LED operating conditions. Asymmetrical dynamic short-circuits are observed and characterized for the first time in garnet based solid state batteries. Further work to investigate this short-circuiting phenomena will be key to developing practical all solid state Li metal batteries.

### Example 2

Synthesis of garnet solid state electrolytes. Cubic phase garnet electrolyte of Li_{6.75}La_{2.75}Ca_{0.25}Zr_{1.75}Nb_{0.25}O₁₂ stoichiometry was synthesized by following previous methods. Specifically, stoichiometric amounts of LiOH.H₂O (Alfa Aesar, 98.0%), La₂O₃ (Alfa Aesar, 99.9%), CaCO₃ (Alfa Aesar, 99.0%), ZrO₂ (Inframat® Advanced Materials, 99.9%) and Nb₂O₅ (Alfa Aesar, 99.9%) were thoroughly ball milled in isopropanol for 24 h. To compensate for vitalization of lithium during the calcination and sintering processes, 10 wt % excess LiOH.H₂O was added. After the well-mixed precursors were dried, pressed and calcined at 900° C. for 10 h, the as-calcined pellets were broken down and ball-milled for 48 h in isopropanol. The dried powders were then pressed into 12.54 mm diameter pellets at 500 MPa, which were fully embedded in the mother powder and sintered at 1050° C. for 12 h. Alumina crucibles are used during the whole synthesis process. The as-made garnet pellets are about 1 cm in diameter and are mechanically polished on both sides to about 500 μm thickness for the battery testing.

Cell preparation. The TiS₂ solution was made from titanium sulfide powder (200 mesh, Sigma-Aldrich). A mixture of 100 mg TiS₂ powder and 5 mL N-Methyl-2-pyrrolidone (NMP) was bath sonicated (FS 110D, Fisher Scientific) for 1 hour. The final concentration of the as-made solution was 20 mg/mL The CNT solution was made by sonicating approximately 10 mg P3 (Carbon Solution) single wall carbon nanotubes (SWCNTs) in 5 mL NMP solvent with a probe sonicator (SONICS&MATERIALS, MODEL: VC505, 500 W) using the pulse mode(1 second on, 1 second off, 25% Amplitude) for approximately 20 min, which results in 2 mg/mL CNTs solution. To make LGTS all solid state batteries, one side of the fresh-polished garnet pellets was first coated with Li metal anode by following the previous method. Specifically, the garnet pellets were directly placed and smeared on the molten Li—Sn alloy (30-50 wt % of Sn) at about 250° C. for less than 1 minutes to ensure a conformal coating. Then the TiS₂ solution and CNT solution were sequentially coated on the other side of garnet pellet to achieve a mass loading of 1 mg/cm² for TiS₂ cathode and 0.1 mg/cm² for CNTs current collector.

Electrochemical measurement. Electrochemical tests of the LGTS batteries were conducted on a BioLogic VMP3 potentiostat. The electrochemical impedance spectra (EIS) were performed with a 30 mV AC amplitude in the frequency range of 100 mHz to 1 MHz. For the EIS measurement with bias voltage, +0.2 V or −0.2 V constant bias voltages were applied, while the other parameters are the same. Galvanostatic charge-discharge of the LGTS batteries was recorded at temperatures from 60 to 150° C. with current densities from 20 mA/g to 1000 mAV/g. The cells were placed in an argon filled glovebox to conduct all measurements. A small box furnace was used to control the temperatures. For the open flame burning test of the LGTS battery, the edges of the battery were sealed with Polydimethylsiloxane (PDMS). A green LED was attached and a lighter was used to burn the LGTS battery. To measure the electronic conductivity of the TiS₂ thin film strip before and after lithiation, a 5 cm×5 mm×15 μm TiS₂ thin film was coated on a glass substrate with two platinum electrodes. The lithiation process was conducted by melting Li on the two ends of TiS₂ strip at 250° C. for about 1 h followed by I-V measurements.

Materials characterization. The morphologies the Li anode-garnet cross section, TiS₂ cathode and CNTs current collector were conducted on a Tescan XEIA Plasma FIB/SEM at 10 kV.

### Additional Disclosure, Embodiments and Examples

Further discussion of structures and methods applicable to battery cells, batteries and associated components follows.

The present disclosure provides ceramic ion-conducing structures and methods of fabricating ceramic ion-conducing structures from ceramic ion-conducting materials. Also provided are uses of ceramic ion-conducing structures.

All ranges disclosed herein are inclusive of their upper and lower limits, and include each value there between to the hundredth decimal place, and all ranges within those limits.

In an aspect, the present disclosure provides ceramic ion-conducing structures (e.g., ceramic ion-conducing materials having particular structural features and/or properties). The structures can be in the form of a single layer or multilayer structures. For example, a multilayer structure can comprise layers of ceramic ion-conducing structures, where the individual layers have the same or different porosity. The ceramic ion-conducing structures can be ion-conducting electrolyte materials (e.g., solid-state electrolyte materials). The ion-conducing ceramic structures can be formed by a method (e.g., a tape casting method) disclosed herein. For example, a ceramic ion-conducing structure is formed by a method disclosed herein.

A ceramic ion-conducting structure can be a layer. For example, a layer has a dimension (e.g., a thickness perpendicular to the longest dimension of the material) of 1 μm to 200 μm, including all 0.1 micron values and ranges therebetween.

The ceramic ion-conducing structures can have a dense region (e.g., a dense layer) and one (e.g., a bilayer structure) or two (e.g., a triple layer structure) porous regions (e.g., porous layer(s)). The porosity of the dense region is less than that of the porous region(s).

A cathode material and/or an anode material can be disposed on a porous region of a ceramic ion-conducing structure forming a discrete cathode-material containing region and/or a discrete anode-material containing region of the ceramic ion-conducing structure. For example, each of these regions of the ceramic ion-conducting structure has, independently, a dimension (e.g., a thickness perpendicular to the longest dimension of the material) of 1 μm to 200 μm, including all 0.1 micron values and ranges therebetween.

The dense regions and porous regions described herein can be discrete dense layers and discrete porous layers. Accordingly, the ceramic ion-conducing structures can have a dense layer and one or two porous layers.

The ceramic ion-conducing structures conduct ions (e.g., lithium ions, sodium ions, or magnesium ions), for example, between the anode and cathode. The ceramic ion-conducing structures can be an ion-conducting solid-state electrolyte material for a battery or battery cell and can have a dense region (e.g., a dense layer) that is supported by one or more porous regions (e.g., porous layer(s)) (the porous region(s)/layer(s). The dense region of a ceramic ion-conducing structure is, for example, free of pin-hole defects.

The ceramic ion-conducing structures can have a dense region (e.g., a dense layer) and two porous regions (e.g., porous layers), where the porous regions are disposed on opposite sides of the dense region and cathode material is disposed on one of the porous regions and the anode material on the other porous region. If cathode material is disposed on the porous region, a conventional battery anode (e.g., a solid-state battery anode) can be formed on the opposite side of the dense region by known methods. If anode material is disposed in the porous region, a conventional battery cathode (e.g., a solid-state battery cathode) can be formed on the opposite side of the dense region.

The ceramic ion-conducing structure (e.g., a multilayer ceramic ion-conducting structure) can have a dense region. The dense region can be free of the cathode material and anode material. For example, this region has a dimension (e.g., a thickness perpendicular to the longest dimension of the material) of 1 μm to 100 μm, including all 0.1 micron values and ranges therebetween. In another example, this region has a dimension of 5 μm to 40 μm. The dense region has less than 5% porosity. In various examples, the dense region has less than 4% porosity, 3% porosity, 2% porosity, or 1% porosity. Porosity can be determined by methods known in the art. For example, porosity can be determined by electron microscopy methods.

A porous region (e.g., porous layer) of the ceramic ion-conducing structure has a porous structure. The porous structure can have microstructural features (e.g., microporosity such as, for example, micropores less than 2 nm in size (e.g., longest dimension of a pore aperture)) and/or nanostructural features (e.g., nanoporosity). For example, each porous region, independently, has a porosity of 40% to 90%, including all 0.1% values and ranges therebetween. In another example, each porous region, independently, has a porosity of 40% to 70%. Where two porous regions are present the porosity of the two layers may be the same or different. The porosity of the individual regions can be selected to, for example, accommodate processing steps (e.g., higher porosity is easier to fill with electrode material (e.g., charge storage material) (e.g., cathode)) in subsequent screen-printing or infiltration step, and achieve a desired electrode material capacity, i.e., how much of the conducting material (e.g., Li, Na, Mg) is stored in the electrode materials. The porous region (e.g., layer) provide structural support to the dense layer so that the thickness of the dense layer can be reduced, thus reducing its resistance. The porous layer also extends ion conduction of the dense phase (solid electrolyte) into the electrode layer to reduce electrode resistance both in terms of ion conduction through electrode and interfacial resistance due to charge transfer reaction at electrode/electrolyte interface, the later improved by having more electrode/electrolyte interfacial area. For example, pore size can range from 100 nm to 200 microns, including all 0.1 micron values and ranges therebetween. The pores can have any morphology. Any pore morphology can be obtained based on selection of an appropriate pore-forming material. For example, PMMA is spherical, while the graphite is flakes. Other pore-forming materials with different morphologies can be used, such as spheres, rods, flakes, or irregular shapes such as, for example, a coral-like structure and string-like particles.

The ceramic ion-conducing structures (e.g., ceramic ion-conducting layer(s)) can have a random or an ordered porous structure. For example, a porous ceramic ion-conducing layer comprises pores that connect opposing sides of the layer. For example, a porous ceramic ion-conducing structure comprising multiple layers comprises a porous layer and a dense layer and the porous layer has pores extending from an outer (exposed) surface of the porous layer to the interface between the porous layer and dense layer. The ordered porous structure can be columnar structure (e.g., a columnar structure having a tortuosity of 1). The ordered structure can comprise patterns (e.g., grids) of non-planar structures in a layer or layers of a ceramic ion-conducing structure. The ordered structure can be formed by, for example, templating or 3-D printing methods.

Dendrites can form when lithium is cycled to the anode side. If dendrites of lithium form, they must not be able to protrude through the dense layer and contact the other electrode. It is desirable that a ceramic ion-conducing structure is hard enough and dense layer dense enough to prevent dendrites from propagating across the structure. It is desirable that a ceramic ion-conducing structure not allow dendrites to form (form dendrites) during cycling. Accordingly, in an example, the ceramic ion-conducing material (or a ceramic ion-conducting structure) does not have observable dendrites (e.g., lithium dendrites). Dendrites can be observed by methods known in the art. For example, the presence or absence of dendrites is determined by electron microscopy methods.

The ceramic ion-conducting structures can be in the form of a layer or layers (e.g., a layer or layers formed by tape casting). It is desirable that cells comprising one or more of the layers be stacked compactly and without flexing to the point of breaking. This is dependent on material and cell length, width and thickness dimensions. It is desirable that individual layers be flat. For example, a layer has a maximum P-V Error of 325 μm, where P-V Error=Peak height−Valley height. In various examples, a layer has a maximum P-V Error of 350 μm, 375 μm, 400 μm, 425 μm, 450 μm, 475 μm, or 500 μm.

The ceramic ion-conducing structure can comprise a ceramic ion-conducting material (e.g., a solid-state, ion-conducting electrolyte material). The ceramic ion-conducing structure can comprise a solid-state electrolyte (SSE), lithium-containing material. For example, the solid-state electrolyte, lithium-containing material is a lithium-garnet SSE material.

The ceramic ion-conducing material can be a Li-garnet material comprising cation-doped Li₅ La₃M′₂O₁₂, cation-doped Li₆La₂BaTa₂O₁₂, cation-doped Li₇La₃Zr₂O₁₂, and cation-doped Li₆BaY₂M′₂O₁₂. The cation dopants are calcium, barium, yttrium, zinc, or combinations thereof and M′ is Nb, Zr, Ta, or combinations thereof.

For example, the Li-garnet material comprises Li₅La₃Nb₂O₁₂ Li₅La₃Ta₂O₁₂ Li₇La₃Zr₂O₁₂, Li₆La₂SrNb₂O₁₂, Li₆La₂BaNb₂O₁₂, Li₆La₂SrTa₂O₁₂, Li₆La₂BaTa₂O₁₂, Li₇Y₃Zr₂O₁₂, Li_{6.4} Y₃Zr_{1.4}Ta_{0.6}O₁₂, Li_{6.5}La_{2.5}Ba_{0.5}TaZrO₁₂, Li₆BaY₂M¹₂O₁₂, Li₇Y₃Zr₂O₁₂, Li_{6.75}La_{2.75}Ca_{0.25}Zr_{1.5}Nb_{0.5}O₁₂, Li_{6.75}BaLa₂Nb_{1.75}Zn_{0.25}O₁₂, or Li_{6.75}BaLa₂Ta_{1.75}Zn_{0.25}O₁₂. For example, the Li-garnet material is Li₇La_{2.75}Ca_{0.25}Zr_{1.75}Nb_{0.25}O₁₂.

The ceramic ion-conducing structure can comprise a sodium-containing, solid-state electrolyte material. For example, the ceramic ion-conducing material can be Na₃ZrSi₂PO₁₂ (NASICON) or beta-alumina.

The ceramic ion-conducing structure can comprise a solid-state electrolyte, magnesium-containing material. For example, the magnesium ion-conducting electrolyte material is MgZr₄P₆O₂₄.

Standard x-ray diffraction analysis techniques may be performed to identify the crystal structure and phase purity of the ceramic ion-conducting structures.

In an aspect the present disclosure provides methods of fabricating ceramic-ionic conducing structures. The methods are based on particular slurry formulation methods and/or particular sintering methods. The methods can be tape casting methods.

A method of fabricating ceramic ionic-conducing structures can comprise forming a slurry. The slurry can be used in a tape casting method. The order of addition of components (starting materials) during formation of the slurry and/or milling time(s) can be critical.

For example, a slurry for dense ceramic ionic-conducing structures (e.g., a dense layer) can be formed by i) adding solvent(s) (e.g., isopropanol and toluene) to a dispersant (e.g., fish oils such as, for example, blown fish oils (e.g., Blown Menhaden fish oil, Z-3′ from Tape Casting Warehouse, Inc.)) and mixing until the dispersant is dissolved in the solvent(s), ii) optionally, adding a sintering facilitating material (e.g., Al₂O₃) (which can increase conductivity) (e.g., at 0.1 to 0.2 mole per mole of ceramic material), and iii) adding the ceramic material. The sintering facilitating material, if present, and ceramic material can be added in any order. This mixture is milled (first milling) for 1 to 47 hours, including all 0.1 hour values and range therebetween. In various examples, the mixture is milled for at least 1 hour, at least 10 hours, or at least 24 hours. After the first milling step, plasticizer(s) (optionally, plasticizer(s) dissolved in a solvent) (e.g., BBP) is/are added to the mixture of dispersant, solvent(s), sintering facilitating material, if present, and ceramic material). After addition of plasticizer(s), binder(s) (optionally, binder(s) dissolved in a solvent) (e.g., PVB) is/are added. Optionally, solvent(s) is/are added after addition of the binder(s). This mixture is milled (second milling) for 12 to 48 hours, including all 0.1 hour values and range therebetween. Additional mixing (e.g., by agitation) can be carried out after addition (e.g., to provide a homogenous solution or uniform suspension) of any of the starting materials. For example, steps described in this example are carried out in the stated order and/or without any additional steps.

For example, a slurry for porous ceramic ionic-conducing structures (e.g., a porous layer) can be formed by i) adding one or more solvents to a dispersant (e.g., fish oils such as, for example, blown fish oils (e.g., Blown Menhaden fish oil, Z-3′ from Tape Casting Warehouse, Inc.)) and mixing until the dispersant is dissolved in the solvent, ii) optionally, adding a sintering facilitating material (such as Al₂O₃) (which can increase conductivity), iii) optionally, adding a pore-forming material (e.g., PMMA or graphite), and iv) adding the ceramic material. The sintering facilitating material, if present and ceramic material can be added in any order. This mixture is milled for 1 to 47 hours, including all 0.1 hour values and range therebetween. For example, the mixture is milled for at least 1 hour or at least 10 hours. After milling, plasticizer(s) (optionally, plasticizer(s) dissolved in a solvent) (e.g., BBP) is/are added to the mixture of dispersant, solvent(s), sintering facilitating material, if present, and ceramic material). After addition of plasticizer(s), binder(s) (optionally, binder(s) dissolved in a solvent) (e.g., PVB) is/are added. Optionally, solvent(s) is/are added after addition of the binder(s). The resulting mixture is milled (second milling) for 12 to 48 hours, including all integer hour values and range therebetween. Optionally, a pore-forming material (e.g, PMMA or graphite) is added. If pore-forming material(s) is/are added at this point, the resulting mixture is milled (third milling) for 10 minutes to 6 hours, including all integer minute values and ranges therebetween). At least one pore-forming material is added. After all the starting materials are added and milled, the mixture of starting materials is degassed. For example, the mixture is degassed 1 hour after the starting materials are added and milled. Additional mixing (e.g., by agitation) can be carried out after addition (e.g., to provide a homogenous solution or uniform suspension) of any of the starting materials. For example, steps described in this example are carried out in the stated order and/or without any additional steps.

A slurry can be filtered (e.g., before casting such as, for example, tape casting) to remove agglomerates that may interfere with casting. For example, the slurry is filtered with a mesh with 180 μm spacing.

A variety of pore-forming materials (e.g., porogens) can be used. A pore-forming material can be any material that will vaporize or burn below 1000° C. Examples of pore-forming materials include, but are not limited to, carbon-containing materials (e.g., graphite (or graphitic materials), carbon fibers, carbon black, and the like), natural fibers (e.g., cellulose), starches, and polymer materials (e.g., PMMA, polyethylene, polystyrene, and the like). By selection of a pore-forming material (based on, for example, size and/or decomposition properties) a desired porosity (e.g., pore size and/or pore shape) can be obtained.

The mixing can carried out by known solid-state mixing techniques. The mixture of starting materials (e.g., dispersant, solvent(s), sintering facilitating material, ceramic material, plasticizer(s), binder(s), or combination thereof) can be ball milled.

The mixture may be milled with media such as stabilized-zirconia or alumina or another media known to one of ordinary skill in the art to achieve the prerequisite particle size distribution. To achieve the prerequisite particle size distribution, the calcined mixture may be milled using a technique such as vibratory milling, attrition milling, jet milling, ball milling, or another technique known to one of ordinary skill in the art, using media such as stabilized-zirconia, alumina, or another media known to one of ordinary skill in the art.

A method of fabricating ceramic-ionic conducing structures comprises forming a layer of a slurry. The layer can be formed by a tape casting method.

A method of fabricating ceramic-ionic conducing structures comprises forming a layer of a slurry. The layer can be formed on a tape using a tape casting methods.

A method of fabricating ceramic-ionic conducing structures comprises sintering a layer of a slurry. The sintering can be carried out in discrete steps (e.g., presintering (burn out) and sintering steps) or in single continuous step. The sintering can be carried out using equipment known in the art. It is desirable that the sintering be carried out and result in layers of ceramic-ionic conducing material that are flat (do not exhibit curling) and maintain all (or substantially all) of volatile compounds in the ceramic-ionic conducing material.

For example, sintering is carried out at 800° C. to 1200° C., including all integer ° C. values and ranges therebetween. In an example, sintering is carried out at 950° C. to 1050° C. or at 1000° C. The sintering can be carried out for 1 minute to 24 hours, including all integer minute values and ranges therebetween. One having skill in the art will appreciate that smaller particles may be sintered at lower temperatures and/or shorter sintering times and larger particles may be sintered at higher temperatures and/or longer sintering times.

During sintering (both heating and cooling), various heating or cooling rates can be used. For example, heating rates of 1 to 5° C./min, including all integer C/min values, can be used to heat the layer of slurry to the desired sintering temperature. For example, cooling rates of 1 to 15° C./min, including all integer C/min values and ranges therebetween, can be used to cool the sample after the desired sintering (time and temperature). For example, cooling rates of 1 to 10° C./min or 5° C./min can be used. Without intending to be bound by any particular theory, it is considered that use of heating or cooling rates that are too high can result in warping of the layer (e.g., layer on a tape).

Sintering (including, for example, presintering and sintering steps) is carried out in a low humidity (less than 1% or less than or equal to 1% absolute humidity) or no observable humidity environment. Humidity can be determined by methods known in the art. Without intending to be bound by any particular theory, it is considered that sintering under low humidity (less than 1% or less than or equal to 1% absolute humidity) or no observable humidity environment will provide an ion-conducing ceramic material having a desired phase (e.g., garnet phase) and/or structure.

Presintering is carried out in an atmosphere comprising oxygen. Sintering is carried out under a flow of a gas or mixture of gasses. The flow of gas can be an inert gas flow (e.g., argon gas). It is desirable that an inert gas flow be sufficient to remove CO₂ and/or H₂O (which can be formed during the sintering process) such than no observable carbonate materials are formed. The gas flow can comprise oxygen.

A method of fabricating ceramic ionic-conducing structures can comprise forming slurry, a layer of a slurry, and/or sintering a layer of slurry. These steps (or a combination thereof) can be carried out in a tape casting method.

The steps of the method described herein are sufficient to carry out the methods of making the ceramic ion-conducing ceramic structures of the present invention. Thus, in an example, the method consists essentially of a combination of the steps of the methods disclosed herein. In another example, the method consists of such steps. In various examples, the method comprises, consists essentially of, or consists of a combination of the steps of the methods disclosed herein in the order disclosed. Any particular chemical composition or combination of compounds can comprise or consist or consist essentially of the recite composition or compounds.

In an aspect, the present disclosure provides uses of ceramic ion-conducing structures. For example, the ceramic ion conducing structures can be used as solid-state electrolyte materials in ion-conducing batteries (e.g., solid-state ion-conducing batteries).

An ion-conducting battery can comprise ion-conducting solid state electrolyte comprising one or more ceramic ion conducing material of the present disclosure. For example, the batteries are lithium-ion, solid-state electrolyte batteries, sodium-ion, solid-state electrolyte batteries, or magnesium-ion solid-state electrolyte batteries. Lithium-ion (Li⁺) batteries are used, for example, in portable electronics and electric cars, sodium-ion (Na⁺) batteries are used, for example, for electric grid storage to enable intermittent renewable energy deployment such as solar and wind, and magnesium-ion (Mg²⁺) batteries are expected to have higher performance than Li⁺ and Na⁺ because Mg²⁺ carries twice the charge for each ion.

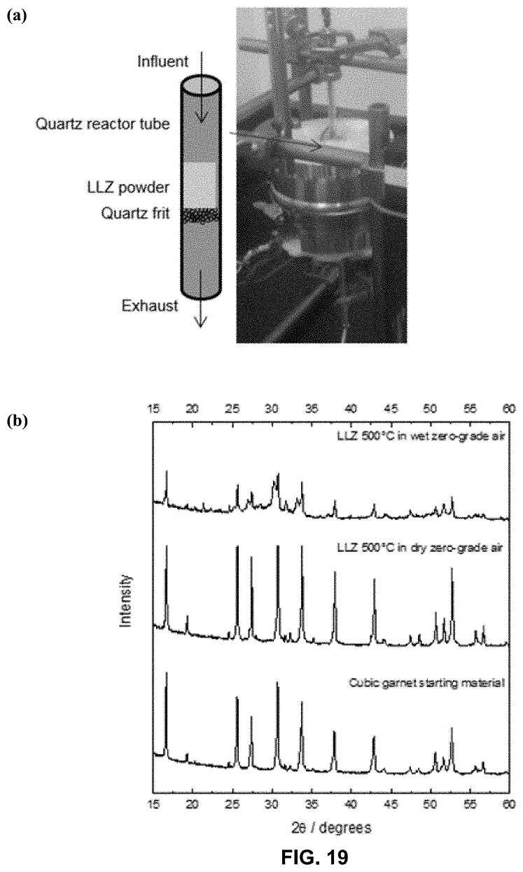

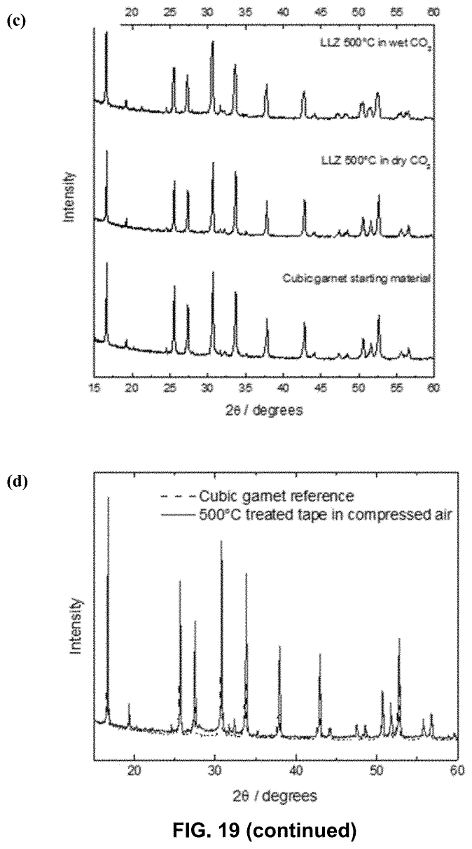

Solid-state batteries have advantages over previous batteries. For example, the solid electrolyte is non-flammable providing enhanced safety, and also provides greater stability to allow high voltage electrodes for greater energy density. The battery design (FIG. 19) provides additional advantages in that it allows for a thin electrolyte layer and a larger electrolyte/electrode interfacial area, both resulting in lower resistance and thus greater power and energy density. In addition, the structure eliminates mechanical stress from ion intercalation during charging and discharging cycles and the formation of solid electrolyte interphase (SEI) layers, thus removing the capacity fade degradation mechanisms that limit lifetime of current battery technology.

Solid state batteries comprise a cathode material, an anode material, and solid state electrolyte comprising one or more the ceramic ion-conducing materials. The ceramic ion conducing materials can have a dense region (e.g. a layer) and one or two porous regions (layers). The porous region(s) can be disposed on one side of the dense region or disposed on opposite sides of the dense region. The dense region and porous region(s) are fabricated from the same ceramic ion-conducing materials. The batteries conduct ions such as, for example, lithium ions, sodium ions, or magnesium ions.

The solid state battery can comprise a lithium-containing cathode material and/or a lithium-containing anode material, and a lithium-containing, ion-conducting, solid-state electrolyte material (e.g., a lithium containing ceramic ion-conducting structure). The solid state battery can comprise a sodium-containing cathode material and/or a sodium-containing anode material, and a sodium-containing, ion-conducting, solid-state electrolyte material (e.g., a sodium containing ceramic ion-conducting structure). The solid state battery can comprise a magnesium-containing cathode material and/or a magnesium-containing anode material, and a magnesium-containing, ion-conducting, solid-state electrolyte material (e.g., a magnesium containing ceramic ion-conducting structure).

The solid-state, ion-conducting electrolyte material is configured such that ions (e.g., lithium ions, sodium ions, or magnesium ions) diffuse into and out of the porous region(s) (e.g., porous layer(s)) of the solid-state, ion-conducting electrolyte material (e.g., ceramic ion-conducting structure) during charging and/or discharging of the battery. A solid-state, ion-conducting battery can comprise a solid-state, ion-conducting electrolyte material (e.g., a ceramic ion-conducting structure) comprising one or two porous regions (e.g., porous layer(s)) configured such that ions (e.g., lithium ions, sodium ions, or magnesium ions) diffuse into and out of the porous region(s) of solid-state, ion-conducting electrolyte material during charging and/or discharging of the battery.

The cathode comprises cathode material in electrical contact with the porous region of the ion-conducting, solid-state electrolyte material (e.g., ceramic ion-conducing structure). For example, the cathode material is an ion-conducting material that stores ions by mechanisms such as intercalation or reacts with the ion to form a secondary phase (e.g., an air or sulfide electrode). Examples of suitable cathode materials are known in the art.

The cathode material, if present, is disposed on at least a portion of a surface (e.g., a pore surface of one of the pores) of a porous region of the ion-conducting, solid-state electrolyte material (e.g., ceramic ion-conducing structure). The cathode material, when present, at least partially fills one or more pores (e.g., a majority of the pores) of a porous region or one of the porous regions of the ion-conducting, solid-state electrolyte material (e.g., ceramic ion-conducing structure). The cathode material can be infiltrated into at least a portion of the pores of the porous region of the ion-conducting, solid-state electrolyte material.

The cathode material can be disposed on at least a portion of the pore surface of the cathode side of the porous region of the ion-conducting, solid-state electrolyte material (e.g., ceramic ion-conducing structure), where the cathode side of the porous region of ion-conducting, solid-state electrolyte material is opposed to an anode side of the porous region of ion-conducting, solid-state electrolyte material (e.g., ceramic ion-conducing structure) on which the anode material is disposed.

The cathode material can be a lithium ion-conducting material. For example, the lithium ion-conducting cathode material is, lithium nickel manganese cobalt oxides (NMC, LiNiₓMn_{y}Co_{z}O₂, where x+y+z=1), such as LiCoO₂, LiNi_{1/3}Co_{1/3}Mn_{1/3}O₂, LiNi_{0.5}Co_{0.2}Mn_{0.3}O₂, lithium manganese oxides (LMOs), such as LiMn₂O₄, LiNi_{0.5}Mn_{1.5}O₄, lithium iron phosphates (LFPs) such as LiFePO₄, LiMnPO₄, and LiCoPO₄, and Li₂MMn₃O₈, where M is selected from Fe, Co, and combinations thereof. The ion-conducting cathode material can be a high energy ion-conducting cathode material such as Li₂MMn₃O₈, wherein M is selected from Fe, Co, and combinations thereof.

The cathode material can be a sodium ion-conducting material. For example, the sodium ion-conducting cathode material is Na₂V₂O₅, P2-Na_{2/3}Fe_{1/2}Mn_{1/2}O₂, Na₃V₂(PO₄)₃, NaMn_{1/3}Co_{1/3}Ni_{1/3}PO₄ and composite materials (e.g., composites with carbon black) thereof such as Na_{2/3}Fe_{1/2}Mn_{1/2}O₂@graphene composite.

The cathode material can be a magnesium ion-conducting material. For example, the magnesium ion-conducting cathode material is doped manganese oxide (e.g., MgₓMnO_{2.y}H₂O).

The cathode material can be an organic sulfide or polysulfide. Examples of organic sulfides include carbynepolysulfide and copolymerized sulfur.

The cathode material can be an air electrode. Examples of materials suitable for air electrodes include those used in solid-state lithium ion batteries with air cathodes such as large surface area carbon particles (e.g., Super P which is a conductive carbon black) and catalyst particles (e.g., alpha-MnO₂ nanorods) bound in a mesh (e.g., a polymer binder such as PVDF binder).

It may be desirable to use an electronically conductive material as part of the ion-conducting cathode material. For example, the ion-conducting cathode material also comprises an electrically conducting carbon material (e.g., graphene or carbon black), and the ion-conducting cathode material, optionally, further comprises an organic or gel ion-conducting electrolyte. The electronically conductive material may separate from the ion-conducting cathode material. For example, electronically conductive material (e.g., graphene) is disposed on at least a portion of a surface (e.g., a pore surface) of the porous region of the ceramic ion-conducting, SSE electrolyte structure and the ion-conducting cathode material is disposed on at least a portion of the electrically conductive material (e.g., graphene).

The anode comprises anode material in electrical contact with the porous region of the ion-conducting, solid-state electrolyte material (e.g., ceramic ion-conducing structure). For example, the anode material is the metallic form of the ion conducted in the solid state electrolyte (e.g., metallic lithium for a lithium-ion battery) or a compound that intercalates the conducting ion (e.g., lithium carbide, Li₆C, for a lithium-ion battery). Examples of suitable anode materials are known in the art.

The anode material, if present, is disposed on at least a portion of a surface (e.g., a pore surface of one of the pores) of the porous region of the ion-conducting, solid-state electrolyte material (e.g., ceramic ion-conducing structure). The anode material, when present, at least partially fills one or more pores (e.g., a majority of the pores) of the porous region of ion-conducting, solid-state electrolyte material. The anode material can be infiltrated into at least a portion of the pores of the porous region of the ion-conducting, solid-state electrolyte material.

The anode material can be disposed on at least a portion of the pore surface of an anode-side porous region of the ion-conducting, solid-state electrolyte material (e.g., ceramic ion-conducing structure), where the anode side of the ion-conducting, solid-state electrolyte material is opposed to a cathode side of the porous, ion-conducting, solid-state electrolyte (e.g., ceramic ion-conducing structure) on which the cathode material is disposed.

The anode material can be a lithium-containing material. For example, the anode material is lithium metal, or an ion-conducting lithium-containing anode material such as lithium titanates (LTOs) such as Li₄Ti₅O₁₂.

The anode material can be a sodium-containing material. For example, the anode material is sodium metal, or an ion-conducting sodium-containing anode material such as Na₂C₈H₄O₄ and Na_{0.66}Li_{0.22}Ti_{0.78}O₂.

The anode material can be a magnesium-containing material. For example, the anode material is magnesium metal.

The anode material can be a conducting material such as graphite, hard carbon, porous hollow carbon spheres and tubes, and tin and its alloys, tin/carbon, tin/cobalt alloy, or silicon/carbon.

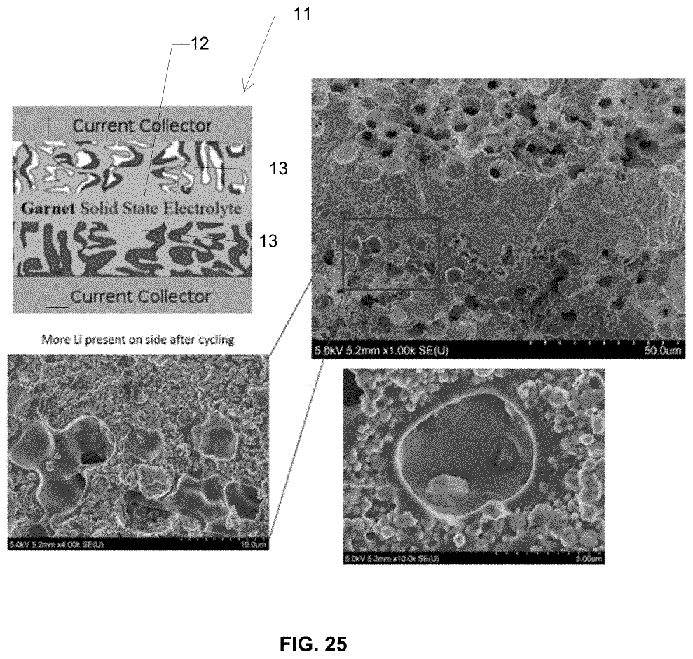

The ion-conducting solid state batteries 11 (e.g., lithium-ion solid state electrolyte batteries, sodium-ion solid state electrolyte batteries, or magnesium-ion solid state electrolyte batteries), such as shown in FIG. 25 (top left) can comprise current collector(s) 14, such as Ti current collector(s.) The batteries can have a cathode-side (first) current collector 14 disposed on the cathode-side of the porous, solid-state electrolyte material (porous layer 13) and an anode-side (second) current collector 14 disposed on the anode-side of the porous, solid-state electrolyte material (porous layer 13.) The current collectors 14 can be each independently fabricated of a metal (e.g., aluminum, copper, or titanium) or metal alloy (aluminum alloy, copper alloy, or titanium alloy).

The ion-conducting solid-state batteries (e.g., lithium-ion solid state electrolyte batteries, sodium-ion solid state electrolyte batteries, or magnesium-ion solid state electrolyte batteries) may comprise various additional structural components (such as bipolar plates, external packaging, and electrical contacts/leads to connect wires. The battery can further comprise bipolar plates. The battery can further comprise bipolar plates and external packaging, and electrical contacts/leads to connect wires. Repeat battery cell units can be separated by a bipolar plate.

The cathode material (if present), the anode material (if present), the SSE material, the cathode-side (first) current collector (if present), and the anode-side (second) current collector (if present) may form a cell. In this case, the solid-state, ion-conducting battery comprises a plurality of cells separated by one or more bipolar plates. The number of cells in the battery is determined by the performance requirements (e.g., voltage output) of the battery and is limited only by fabrication constraints. For example, the solid-state, ion-conducting battery comprises 1 to 500 cells, including all integer number of cells and ranges therebetween.

For example, an ion-conducting, solid-state battery or battery cell has one planar cathode and/or anode-electrolyte interface or no planar cathode and/or anode-electrolyte interfaces. For example, the battery or battery cell does not exhibit solid electrolyte interphase (SEI).

The following Statements provides examples of ceramic ion-conducting structures, methods of making a ceramic ion-conducting structures, and solid-state, ion-conducting batteries of the present disclosure.

Statement 1. A ceramic ion-conducting structure comprising a dense region (e.g., at least one dense layer) having a porosity of less than 5% and/or at least one porous region (e.g., porous layer) having a porosity of 40% to 90%.
Statement 2. A ceramic ion-conducting structure according to Statement 1, where the porous region has a random or ordered porous structure.
Statement 3. A ceramic ion-conducting structure according to any one of the preceding Statements, where the structure does not have observable dendrites (e.g., lithium dendrites in the case of structure having a lithium electrode material disposed on at least a portion of a surface of the structure).
Statement 4. A ceramic ion-conducting structure according to any one of the preceding Statements, where the structure is formed by a tape cast layer.
Statement 5. A method of making a ceramic ion-conducting structure comprising:
i) adding solvent(s) (e.g., isopropanol and toluene) to a dispersant (e.g., fish oil) and mixing until the dispersant is dissolved in the solvent(s),
ii) optionally, adding a sintering facilitating material (e.g., Al₂O₃) (e.g., at 0.1 to 0.2 mole per mole of ceramic material),
iii) adding a ceramic material,
iv) milling the resulting mixture from iii) for 1 to 47 hours,
v) adding plasticizer(s) (e.g., BBP) to the milled mixture from iv),
vi) adding binder(s) (e.g., PVP) to the mixture from v), Optionally, solvent(s) is/are added after addition of the binder(s),
vii) milling the mixture from vi) for 12 to 48 hours,
or
i) adding solvent(s) (e.g., isopropanol and toluene) to a dispersant (e.g., fish oil) and mixing until the dispersant is dissolved in the solvent(s),
ii) optionally, adding a sintering facilitating material (e.g., Al₂O₃) (e.g., at 0.1 to 0.2 mole per mole of ceramic material),
iii) optionally, adding a first pore-forming material (e.g., PMMA or graphite),
iv) adding a ceramic material,
v) milling the resulting mixture from iv) for 1 to 47 hours,
vi) adding plasticizer(s) (e.g., BBP) to the milled mixture from v),
vii) adding binder(s) (e.g., PVP) to the mixture from vi), Optionally, solvent(s) is/are added after addition of the binder(s),
viii) optionally, adding solvent(s) (e.g., isopropanol and toluene) to the mixture from vii),
ix) milling the mixture from vii) for 12 to 48 hours,
x) optionally, adding a second pore-forming material (e.g., PMMA or graphite),
xi) if a second pore-forming material is added, milling the mixture from ix), for 10 minutes to 6 hours, and
xii) degassing the mixture from viii) or milled mixture from x).
Statement 6. A method of making a ceramic ion-conducting ceramic structure according to Statement 5, further comprising: forming a layer of slurry on a substrate (e.g., a tape).
Statement 7. A method of making a ceramic ion-conducting ceramic structure according to any one of Statements 5 or 6 further comprising, sintering a layer of slurry of claim 5 or the layer of slurry on a substrate of claim 6 at a temperature of 800° C. to 1200° C. for 1 minute to 24 hours.
Statement 8. A method of making a ceramic ion-conducting structure according to Statement 7, where the sintering is carried out in a low humidity (less than 1% or less than or equal to 1% absolute humidity) or no observable humidity environment.
Statement 9. A method of making a ceramic ion-conducting structure according to Statement 8, where the sintering is carried out under a flow of inert gas (e.g., argon gas).
Statement 10. A solid-state, ion-conducting battery comprising:
a) cathode material or anode material;
b) a ceramic ion-conducing structure of any of claims 1-4 or made by any of claims 5-9 (e.g., a solid-state electrolyte (SSE) material) (e.g., a layer or layers of the ion-conducing ceramic material) comprising a porous region having a plurality of pores, and a dense region,
c) wherein the cathode material or the anode material is disposed on at least a portion of the porous region and the dense region is free of the cathode material and the anode material, and
d) a current collector disposed on at least a portion of the cathode material or the anode material.
   Statement 11. A solid-state, ion-conducting battery according to Statement 10, wherein the ion-conducing ceramic structure comprises two of the porous regions, the cathode material, the anode material, and the cathode material is disposed on at least a portion of one of the porous regions forming a cathode-side porous region and the anode material is disposed on at least a portion of the other porous region forming an anode-side porous region, and the cathode-side region and the anode-side region are disposed on opposite sides of the dense region, and further comprises a cathode-side current collector and an anode-side current collector.
   Statement 12. A solid-state, ion-conducting battery according to any one of Statements 10 or 11, where the current collector is a conducting metal or metal alloy.
   Statement 13. A solid-state, ion-conducting battery according to any of Statements 10 to 12, where the dense region of the ion-conducing ceramic material has a dimension of 1 μm to 100 μm and/or the porous region of the ion-conducing ceramic material that has the cathode material disposed thereon has a dimension of 20 μm to 200 μm and/or the porous region of the SSE material that has the anode material disposed thereon has a dimension of 20 μm to 200 μm.
   Statement 14. A solid-state, ion-conducting battery according to any one of Statements 10 to 13, where the cathode material, the anode material, the SSE material, and the current collector form a cell, and the solid-state, ion-conducting battery comprises a plurality of the cells, each adjacent pair of the cells is separated by a bipolar plate.

The following examples are presented to illustrate the present disclosure. They are not intended to limiting in any manner.

### Example 3

The following is an example describing structures (e.g., multilayer structures) comprising ionically conductive ceramics, which enables the production of various high performance solid state battery chemistries. These structures can have porous outer layers, which can contain electrochemically active electrode materials, that are separated by a dense center layer. This configuration can be used, for example, for high performance electrochemical energy storage systems, creating space for high loading of active materials, electronic separation between active materials, and ionic conduction throughout.

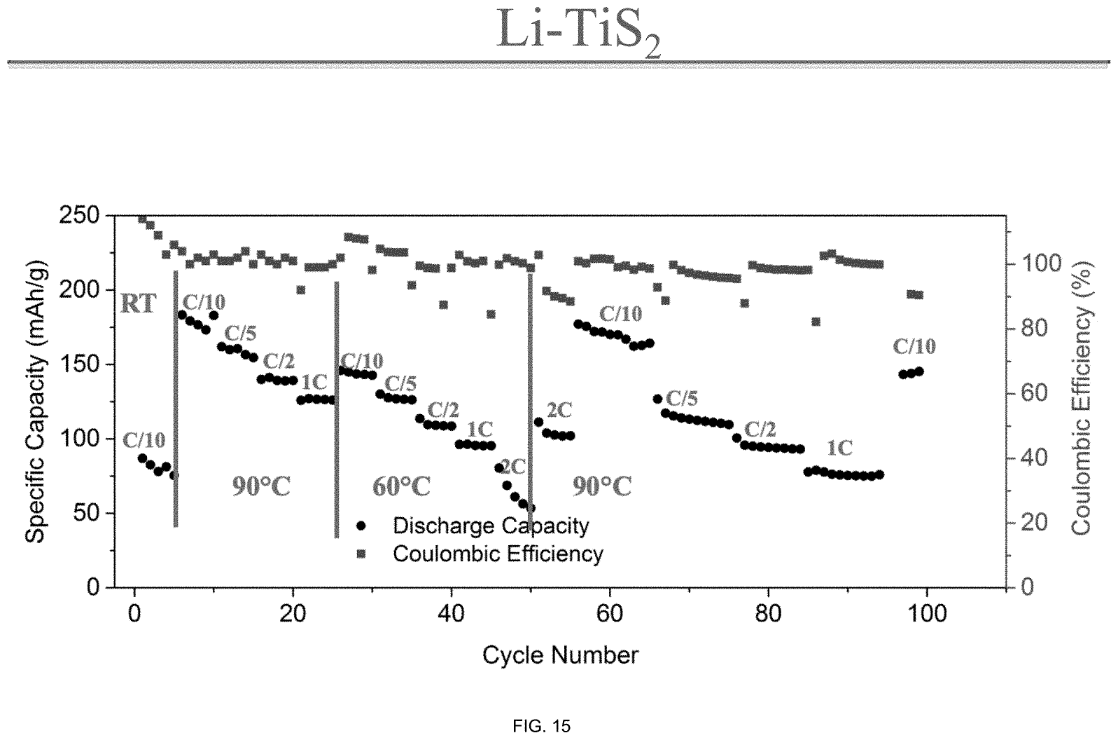

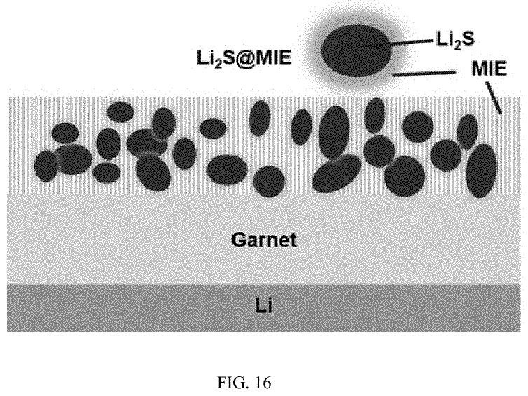

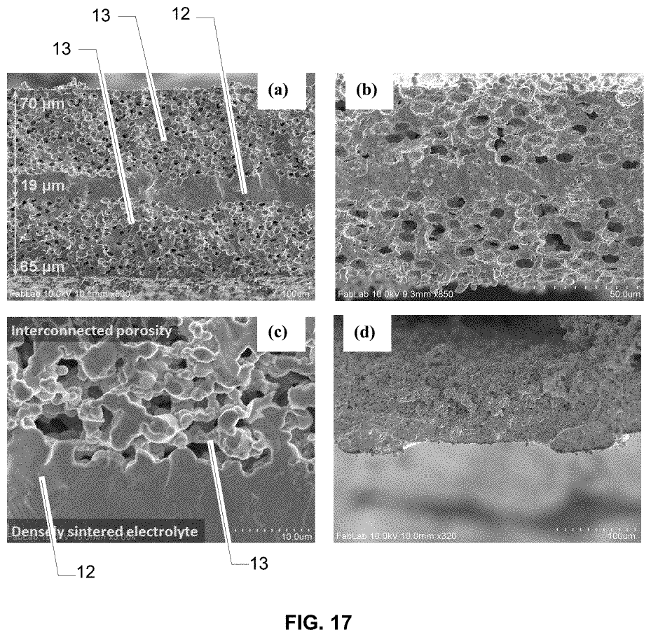

A multilayer ceramic can be a triple layer structure, bilayer structure, or ordered structure. For example, FIG. 17a shows a triple layer ceramic lithium conductor Li_{6.75}La_{2.75}Ca_{0.25}Zr_{1.5}Nb_{0.5}O₁₂ (LLCZN) with ˜5 μm spherical pores in porous layers 13 on either side of a dense layer 12. FIG. 17b is another example of a LLCZN triple layer with ˜10 μm spherical pores. It is desirable that the pores have high interconnectivity to allow electrode filling. This is demonstrated in FIG. 17c, showing a close-up of highly interconnected pores and the densified center layer (dense layer 12.) Pores should be highly interconnected but also maintain low tortuosity for fast kinetics. Ordered porosity, as shown on the bottom layer of FIG. 917d, can consistently reach tortuosities as low as 1. This ordered porosity was not created via the same techniques as FIGS. 17a-c but was 3D printed.

Various battery chemistries benefit from such a multilayered structure. This structure allows for the use of an alkaline metal anode, which represents the best energy density and lowest voltage anode in each chemistry. This invention is useful in such chemistries as:
Lithium ion with high voltage spinel cathode
Lithium ion with layered oxide cathode
Lithium ion with olivine phosphate cathode
Lithium-sulfur
Lithium-air
Use as a separator in a traditional liquid electrolyte lithium ion cell
Similar chemistries utilizing sodium, magnesium, potassium, or silver conductors instead of lithium conductors would also benefit from such a structure.

The fabrication of this product relies on a set of processing strategies that allow the creation of a well sintered ceramic body with the desired structure, phase and electrical properties. This example focuses specifically on the fabrication of the ionically conductive ceramic structure. To produce a high performance cell, it is desirable that the structure meets the requirements listed in Table 2, regardless of specific chemistry. The processes described herein used to create the structures shown in FIG. 17a-c achieves these goals.

TABLE 2
Properties by layer for a high performance solid state battery.

| Laver | Requirement | Purpose |
|---|---|---|
| Cathode-side | High ionic | Enabling low resistance/high |
| | conductivity | current cycling |
| Cathode-side | High porosity | Allow high capacity filling of |
| | | electrode |
| Cathode-side | High strength | Overall device strength; |
| | | Prevention of fracture during |
| | | cycling |
| Center Separator | High ionic | Enabling low resistance/high |
| (Electrolyte-layer) | conductivity | current cycling |
| Center Separator | Very low electronic | Blockage of short circuit |
| (Electrolyte-layer) | conductivity | current, allowing cell to hold |
| | | charge and have long calendar |
| | | life |
| Center Separator | Thin | Enabling low resistance/high |
| (Electrolyte-layer) | | current cycling |
| Center Separator | High strength | Prevention of dendrite growth; |
| (Electrolyte-layer) | | Overall device strength |
| Center Separator | Highly densified | Prevention of dendrites; |
| (Electrolyte-layer) | | Prevention of electrode |
| | | materials coming into physical |
| | | contact |
| Anode-side | High strength | Overall device strength; |
| | | Prevention fo fracture during |
| | | cycling |
| Anode-side | High ionic | Enabling low resistance/high |
| | conductivity | current cycling |
| Anode-side | High porosity | Allow high capacity filling of |
| | | electrode |

Beyond these requirements, control over exact microstructure is important. The porosity of the anode and cathode (or more generally, “electrode”) layers must be well interconnected to create a low tortuosity. Optimal pore size is chemistry dependent. Because sulfur fills pores easily and is not conductive to lithium ions, Li—S chemistries benefit from small pores (on the order of 1-10 μm diameter). On the other hand, lithium ion chemistries with an oxide cathode are hard to fill with micron-plus sized commercially available cathode such as LiCoO₂. These lithium ion chemistries benefit from larger pores (10-30 μm diameter). Ordered porosity with controlled aspect ratios allow the highest possible surface area with low tortuosity. Thickness of electrodes must be determined by design to allow high capacity and high rate capability.

This disclosure should not be limited by the materials synthesis method, dimensions of the structure, the size or dimension of the pores, the exact recipe of the tapes, or the source of the porogens. Discoveries that led to the successful fabrication of the structure include, for example, the atmospheric protection and the importance of particle size reduction.

Fabrication Procedure and Development. This section discusses the overall procedure including materials synthesis, milling, tapecasting, pre-sintering, sintering, and the nuanced procedures required to achieve the desired structure. The research that led to the development of these procedures will also be discussed.

The ionically conductive material can have, among other materials, various members of the lithium garnet family. There are many members of the garnet family which would satisfy the requirements of a viable device (e.g., low electronic conductivity). This work has been demonstrated with Li_{6.75}La_{2.75}Ca_{0.25}Zr_{1.5}Nb_{0.5}O₁₂ (LLCZN, nominal composition), a variant of the Li₇La₃Zr₂O₁₂ (LLZ) composition. The lithium garnet material is produced via solid state reaction by mixing CaCO₃, La₂O₃, ZrO₂, and Nb₂O₅ in stoichiometric quantities. LiOH, LiNO₃ or Li₂CO₃ is added with 10% excess to account for volatility during sintering. The raw materials are mixed with isopropanol and 5 mm diameter yttria-stabilized zirconia (YSZ) balls to form a slurry for milling. After 24 hours of milling, the mixture is screened through a 38 μm mesh and separated from the milling media. The slurry is then dried for several hours in a 100° C. oven, lightly ground in a mortar and pestle to re-powderize. The powder is placed in a covered Al₂O₃ crucible and calcined at 900° C. for 10 hours. After calcining, the ceramic powder is milled in isopropanol for 3 days with 5 mm YSZ balls, then 18 days with 2 mm YSZ balls.

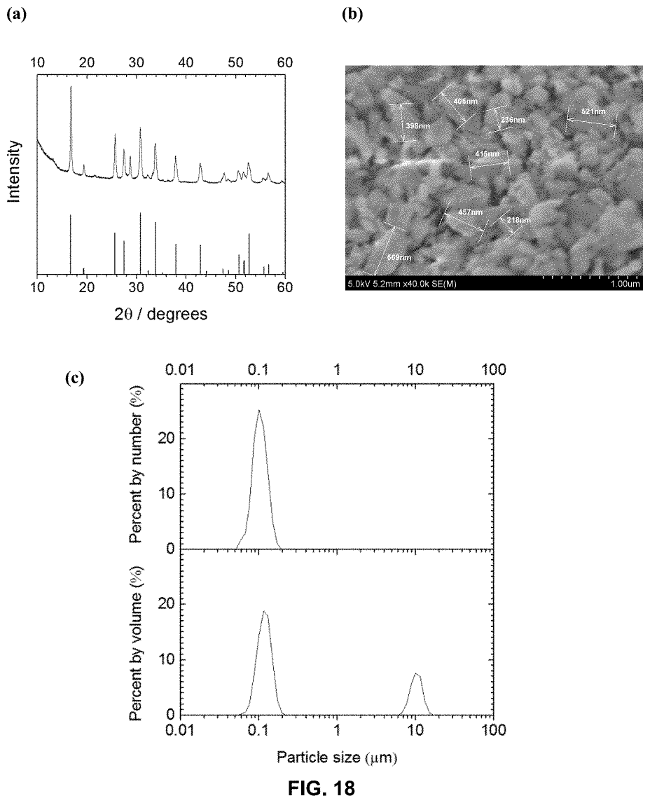

This synthesis procedure produces highly conductive, cubic phase lithium garnet as can be seen in the X-ray diffraction pattern in FIG. 18a. FIGS. 18b and 18c show results from scanning electron microscopy and dynamic light scattering demonstrating that nearly all the particles are under 500 nm in size. Brunauer-Enunett-Teller particle size analysis confirm submicron particles with 20-25 m²/g surface area. This small particle size and high surface area are important for reducing sintering temperature and time, which in turn retain lithium and enable final fabrication of the triple layer structure meeting all the requirements as listed in Table 2.

From this LLCZN powder, complex microstructured ceramics can be scalably produced via tapecasting, followed by organic burnout, then high temperature sintering. While this is a widely employed technique in industry, every material requires unique formulations and compositions of tapecasting slurry to produce tapes that have the right properties and successfully produce the desired sintered structure. The slurries must cast nicely to produce tapes of consistent thickness and without defects. Tapes must be flexible and maintain this flexibility for a long shelf life. Tapes must be able to be laminated to one another well enough that delamination does not occur during sintering.

The slurry recipes in Tables 2 and 3 represent significant development work to produce tapes that meet these requirements. However, these are not the only functional recipes that were achieved and can be tailored to the desired structure, with increased or decreased porosity and changes of tape thickness among other possible variations. Furthermore, a significant component of successful tapecasting is the procedure used to create the slurry. These compositions could result in inferior tapes if the addition order and notes in Tables 2 and 3 are not followed.

Polymer-ceramic composite tapes are cast for the separator layer and the electrode layers separately. Slurries for tape casting are prepared by mixing the garnet and Al₂O₃ nanopowder in isopropanol, toluene and a small amount of fish oil for 24 hours. After the addition of polyvinyl butyral (PVB) and benzyl butyl phthalate (BBP), the solution is milled for another 24 hours. Slurries used to create the electrode layers of the triple layer contain 10 or 15 μm diameter crosslinked polymethyl methacrylate (PMMA) spheres and/or 7-11 μm graphite particles to create porosity. An example slurry recipe for the electrolyte layer tape is given in Table 3, sorted by order of addition to the slurry and normalized to grams of garnet. Similarly, Table 4 shows a slurry recipe for a porous layer tape. These are not the only possible recipes to achieve viable tapes, but are two examples of what has been used in our procedure. In addition to many variations on these recipes, we have also created tapes using all-PMMA pore porogen, all-graphite porogen, and other porogens such as starch and cellulose.

Control of porosity is achieved via selection of porogen. Only interconnected pores with an electronic path to the current collector will be electrochemically active. Furthermore, only pores with sufficiently sized connections are able to be filled with electrode material. The image shown in FIG. 17a is of a triple layer produced with 10 μm diameter crosslinked PMMA spheres in the electrode layer tapes. These spheres decompose and volatilize during the burnout stage, leaving spherical voids which shrink during sintering. However, interconnectivity between pores is low. Because the LLCZN grains were not sintered together, the volatilizing PMMA easily escapes and does not push through channels between pores. In order to increase interconnectivity of pores, graphite can also be used as a porogen. Graphite does not finish burning out until above 800 C, which preserves the integrity of the pores and allows a continual off-gassing which forces the connections in the pores to stay open. The triple layer in FIG. 17c uses only graphite as porogen. Even a small amount of graphite can be enough to keep the maintain pore connectivity, as can be seen in FIG. 17b showing a triple layer made with a PMMA/graphite ratio of 19/1.

TABLE 3
Formulation for lithium garnet tape for dense center layer

| Addition | | Amount | |
|---|---|---|---|
| Day | Material | (g/g LLCZN) | Note |
| 1 | Fish oil | 0.05 | |
| 1 | Isopropanol | 0.95 | |
| 1 | Toluene | 0.95 | Bottle is shaken to |
| | | | completely dissolve |
| | | | fish oil after this |
| | | | addition. |
| 1 | Al₂O₃ | 0.006 | 0.1-0.2 mole Al₂O₃/ |
| | | | mole LLCZN. |
| 1 | LLCZN | 1 | |
| 2 | BBP | 0.28 | Bottle is shaken after |
| | | | this addition. |
| 2 | PVB | 0.24 | Bottle is shaken after |
| | | | this addition until |
| | | | PVB particles are |
| | | | dissolved |
| 2 | Cyclohexanone | 0.02 | |

TABLE 4
Formulation for lithium garnet tape for porous outer layers

| Addition | | Amount | |
|---|---|---|---|
| Day | Material | (g/g LLCZN) | Note |
| 1 | Fish oil | 0.04 | |
| 1 | Isopropanol | 1.25 | |
| 1 | Toluene | 1.15 | Bottle is shaken to |
| | | | completely dissolve |
| | | | fish oil after this |
| | | | addition. |
| 1 | Al₂O₃ | 0.006 | 0.1-0.2 mole Al₂O₃/ |
| | | | mole LLCZN. |
| 1 | Graphite | 0.04 | |
| 1 | LLCZM | 1 | |
| 2 | BBP | 0.55 | Bottle is shaken after |
| | | | this addition. |
| 2 | PVB | 0.0.65 | Bottle is shaken after |
| | | | this addition until |
| | | | PVB particles are |
| | | | dissolved |
| 3 | PMMA | 0.37 | PMMA added 1 hour |
| | | | before degassing. |

It may be important that for each addition day, the materials added are mixed for 24 hours for proper homogeneity. On the day of tapecasting, the slurries are degassed to prevent bubbles from disrupting the process of tape drying and ceramic powder packing. Degassing is accomplished by stirring the slurry while pulling low (˜500 mmHg) vacuum. The slurries for the electrolyte and electrode layers are degassed for 1 and 3 hours, respectively. After degassing, tapecasting is performed by pouring the slurry into a reservoir. A sheet of silicone coated mylar is pulled under the reservoir at 10 cm/minute. The film thickness is limited by a doctor blade set to the desired height. Common heights for electrolyte layer tapes and electrode layer tapes are 178 μm and 465 μm, respectively. Smaller or larger blade heights can be used to produce thinner or thicker tapes. The tape is pulled onto a 49° C. heated bed for drying. Tapes are allowed to dry for around 1 hour before removing from the heated bed.

After tapecasting, the tapes are laminated together to form a triple layer. A section of porous-layer tape and a section electrolyte layer tape are pressed at 3 tons at 71° C. for 30 minutes. After pressing, the now bilayer tape is pressed with another section of porous-layer tape for 30 minutes to create a porous-dense-porous triple layer. Alternatively, all three-layers can be laminated at the same time. Cells are punched or cut from this triple layer depending on the desired size.

To produce the final sintered ceramic, punches from this triple layer tape are heated in a furnace to burn out the organics and sinter the ceramic particles into a single body. The tape punch out must sit on a bed of the mother powder. The tape punch out is either covered by more of the mother powder or by a powder nonreactive with garnet such as MgO. A porous Al₂O₃ block is placed on top of this powder to provide a small amount of compression to keep the cells flat while still providing gas flow. Various furnace profiles for the burnout and sintering stages have been shown to work.

An essential breakthrough that led to this product fabrication procedure was the discovery of humidity related reactions in the furnace. It was found that LLZ and LLCZN tapes could not consistently be taken through the burnout stage, between room temperature and about 650° C., without losing the garnet phase. After ruling out reactions during tapecasting, we discovered that the indoor humidity was causing reactions with the garnet in the furnace. Previous research has shown that lithium garnet is not stable in water. However, there has been no report of the stability of the material in humid conditions at an elevated temperature, such as the environment in a furnace on a humid day. This is not usually a concern because at high temperatures, the relative humidity of the atmosphere is very low. The absolute humidity, though, can be high. An additional concern was that organics in the tape are converted to water and CO₂ during binder burnout stage, increasing the humidity and providing another possible reactant.

FIG. 19a shows the setup of the experiment used to determine the furnace stability of lithium garnet with water and CO₂. LLZ was heated in a quartz reactor in a 20 sccm flow of the test gas. The furnace was ramped to 500° C., held for 30 minutes, and cooled to room temperature. X-ray diffraction was used to measure phase purity of the starting material and the material after the test.

It can be seen in FIG. 19b that annealing in wet zero-grade air (79% N₂, 21% O₂ without CO₂ or any of the other constituent gases comprising atmospheric air) leads to complete decomposition of the garnet phase and the production of numerous side phases. When annealed in dry zero-grade air, the garnet phase remains intact.

It can be seen in FIG. 19c that annealing garnet in wet CO₂ produces nearly pure phase garnet. There is some peak splitting in the wet CO₂ not seen in the dry CO₂ which may suggest that the garnet is changing from cubic to tetragonal phase, but this is a major improvement over the same heating conditions in wet air. This indicates that CO₂ is not damaging to the garnet phase and may be protective.

FIG. 19d shows that this knowledge can be applied to a tapecast garnet ceramic through the burnout of the organics at 500° C. The burnout of the tape was performed using compressed air, which is low humidity but not completely dry, and produced nearly pure phase cubic garnet.

During the burnout (or “presintering”) phase, the PVB and BBP are oxidized and are carried away by the flowing furnace gas. It is important to provide sufficient oxygen for these reactions to happen. It is also important to burn slowly enough to not disturb the packing of the LLCZN ceramic particles. This is also the stage where the PMMA breaks down and volatilizes. The burnout profiles most commonly used are listed below:
Ramp from room temperature to 750° C. at 2° C./minute under 35 cm³/minute O₂ flow.
Ramp from room temperature to sintering temperature at 3° C./minute with 30 minute stops at 200° C., 450° C. and 650° C. under 35 cm³/minute O₂ flow.

After the burnout stage, the furnace does not need to be cooled to room temperature. The furnace can continue to heat to the full sintering temperature, usually at a rate of 3° C./minute. Due to the small particle size, high surface area, and sharp angles of the particles, all sintering temperatures used in this procedure are significantly lower than literature for the same materials. The two most commonly used sintering profiles in our process are a high temperature, short time profile and a lower temperature, longer time. Each of these temperatures can be reached with traditional, low cost nichrome heating elements:
950° C. hold for 5 hours, followed by cooling at 3-5° C./minute
1050° C. hold for 20 minutes, followed by cooling at 3-5° C./minute

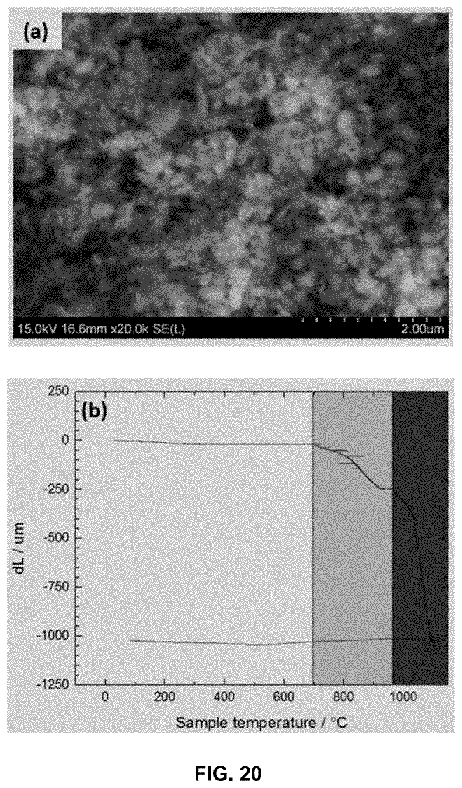

Lithium garnet is notoriously difficult to sinter into a dense body. Most examples of dense sintering in literature include the use of hot-pressing, a procedure not suited for device fabrication. Significant work went into developing a procedure that would allow densification of the garnet during sintering. The most important development in this pursuit is the milling procedure that produces the powder shown in FIG. 20a. It can be seen that not only are the particles sub-micron and high surface area, but they also have sharp edges and acute vertices. Together, this dramatically increases the surface energy of the powder, kinetically favoring sintering as a method to reduce surface energy. A dilatometric study, shown in FIG. 20b, indicates that a significant amount of sintering occurs before 1000° C., where lithium loss starts to be a significant factor. This is the rationale behind the longer 5 hour sintering time at 950° C. or short 20 minute hold at 1050° C., which both promote sintering.

The atmosphere in the furnace during the burnout and the sintering stage must be controlled. Oxygen or dry air is used during the burnout stage to allow for oxidation of organics. After the burnout stage, the gas for the sintering stage is run to completely flush the furnace. During the sintering hold, the gas flow is shut off and the sintering gas is held to slow lithium loss. The gas is flowed again during cooling. The sintering stage has been demonstrated in oxygen and argon, though we have demonstrated that the most important factors are avoidance of CO₂ and humidity. Because graphite does not fully burn out below about 850° C., tapes including graphite must use an oxidizing atmosphere in the sintering stage if all graphite is to be fully removed.

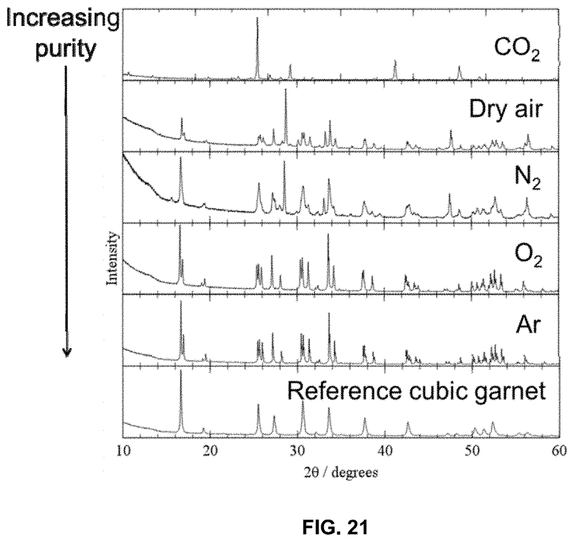

Many alkaline conducting ceramics contain volatile elements that can be lost at a high rate at these elevated temperatures, hindering sinterability, resulting in reduced phase purity and/or device performance. In order to reduce lithium loss, factors affecting the rate of lithium loss were investigated. After binder burnout, the garnet is heated to temperatures between 800 1200° C. for sintering, depending on composition, particle size, and desired sintering time. At high temperature, loss of lithium in the form of volatile side phases can cause loss of garnet phase. The use of controlled gas environments during sintering can prevent the formation of some lithium-containing side phases by removing the reactants commonly found in air such as N₂ and CO₂. FIG. 21 shows the diffraction patterns of LLCZN garnet tapes heated to 500° C. in dry air and held for 1 hour for binder burnout, then heated to 1050° C. in various test gases. The samples were held for 1 hour then cooled to room temperature for XRD. These results indicate that sintering in O₂ or Ar in these conditions leads to significant lithium retention over sintering in N₂, CO₂ or dry air.

The results of this study also indicate that CO₂ is especially damaging to the garnet and should be avoided. For this reason, binder burnout is performed in O₂ to cause more rapid combustion, reducing the amount of time the CO₂ combustion product is in close proximity to the garnet.

After sintering, the desired structure is complete and is stored in an argon-filled glovebox to protect the surface of the garnet from carbonate formation.

### Example 4

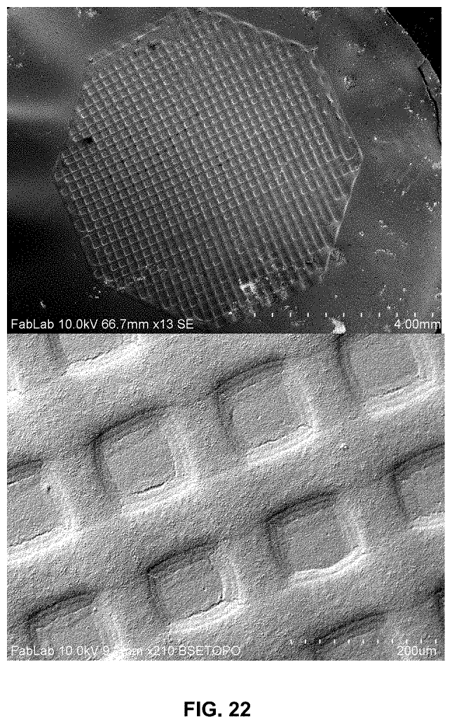

The following is an example of a ceramic ion-conducting structure with ordered structures. For increased surface area, grids can be printed. An SEM of a 10 layer print on top of a dense tape after sintering is shown in FIG. 22.

### Example 5

The following is an example of electrical data obtained using ceramic ion-conducting structures of the present disclosure.

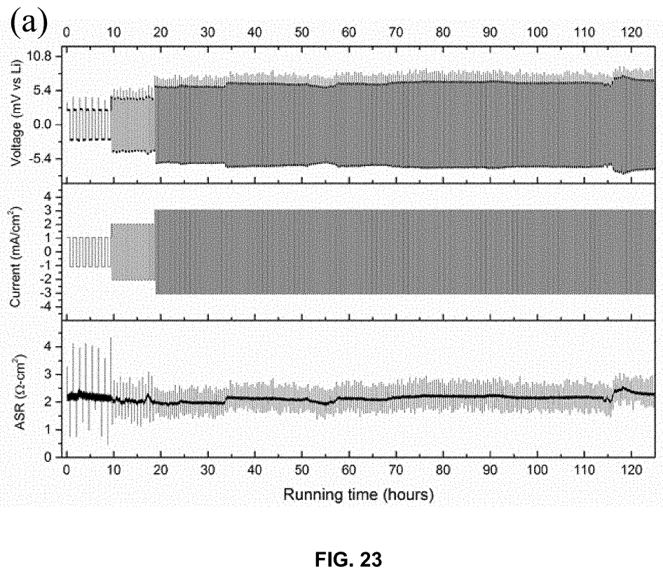

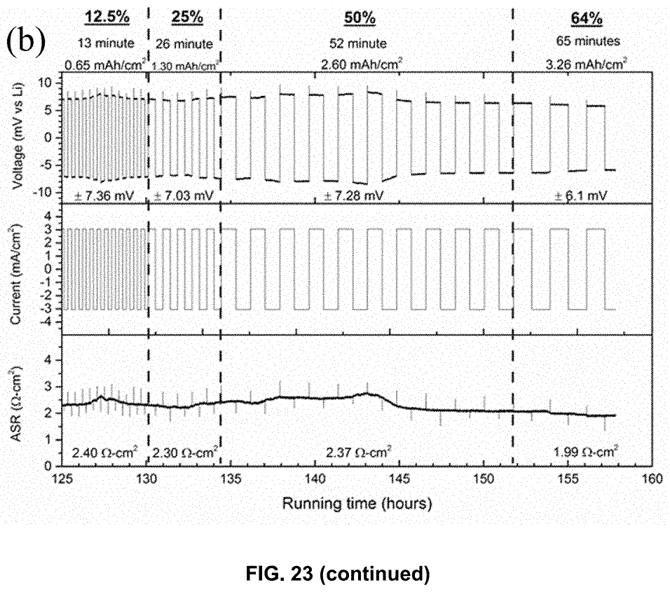

Cycling data. The pores of a triple layer garnet structure were filled with lithium metal which was cycled from one porous layer to the other and back at high rate. In FIG. 23(a), it can be seen that the current is increased incrementally from 1 mA/cm² to 3 mA/cm², with a corresponding response in the voltage. The area specific resistance (ASR) stays around 2-3 Ωcm², which is significantly below the 20-30 Ocm2 of commercially available 18650 lithium batteries. The FIG. 23(b), shows an increase in the amount of lithium removed from the pores, with a continuation of the 3 mA/cm² rate in the same cell. This cell was cycled hundreds of times without degradation, only to be stopped and disassembled for SEM analysis.

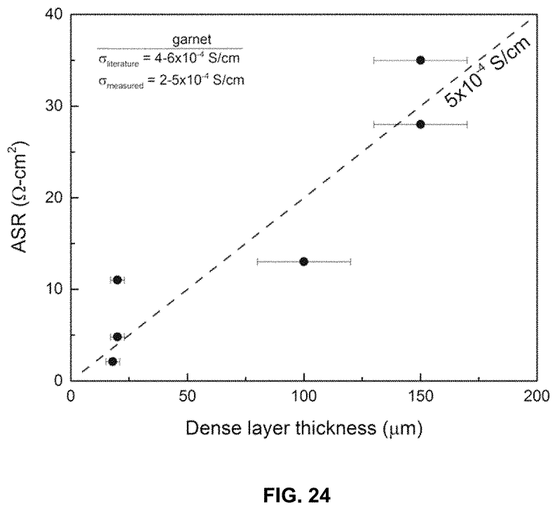

This is the expected resistance as calculated from the conductivity of the material and the thickness of the dense layer. This is shown in FIG. 24 with several tested samples labeled on the plot.

### Example 6

The following describes SEM analysis of an example of an electrical cell comprising a ceramic ion-conducting structure of the present disclosure.

A schematic of an embodiment of a battery 11 is shown in FIG. 17 (top left), with a dense layer 12, two porous layers 13 and two current collectors 14. SEM of lithium in garnet pores. An SEM analysis of the disassembled cycled cell was performed (see FIG. 25). The lithium metal can be seen as the smooth sections in the SEM images. The cell was stopped at the end of a deep cycle, causing most of the lithium metal to be plated on the bottom side.

### Additional Examples

The following describes analysis of the flatness of ceramic ion-conducting structures of the present disclosure.

Flatness of fabricated structures. Flatness of the sintered structures is important to allow compact stacking and prevent breakage. To measure flatness, grid scans were taken using the Keyence LK-H082 Ultra High-Speed/High-Accuracy Laser Displacement Sensor attachment of a nScrypt 3D printer, which is capable of measuring sample topology with resolution better than 20 μm in the x and y directions and about 7 μm in the z direction.

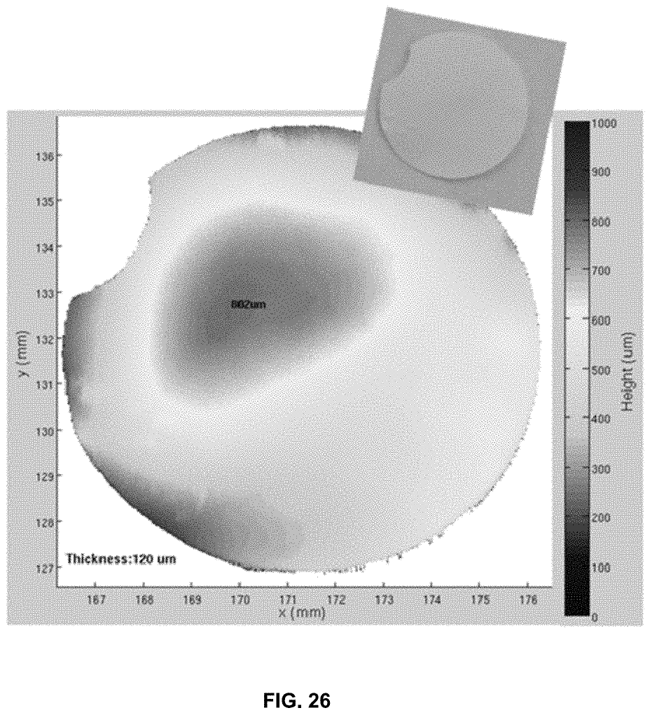

The first scan, shown as a colormap in FIG. 26, represents a grid scan of a cell sintered on a dense Al₂O₃ plate with a light powderbed on top and bottom, covered by a porous Al₂O₃ block. The inset shows a photograph of the same cell. The thickness of the cell is calculated by cutting out the background of the scan using an increasing cutoff until the shape of the trilayer is affected. The accuracy of this method has been confirmed with SEM to within about 10-15 urn. All data analysis for these measurements has been performed in MATLAB.

It can be seen in FIG. 20 that the cell is 120 μm with a peak height of 802 μm, giving a P-V Error of 682 μm, based on Equation 1, where peak height is the maximum height measured on the sample and valley height is the thickness of the cell.

P−V Error=Peak height−Valley height (Eqn. 1)

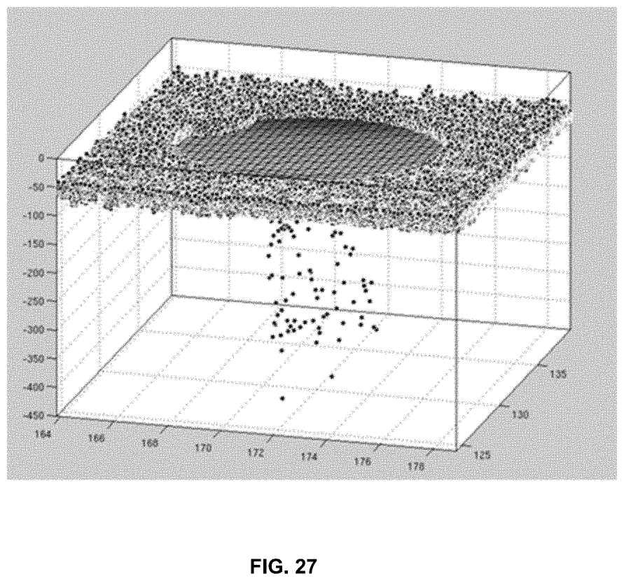

In order to obtain an accurate measure, the z height of the sample holder must be absolutely zeroed and leveled. In order to achieve this, we can subtract the trilayer data from the grid scan of the background and fit a curve to it. This curve is used to subtract the background from the trilayer data points. The fitting of the background data can be seen in FIG. 27. This operation is performed for every trilayer scanned. Also apparent are the outliers created via edge effects in the scanning. These points are removed with a high and low cutoff of data points, which is performed computationally for each cell after scanning.

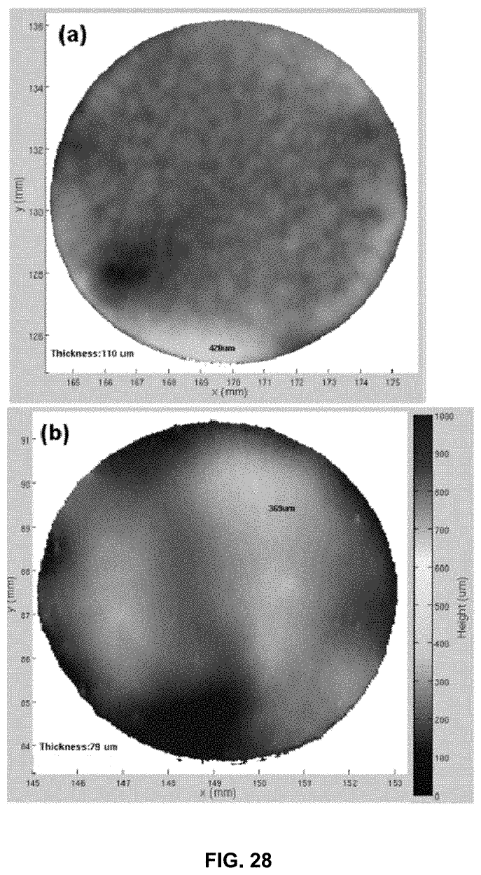

We fabricated flatter cells by applying more consistent pressure to the tops of the cells during sintering. For the first cell, shown on the left of FIG. 28, a powder was ground finely then distributed evenly to the top of the sample. For the second cell, a ceramic pellet was placed underneath and on top of the triple layer tape. Both of these cells sintered much more consistently than previous cells, showing peak to valley differences of 310 μm and 290 μm, respectively.

### Further Detailed Disclosure

The present disclosure provides ion conducting batteries having a solid state electrolyte (SSE). For example, the batteries are lithium-ion, solid-state electrolyte batteries, sodium-ion, solid-state electrolyte batteries, or magnesium-ion solid-state electrolyte batteries. Lithium-ion (Li⁺) batteries are used, for example, in portable electronics and electric cars, sodium-ion (Na⁺) batteries are used, for example, for electric grid storage to enable intermittent renewable energy deployment such as solar and wind, and magnesium-ion (Mg²⁺) batteries are expected to have higher performance than Li⁺ and Na⁺ because Mg²⁺ carries twice the charge for each ion.

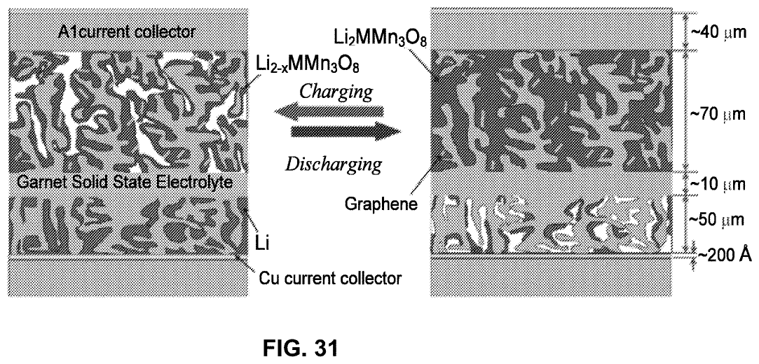

The solid-state batteries have advantages over previous batteries. For example, the solid electrolyte is non-flammable providing enhanced safety, and also provides greater stability to allow high voltage electrodes for greater energy density. The battery design (FIG. 31) provides additional advantages in that it allows for a thin electrolyte layer and a larger electrolyte/electrode interfacial area, both resulting in lower resistance and thus greater power and energy density. In addition, the structure eliminates mechanical stress from ion intercalation during charging and discharging cycles and the formation of solid electrolyte interphase (SEI) layers, thus removing the capacity fade degradation mechanisms that limit lifetime of current battery technology.

The solid state batteries comprise a cathode material, an anode material, and an ion-conducting, solid-state electrolyte material. The solid-state electrolyte material has a dense region (e.g. a layer) and one or two porous regions (layers). The porous region(s) can be disposed on one side of the dense region or disposed on opposite sides of the dense region. The dense region and porous region(s) are fabricated from the same solid-state electrolyte material. The batteries conduct ions such as, for example, lithium ions, sodium ions, or magnesium ions.

The cathode comprises cathode material in electrical contact with the porous region of the ion-conducting, solid-state electrolyte material. For example, the cathode material is an ion-conducting material that stores ions by mechanisms such as intercalation or reacts with the ion to form a secondary phase (e.g., an air or sulfide electrode). Examples of suitable cathode materials are known in the art.

The cathode material is disposed on at least a portion of a surface (e.g., a pore surface of one of the pores) of a porous region of the ion-conducting, solid-state electrolyte material. The cathode material, when present, at least partially fills one or more pores (e.g., a majority of the pores) of a porous region or one of the porous regions of the ion-conducting, solid-state electrolyte material. In one embodiment, the cathode material is infiltrated into at least a portion of the pores of the porous region of the ion-conducting, solid-state electrolyte material.

In an embodiment, the cathode material is disposed on at least a portion of the pore surface of the cathode side of the porous region of the ion-conducting, SSE material, where the cathode side of the porous region of ion-conducting, SSE material is opposed to an anode side of the porous region of ion-conducting, SSE material on which the anode material is disposed.

In an embodiment, the cathode material is a lithium ion-conducting material. For example, the lithium ion-conducting cathode material is, lithium nickel manganese cobalt oxides (NMC, LiNiₓMn_{y}Co_{z}O₂, where x+y+z=1), such as LiCoO₂, LiNi_{1/3}Co_{1/3}Mn_{1/3}O₂, LiNi_{0.5}Co_{0.2}Mn_{0.3}O₂, lithium manganese oxides (LMOs), such as LiMn₂O₄, LiNi_{0.5}Mn_{1.5}O₄, lithium iron phosphates (LFPs) such as LiFePO₄, LiMnPO₄, and LiCoPO₄, and Li₂MMn₃O₈, where M is selected from Fe, Co, and combinations thereof. In an embodiment, the ion-conducting cathode material is a high energy ion-conducting cathode material such as Li₂MMn₃O₈, wherein M is selected from Fe, Co, and combinations thereof.

In an embodiment, the cathode material is a sodium ion-conducting material. For example, the sodium ion-conducting cathode material is Na₂V₂O₅, P2-Na_{2/3}Fe_{1/2}Mn_{1/2}O₂, Na₃V₂(PO₄)₃, NaMn_{1/3}Co_{1/3}Ni_{1/3}PO₄ and composite materials (e.g., composites with carbon black) thereof such as Na_{2/3}Fe_{1/2}Mn_{1/2}O₂ graphene composite.

In an embodiment, the cathode material is a magnesium ion-conducting material. For example, the magnesium ion-conducting cathode material is doped manganese oxide (e.g., MgₓMnO_{2.y}H₂O).

In an embodiment, the cathode material is an organic sulfide or polysulfide. Examples of organic sulfides include carbynepolysulfide and copolymerized sulfur.

In an embodiment, the cathode material is an air electrode. Examples of materials suitable for air electrodes include those used in solid-state lithium ion batteries with air cathodes such as large surface area carbon particles (e.g., Super P which is a conductive carbon black) and catalyst particles (e.g., alpha-MnO₂ nanorods) bound in a mesh (e.g., a polymer binder such as PVDF binder).

It may be desirable to use an electrically conductive material as part of the ion-conducting cathode material. In one embodiment, the ion-conducting cathode material also comprises an electrically conducting carbon material (e.g., graphene or carbon black), and the ion-conducting cathode material, optionally, further comprises a organic or gel ion-conducting electrolyte. The electrically conductive material may separate from the ion-conducting cathode material. For example, electrically conductive material (e.g., graphene) is disposed on at least a portion of a surface (e.g., a pore surface) of the porous region of the ion-conducting, SSE electrolyte material and the ion-conducting cathode material is disposed on at least a portion of the electrically conductive material (e.g., graphene).

The anode comprises anode material in electrical contact with the porous region of the ion-conducting, SSE material. For example, the anode material is the metallic form of the ion conducted in the solid state electrolyte (e.g., metallic lithium for a lithium-ion battery) or a compound that intercalates the conducting ion (e.g., lithium carbide, Li₆C, for a lithium-ion battery). Examples of suitable anode materials are known in the art.

The anode material is disposed on at least a portion of a surface (e.g., a pore surface of one of the pores) of the porous region of the ion-conducting, SSE material. The anode material, when present, at least partially fills one or more pores (e.g., a majority of the pores) of the porous region of ion-conducting, SSE electrolyte material. In an embodiment, the anode material is infiltrated into at least a portion of the pores of the porous region of the ion-conducting, solid-state electrolyte material.

In one embodiment, the anode material is disposed on at least a portion of the pore surface of an anode-side porous region of the ion-conducting, SSE electrolyte material, where the anode side of the ion-conducting, solid-state electrolyte material is opposed to a cathode side of the porous, ion-conducting, SSE on which the cathode material is disposed.

In one embodiment, the anode material is a lithium-containing material. For example, the anode material is lithium metal, or an ion-conducting lithium-containing anode material such as lithium titanates (LTOs) such as Li₄Ti₅O₁₂.

In one embodiment, the anode material is a sodium-containing material. For example, the anode material is sodium metal, or an ion-conducting sodium-containing anode material such as Na₂C₈H₄O₄ and Na_{0.66}Li_{0.22}Ti_{0.78}O₂.

In one embodiment, the anode material is a magnesium-containing material. For example, the anode material is magnesium metal.

In one embodiment, the anode material is a conducting material such as graphite, hard carbon, porous hollow carbon spheres and tubes, and tin and its alloys, tin/carbon, tin/cobalt alloy, or silicon/carbon.

The ion-conducting, solid-state electrolyte material has a dense regions (e.g., a dense layer) and one or two porous regions (e.g., porous layer(s)). The porosity of the dense region is less than that of the porous region(s). In one embodiment, the dense region is not porous. The cathode material and/or anode material is disposed on a porous region of the SSE material forming a discrete cathode material containing region and/or a discrete anode material containing region of the ion-conducting, solid-state electrolyte material. For example, each of these regions of the ion-conducting, solid-state electrolyte material has, independently, a thickness (e.g., a thickness perpendicular to the longest dimension of the material) of 20 μm to 200 μm, including all integer micron values and ranges there between.

The dense regions and porous regions described herein can be discrete dense layers and discrete porous layers. Accordingly, in an embodiment, the ion-conducting, solid-state electrolyte material has a dense layer and one or two porous layers.

The ion-conducting, solid-state electrolyte material conducts ions (e.g., lithium ions, sodium ions, or magnesium ions) between the anode and cathode. The ion-conducting, solid-state electrolyte material is free of pin-hole defects. The ion-conducting solid-state electrolyte material for the battery or battery cell has a dense region (e.g., a dense layer) that is supported by one or more porous regions (e.g., porous layer(s)) (the porous region(s)/layer(s) are also referred to herein as a scaffold structure(s)) comprised of the same ion-conducting, solid-state electrolyte material.

In an embodiment, the ion-conducting solid state electrolyte has a dense region (e.g., a dense layer) and two porous regions (e.g., porous layers), where the porous regions are disposed on opposite sides of the dense region and cathode material is disposed in one of the porous regions and the anode material in the other porous region.

The porous region (e.g., porous layer) of the ion-conducting, solid-state electrolyte material has a porous structure. The porous structure has microstructural features (e.g., microporosity) and/or nanostructural features (e.g., nanoporosity). For example, each porous region, independently, has a porosity of 10% to 90%, including all integer % values and ranges there between. In another example, each porous region, independently, has a porosity of 30% to 70%, including all integer % values and ranges therebetween. Where two porous regions are present the porosity of the two layers may be the same or different. The porosity of the individual regions can be selected to, for example, accommodate processing steps (e.g., higher porosity is easier to fill with electrode material (e.g., charge storage material) (e.g., cathode)) in subsequent screen-printing or infiltration step, and achieve a desired electrode material capacity, i.e., how much of the conducting material (e.g., Li, Na, Mg) is stored in the electrode materials. The porous region (e.g., layer) provide structural support to the dense layer so that the thickness of the dense layer can be reduced, thus reducing its resistance. The porous layer also extends ion conduction of the dense phase (solid electrolyte) into the electrode layer to reduce electrode resistance both in terms of ion conduction through electrode and interfacial resistance due to charge transfer reaction at electrode/electrolyte interface, the later improved by having more electrode/electrolyte interfacial area.

In an embodiment, the solid-state, ion-conducting electrolyte material is a solid-state electrolyte, lithium-containing material. For example, the solid-state electrolyte, lithium-containing material is a lithium-garnet SSE material.

In an embodiment, the solid-state, ion-conducting electrolyte material is a Li-garnet SSE material comprising cation-doped Li₅La₃M′₂O₁₂, cation-doped Li₆La₂BaTa₂O₁₂, cation-doped Li₇La₃Zr₂O₁₂, and cation-doped Li₆BaY₂M′₂O₁₂. The cation dopants are barium, yttrium, zinc, iron, gallium, or combinations thereof and M′ is Nb, Zr, Ta, or combinations thereof.

In an embodiment, the Li-garnet SSE material comprises Li₅La₃Nb₂O₁₂, Li₅La₃Ta₂O₁₂, Li₇La₃Zr₂O₁₂, Li₆La₂SrNb₂O₁₂, Li₆La₂BaNb₂O₁₂, Li₆La₂SrTa₂O₁₂, Li₆La₂BaTa₂O₁₂, Li₇Y₃Zr₂O₁₂, Li_{6.4}Y₃Zr_{1.4}Ta_{0.6}O₁₂, Li_{6.5}La_{2.5}Ba_{0.5}TaZrO₁₂, Li₆BaY₂M¹₂O₁₂, Li₇Y₃Zr₂O₁₂, Li₆₇₅BaLa₂Nb_{1.75}Zn_{0.25}O₁₂, or Li_{6.75}BaLa₂Ta_{1.75}Zn_{0.25}O₁₂.

In an embodiment, the, solid-state, ion-conducting electrolyte material sodium-containing, solid-state electrolyte, material. For example, the sodium-containing, solid-state electrolyte is Na₃Zr₂Si₂PO₁₂ (NASICON) or beta-alumina.

In an embodiment, the, solid-state, ion-conducting electrolyte material is a, solid-state electrolyte, magnesium-containing material. For example, the magnesium ion-conducting electrolyte material is MgZr₄P₆O₂₄.

The ion-conducting, solid-state electrolyte material has a dense region that free of the cathode material and anode material. For example, this region has a thickness (e.g., a thickness perpendicular to the longest dimension of the material) of 1 to 100 μm, including all integer micron values and ranges there between. In another example, this region has a thickness of 5 to 40 μm.

In one embodiment, the solid state battery comprises a lithium-containing cathode material and/or a lithium-containing anode material, and a lithium-containing, ion-conducting, solid-state electrolyte material. In an embodiment, the solid state battery comprises a sodium-containing cathode material and/or a sodium-containing anode material, and a sodium-containing, ion-conducting, solid-state electrolyte material. In another embodiment, the solid state battery comprises a magnesium-containing cathode material and/or a magnesium-containing anode material, and a magnesium-containing, ion-conducting, solid-state electrolyte material.

The solid-state, ion-conducting electrolyte material is configured such that ions (e.g., lithium ions, sodium ions, or magnesium ions) diffuse into and out of the porous region(s) (e.g., porous layer(s)) of the solid-state, ion-conducting electrolyte material during charging and/or discharging of the battery. In one embodiment, the solid-state, ion-conducting battery comprises a solid-state, ion-conducting electrolyte material comprising one or two porous regions (e.g., porous layer(s)) configured such that ions (e.g., lithium ions, sodium ions, or magnesium ions) diffuse into and out of the porous region(s) of solid-state, ion-conducting electrolyte material during charging and/or discharging of the battery.

One of ordinary skill in the art would understand that a number of processing methods are known for processing/forming the porous, solid-state, ion-conducting electrolyte material such as high temperature solid-state reaction processes, co-precipitation processes, hydrothermal processes, sol-gel processes.

The material can be systematically synthesized by solid-state mixing techniques. For example, a mixture of starting materials may be mixed in an organic solvent (e.g., ethanol or methanol) and the mixture of starting materials dried to evolve the organic solvent. The mixture of starting materials may be ball milled. The ball milled mixture may be calcined. For example, the ball milled mixture is calcined at a temperature between 500° C. and 2000° C., including all integer ° C. values and ranges there between, for least 30 minutes to at least 50 hours. The calcined mixture may be milled with media such as stabilized-zirconia or alumina or another media known to one of ordinary skill in the art to achieve the prerequisite particle size distribution. The calcined mixture may be sintered. For example, the calcined mixture is sintered at a temperature between 500° C. and 2000° C., including all integer ° C. values and ranges therebetween, for at least 30 minutes to at least 50 hours. To achieve the prerequisite particle size distribution, the calcined mixture may be milled using a technique such as vibratory milling, attrition milling, jet milling, ball milling, or another technique known to one of ordinary skill in the art, using media such as stabilized-zirconia, alumina, or another media known to one of ordinary skill in the art.

One of ordinary skill in the art would understand that a number of conventional fabrication processing methods are known for processing the ion-conducting SSE materials such as those set forth above in a green-form. Such methods include, but are not limited to, tape casting, calendaring, embossing, punching, laser-cutting, solvent bonding, lamination, heat lamination, extrusion, co-extrusion, centrifugal casting, slip casting, gel casting, die casting, pressing, isostatic pressing, hot isostatic pressing, uniaxial pressing, and sol gel processing. The resulting green-form material may then be sintered to form the ion-conducting SSE materials using a technique known to one of ordinary skill in the art, such as conventional thermal processing in air, or controlled atmospheres to minimize loss of individual components of the ion-conducting SSE materials. In some embodiments of the present invention it is advantageous to fabricate ion-conducting SSE materials in a green-form by die-pressing, optionally followed by isostatic pressing. In other embodiments it is advantageous to fabricate ion-conducting SSE materials as a multi-channel device in a green-form using a combination of techniques such as tape casting, punching, laser-cutting, solvent bonding, heat lamination, or other techniques known to one of ordinary skill in the art.

Standard x-ray diffraction analysis techniques may be performed to identify the crystal structure and phase purity of the solid sodium electrolytes in the sintered ceramic membrane.

The solid state batteries (e.g., lithium-ion solid state electrolyte batteries, sodium-ion solid state electrolyte batteries, or magnesium-ion solid state electrolyte batteries) comprise current collector(s). The batteries have a cathode-side (first) current collector disposed on the cathode-side of the porous, solid-state electrolyte material and an anode-side (second) current collector disposed on the anode-side of the porous, solid-state electrolyte material. The current collector are each independently fabricated of a metal (e.g., aluminum, copper, or titanium) or metal alloy (aluminum alloy, copper alloy, or titanium alloy).

The solid-state batteries (e.g., lithium-ion solid state electrolyte batteries, sodium-ion solid state electrolyte batteries, or magnesium-ion solid state electrolyte batteries) may comprise various additional structural components (such as bipolar plates, external packaging, and electrical contacts/leads to connect wires. In an embodiment, the battery further comprises bipolar plates. In an embodiment, the battery further comprises bipolar plates and external packaging, and electrical contacts/leads to connect wires. In an embodiment, repeat battery cell units are separated by a bipolar plate.

The cathode material, the anode material, the SSE material, the cathode-side (first) current collector (if present), and the anode-side (second) current collector (if present) may form a cell. In this case, the solid-state, ion-conducting battery comprises a plurality of cells separated by one or more bipolar plates. The number of cells in the battery is determined by the performance requirements (e.g., voltage output) of the battery and is limited only by fabrication constraints. For example, the solid-state, ion-conducting battery comprises 1 to 500 cells, including all integer number of cells and ranges there between.

In an embodiment, the ion-conducting, solid-state battery or battery cell has one planar cathode and/or anode electrolyte interface or no planar cathode and/or anode electrolyte interfaces. In an embodiment, the battery or battery cell does not exhibit solid electrolyte interphase (SEI).

The following examples are presented to illustrate the present disclosure. They are not intended to limiting in any manner.

### Example 7

The following is an example describing the solid-state lithium ion batteries of the present disclosure and making same.

The flammable organic electrolytes of conventional batteries can be replaced with non-flammable ceramic-based solid-state electrolytes (SSEs) that exhibit, for example, room temperature ionic conductivity of ≥10⁻³ Scm⁻¹ and electrochemical stability up to 6V. This can further allow replacement of typical LiCoO₂ cathodes with higher voltage cathode materials to increase power/energy densities. Moreover, the integration of these ceramic electrolytes in a planar stacked structure with metal current collectors will provide battery strength.

Intrinsically safe, robust, low-cost, high-energy-density all-solid-state Li-ion batteries (SSLiBs), can be fabricated by integrating high conductivity garnet-type solid Li ion electrolytes and high voltage cathodes in tailored micro/nano-structures, fabricated by low-cost supported thin-film ceramic techniques. Such batteries can be used in electric vehicles.

Li-garnet solid-state electrolytes (SSEs) that have, for example, a room temperature (RT) conductivity of ˜10⁻³ Scm⁻¹ (comparable to organic electrolytes) can be used. The conductivity can be increased to ˜10⁻² Scm⁻¹ by increasing the disorder of the Li-sublattice. The highly stable garnet SSE allows use of Li₂MMn₃O₈ (M=Fe, Co) high voltage (˜6V) cathodes and Li metal anodes without stability or flammability concerns.

Known fabrication techniques can be used to form electrode supported thin-film (˜10 micron) SSEs, resulting in an area specific resistance (ASR) of only ˜0.01 Ωcm⁻². Use of scaleable multilayer ceramic fabrication techniques, without need for dry rooms or vacuum equipment, provide dramatically reduced manufacturing cost.

Moreover, the tailored micro/nanostructured electrode support (scaffold) will increase interfacial area, overcoming the high impedance typical of planar geometry solid-state lithium ion batteries (SSLiBs), resulting in a C/3 IR drop of only 5.02 mV. In addition, charge/discharge of the Li-anode and Li₂MMn₃O₈ cathode scaffolds by pore-filling provides high depth of discharge ability without mechanical cycling fatigue seen with typical electrodes.

At ˜170 micron/repeat unit, a 300V battery pack would only be <1 cm thick. This form factor with high strength due to Al bipolar plates allows synergistic placement between framing elements, reducing effective weight and volume. Based on the SSLiB rational design, targeted SSE conductivity, high voltage cathode, and high capacity electrodes the expected effective specific energy, including structural bipolar plate, is ˜600 Wh/kg at C/3. Since bipolar plates provide strength and no temperature control is necessary this is essentially a full battery pack specification other than the external can. The corresponding effective energy density is 1810 Wh/L.

All the fabrication processes can be done with conventional ceramic processing equipment in ambient air without the need of dry rooms, vacuum deposition, or glove boxes, dramatically reducing cost of manufacturing.

For the all solid-state battery with no SEI or other performance degradation mechanisms inherent in current state-of-art Li-batteries, the calendar life of the instant battery is expected to exceed 10 years and cycle life is expected to exceed 5000 cycles.

Solid-state Li-garnet electrolytes (SSEs) have unique properties for SSLiBs, including room temperature (RT) conductivity of ˜10⁻³ Scm⁻¹ (comparable to organic electrolytes) and stability to high voltage (˜6V) cathodes and Li-metal anodes without flammability concerns.

Use of SSE oxide powders can enable use of low-cost scaleable multilayer ceramic fabrication techniques to form electrode supported thin-film (˜10 μm) SSEs without need for dry rooms or vacuum equipment, as well as engineered micro/nano-structured electrode supports to dramatically increase interfacial area. The later will overcome the high interfacial impedance typical of planar geometry SSLiBs, provide high depth of discharge ability without mechanical cycling fatigue seen with typical electrodes, as well as avoid SEI layer formation.

The SSE scaffold/electrolyte/scaffold structure will also provide mechanical strength, allowing for the integration of structural metal interconnects (bipolar plates) between planar cells, to improve strength, weight, thermal uniformity, and form factor. The resulting strength and form factor provides potential for the battery pack to be load bearing.

Highly Li⁺ conducting and high voltage stable garnet type solid electrolytes can be made by doping specific cations for Ta and Zr in Li₅La₃Ta₂O₁₂, Li₆La₂BaTa₂O₁₂ and Li₇La₃Zr₂O₁₂, to extend RT conductivity from ˜10⁻³ to ˜10⁻² Scm⁻¹. Compositions having desirable conductivity, ionic transference number, and electrochemical stability up to 6V against elemental Li can be determined.

Electrode supported thin film SSEs can be fabricated. Submicron SSE powders and SSE ink/paste formulations thereof can be made. Tape casting, colloidal deposition, and sintering conditions can be developed to prepare dense thin-film (˜10 μm) garnet SSEs on porous scaffolds.

Cathode and anode can be integrated. Electrode-SSE interface structure and SSE surface can be optimized to minimize interfacial impedance for targeted electrode compositions. High voltage cathode inks can be made to fabricate SSLiBs with high voltage cathode and Li-metal anode incorporated into the SSE scaffold. The SSLiB electrochemical performance can be determined by measurements including CV, energy/power density and cycling performance.

Stacked multi-cell SSLiBs with Al/Cu bipolar plates can be assembled. Energy/power density, cycle life, and mechanical strength as a function of layer thicknesses and area for the stacked multi-cell SSLiBs can be determined.

Li-Stuffed Garnets SSEs. Conductivity of Li-Garnet SSEs can be improved doping to increase the Li content (“stuffing”) of the garnet structure. Li-stuffed garnets exhibit desirable physical and chemical properties for SSEs including:
RT bulk conductivity (˜10⁻³ S/cm) for cubic Li₇La₃Zr₂O₁₂.
High electrochemical stability for high voltage cathodes (up to 6 V), about 2 V higher than current organic electrolytes and about 1 V higher than the more popular LiPON.
Excellent chemical stability in contact with elemental and molten Li anodes up to 400° C.
Li⁺ transference number close to the maximum of 1.00, which is important to battery cycle efficiency, while typical polymer electrolytes are only ˜0.35.
Wide operating temperature capability, electrical conductivity that increases with increasing temperature reaching 0.1 Scm⁻¹ at 300° C., and maintains appreciable conductivity below 0° C. In contrast, polymer electrolytes are flammable at high temperature
Synthesizable as simple mixed oxide powders in air, hence easy scale up for bulk synthesis.

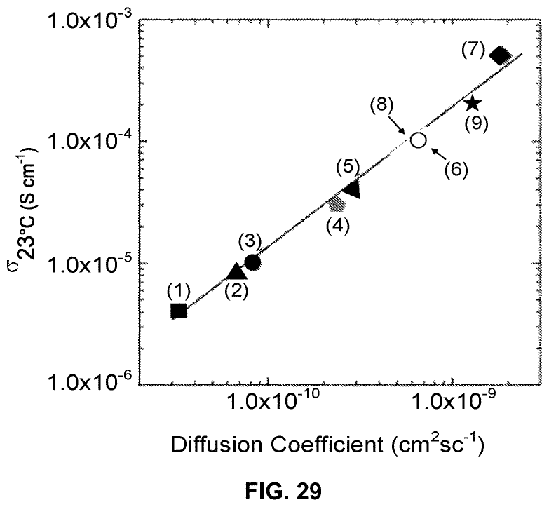

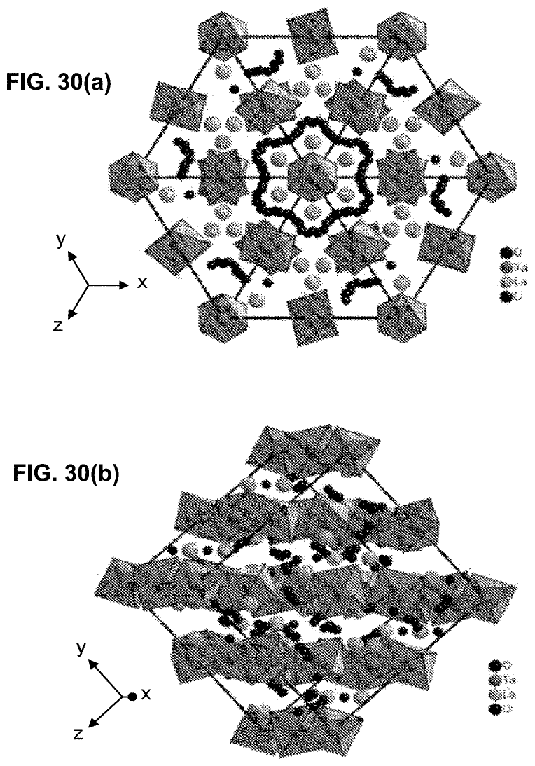

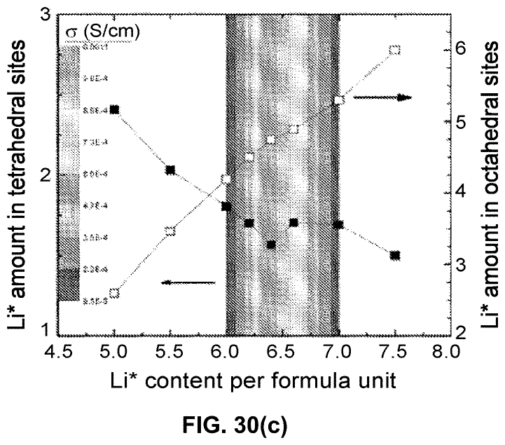

Li⁺ conductivity of garnet SSEs can be further increased. The Li ion conductivity of garnet is highly correlated to the concentration of Li⁺ in the crystal structure. FIG. 29 shows the relationship between the Li⁺ conductivity and diffusion coefficient for various Li-stuffed garnets. The conductivity increases with Li content, for example, the cubic Li₂-phase (Li₇La₃Zr₂O₁₂) exhibits a RT conductivity of 5×10⁻⁴ S/cm. However, conductivity also depends on synthesis conditions, including sintering temperature. The effects of composition and synthesis method can be determined to achieve a minimum RT conductivity of ˜10⁻³ S/cm for the scaffold supported SSE layer. It is expected the RT conductivity can be increased to ˜10⁻² S/cm through doping to increase the disorder of the Li sublattice. Ionic conduction in the garnet structure occurs around the metal-oxygen octahedron, and site occupancy of Li ions in tetrahedral vs. octahedral sites directly controls the Li ion conductivity (FIG. 30(a)-(c)). For example, in Li₅La₃Ta₂O₁₂, about 80% of Li ions occupy the tetrahedral sites while only 20% occupy octahedral sites. Increasing the Li⁺ concentration at octahedral sites while decreasing occupancy of the tetrahedral sides has been shown to result in an order of magnitude increase in ionic conductivity (FIG. 30(b)). Smaller-radii metal ions (e.g., Y3+), which are chemically stable in contact with elemental Li and isovalent with La, can be doped to develop a new series of garnets: Li₆BaY₂M₂O₁₂, Li_{6.4}Y₃Zr_{1.6}Ta_{0.6}O₁₂, Li₇Y₃Zr₂O₁₂, and their solid solutions; to increase ionic conductivity. The enthalpy of formation of Y₂O₃ (−1932 kJ/mol) is lower than that of La₂O₃ (−1794 kJ/mol), hence, doping Y for La will increase Y—O bond strength and weaken Li—O bonds. Thus increasing Li⁺ mobility due to weaker lithium to oxygen interaction energy. Further, it is expected that Y will provide a smoother path for ionic conduction around the metal oxygen octahedral due to its smaller ionic radius (FIG. 30a).

In another approach, we can substitute M²⁺ cations (e.g., Zn²⁺, a 3d° cation known to form distorted metal-oxygen octandera) for the M⁵⁺ sites in Li₆BaY₂M₂O₁₂. ZnO is expected to play a dual role of both further increasing the concentration of mobile Li ions in the structure and decreasing the final sintering temperature. Each M²⁺ will add three more Li⁺ for charge balance and these ions will occupy vacant Li⁺ sites in the garnet structure. Thus, further increase Li⁺ conduction can be obtained by modifying the garnet composition to control the crystal structure, Li-site occupancy, and minimize the conduction path activation energy.

Due to the ceramic powder nature of Li-garnets, SSLiBs can be fabricated using conventional fabrication techniques. This has tremendous advantages in terms of both cost and performance. All the fabrication processes can be done with conventional ceramic processing equipment in ambient air without the need of dry rooms, vacuum deposition, or glove boxes, dramatically reducing cost of manufacturing.

The SSLiBs investigated to date suffer from high interfacial impedance due to their low surface area, planar electrode/electrolyte interfaces (e.g., LiPON based SSLiBs). Low area specific resistance (ASR) cathodes and anodes can be achieved by integration of electronic and ionic conducting phases to increase electrolyte/electrode interfacial area and extend the electrochemically active region farther from the electrolyte/electrode planar interface. It is expected that modification of the nano/microstructure of the electrolyte/electrode interface (for example, by colloidal deposition of powders or salt solution impregnation) can reduce overall cell area specific resistance (ASR), resulting in an increase in power density relative to identical composition and layer thickness cells. These same advances can be applied to decrease SSLiB interfacial impedance. The SSLiB will be made by known fabrication techniques Low-cost, high speed, scaleable multi-layer ceramic processing can be used to fabricate supported thin-film (˜10 μm) SSEs on tailored nano/micro-structured electrode scaffolds. ˜50 and 70 μm tailored porosity (nano/micro features) SSE garnet support layers (scaffolds) can be tape cast, followed by colloidal deposition of a ˜10 μm dense garnet SSE layer and sintering. The resulting pinhole-free SSE layer is expected to be mechanically robust due to support layers and have a low area specific resistance ASR, for example, only 0.01 Ωcm⁻². Li₂MMn₃O₈ will be screen printed into the porous cathode scaffold and initial Li-metal will be impregnated in the porous anode scaffold (FIG. 31). For example, Li₂(Co,Fe)Mn₃O₈ high voltage cathodes can be prepared in the form of nano-sized powders using wet chemical methods. The nano-sized electrode powders can be mixed with conductive materials such as graphene or carbon black and polymer binder in NMP solvent. Typical mass ratio for cathode, conductive additive or binder is 85%:10%:5% by weight. The slurry viscosity can be optimized for filling the porous SSE scaffold, infiltrated in and dried. An Li-metal flashing of Li nanoparticles may be infiltrated in the porous anode scaffold or the Li can be provided fully from the cathode composition so dry room processing can be avoided.

Another major advantage of this structure is that charge/discharge cycles will involve filling/emptying of the SSE scaffold pores (see FIG. 31), rather than intercalating and expanding carbon anode powders/fibers. As a result there will be no change in electrode dimensions between charged and discharged state. This is expected to remove both cycle fatigue and limitations on depth of discharge, the former allowing for greater cycle life and the later for greater actual battery capacity.

Moreover, there will be no change in overall cell dimensions allowing for the batteries to be stacked as a structural unit. Light-weight, ˜40 micron thick Al plates will serve not only as current collectors but also provide mechanical strength. ˜20 nm of Cu can be electrodeposited on the anode side for electrochemical compatibility with Li. The bipolar current collector plates can be applied before the slurry is fully dried and pressed to improve the electrical contact between bipolar current collector and the electrode materials.

Compared to current LiBs with organic electrolytes, the SSLiB with intrinsically safe solid state chemistry is expected to not only increase the specific energy density and decrease the cost on the cell level, but also avoid demanding packing level and system level engineering requirements. High specific energy density at both cell and system level can be achieved, relative to the state-of-the-art, by the following:
Stable electrochemical voltage window of garnet SSE allows for high voltage cathodes resulting in high cell voltage (˜6 V).
Porous SSE scaffold allows use of high specific capacity Li-metal anode.
Porous 3-dimensionally networked SSE scaffolds allows electrode materials to fill volume with a smaller charge transfer resistance, increasing mass percentage of active electrode materials.
Bipolar plates will be made by electroplating ˜200 Å Cu on ˜40 μm Al plates. Given the 3× lower density of Al vs. Cu the resulting plate will have same weight as the sum of the ˜10 μm Al and Cu foils used in conventional batteries. However, with 3× the strength (due to ˜9× higher strength-to-weight ratio of Al vs. Cu).
The repeat unit (SSLiB/bipolar plate) will then be stacked in series to obtain desired battery pack voltage (e.g., fifty 6V SSLiBs for a 300V battery pac would be <1 cm thick).
Thermal and electrical control/management systems are not needed as there is no thermal runaway concern.
The proposed intrinsically safe SSLiBs also drastically reduces mechanical protection needs.

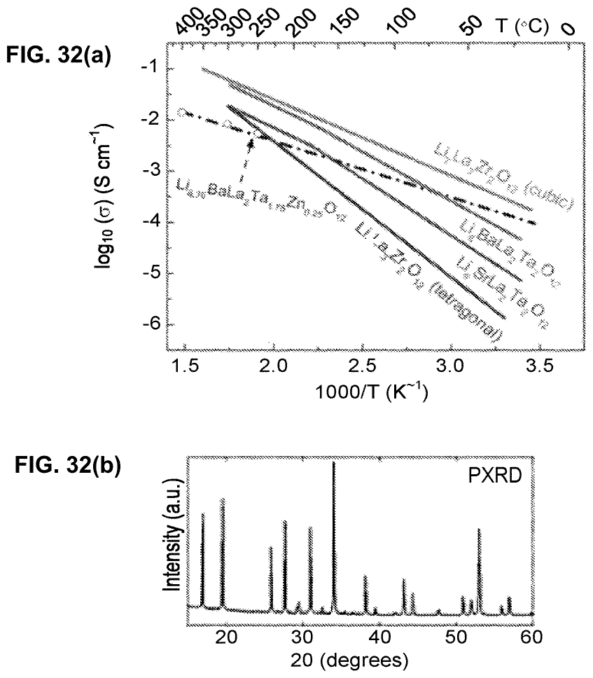

The energy density is calculated from component thicknesses of device structure (FIG. 32(a) and FIG. 32(b)) normalized to 1 cm² area (see data in Table 1). The estimated SSE scaffold porosity is 70% for the cathode and 30% for the anode. The charge/capacity is balanced for the anode and cathode by: m_{Li}×C_{Li}=m_{LMFO}×C_{LMFO}, where LFMO stands for Li₂FeMn₃O₈. Therefore, the total mass (cathode-scaffold/SSE/scaffold and bipolar plate) is calculated to be 50.92 mg per cm² area. Note it is our intent to fabricate charged cells with all Li in cathode to avoid necessity of dry room. Thus, anode-scaffold would be empty of Li metal for energy density calculations.

TABLE 1
Material parameters for energy density calculation.

| | Density | mass per | Capacity | Voltage |
|---|---|---|---|---|
| Material | (g/cm³) | cm² (mg) | (mA/g) | (Vs. Li) (V) |
| Cathode LFMO | 3.59 | 17.00 | 300 | 6 |
| Anode Li | 0.54 | 0 | 3800 | 0 |
| SSE | 5.00 | 27.5 | N/A | N/A |
| Al | 2.70 | 5.40 | N/A | N/A |
| Cu | 8.69 | 0.02 | N/A | N/A |
| Carbon additive | 1.00 | 1.00 | N/A | N/A |
| Cell Total | | 50.92 | | |

The corresponding total energy is Eₜₒₜ=C×V=5.13 mAh×6 V=30.78 mWh. The total volume is 1.7×10⁻⁵ L for 1 cm² area. Therefore, the theoretical effective specific energy, including structural bipolar plate, is ˜603.29 Wh/kg. As calculated below, the overpotential at C/3 is negligible compared with the cell voltage, leading to an energy density at this rate close to theoretical. Since the bipolar plate provides strength and no temperature control is necessary this is essential the full battery pack specification other than external can. (In contrast, state-of-art LiBs have a ˜40% decrease in energy density from cell level to pack level.) The corresponding effective energy density of the complete battery pack is 1810 Wh/L.

A desirable rate performance is expected with the SSLiBs due to 3-dimensional (3D) networked scaffold structures, comparable to organic electrolyte based ones, and much better than traditional planar solid state batteries. The reasons for this include the following:
Porous SSE scaffolds provide extended 3D electrode-electrolyte interface, dramatically increasing the surface contact area and decreasing the charge-transfer impedance.
Use of SSE having a conductivity of 10⁻³-10⁻² S/cm in electrode scaffolds to provide continuous Li⁺ conductive path.
Use of high aspect ratio (lateral dimension vs. thickness) graphene in electrode pores to provide continuous electron conductive path.

To calculate the rate performance, the overpotential of SSLiB, shown in FIG. 31, was estimated, including electrolyte impedance (Z_{SSE}) and electrode-electrolyte-interface impedance (Z_{interface}).

The porous SSE scaffold achieves a smaller interfacial impedance by: 1/Z_{interface}=S*Gs, where S is the interfacial area close to the porous SSE and Gs is the interfacial conductance per specific area. The interfacial impedance is expected to be small since the porous SSE results in a large electrode-electrolyte interfacial area. For ion transport impedance through the entire SSE structure: ZSSE=Zcathode-scaffold+Zdense-SSE+Zanode-scaffold; and Z=(μL)/(A*(1−ε)), where ρ=100 Ωcm, L is thickness (FIG. 31), A is 1 cm², and ε is porosity (70% for the cathode scaffold, 50% for the anode scaffold and 0% for the dense SSE layer). Therefore, Zcathode-scaffold=2.3 Ohm/cm², Zdense-SSE=0.01 Ohm/cm², and Zanode-scaffold=1 Ohm/cm²; resulting in Ztotal=3.31 Ohm/cm². At C/3, the current density=1.71 mA/cm² and the voltage drop is 5.02 mV/cm², which is negligible compared with a 6 V cell voltage.

Desirable cycling performance is expected due to the following advantages:
No structural challenges associated with intercalating and de-intercalating Li due to filling of 3D porous structure.
Excellent mechanical and electrochemical electrolyte-electrode interface stability due to 3D porous SSE structure.
No SEI formation inherent in current state-of-art LiBs, which consumes electrolyte and increase cell impedance.
No Li dendrite formation (problematic for LiBs with Li anodes) due to dense ceramic SSE. Therefore, the calendar life should easily exceed 10 years and the cycle life should easily exceed 5000 cycles.

The SSLiB is an advancement in battery materials and architecture. It can provide the necessary transformational change in battery performance and cost to accelerate vehicle electrification. As a result it can improve vehicle energy efficiency, reduce energy related emissions, and reduce energy imports.

FIGS. 32(a) and 32(b) shows the conductivity for Li garnets, including Li_{6.75}BaLa₂Ta_{1.75}Zn_{0.25}O₁₂. It is expected that the lower activation energy of this composition will provide a path to achieve RT conductivity of ˜10⁻² Scm-1 when similar substitutions are made in Li₇La₃Zr₂O₁₂.

Since garnet SSEs can be synthesized as ceramic powders (unlike LiPON) high speed, scaleable multilayer ceramic fabrication techniques can be used to fabricate supported thin-film (˜10 μm) SSEs on tailored nano/micro-structured electrode scaffolds (FIG. 31). Tape casting 50 and 70 μm tailored porosity (nano/micro features) SSE support layers, followed by colloidal deposition of a ˜10 μm dense SSE layer and sintering can be used. The resulting pinhole-free SSE layer will be mechanically robust due to support layers and have a low area specific resistance ASR, of only ˜0.01 Ωcm⁻².

The ˜6.0 volt cathode compositions (Li₂MMn₃O₈, M=Fe, Co) have been synthesized. These can be combined with SSE scaffold & graphene to increase ionic and electronic conduction, respectively, as well as to reduce interfacial impedance. Li₂MMn₃O₈ can be screen printed into the porous cathode scaffold and Li-metal impregnated in the porous anode scaffold.

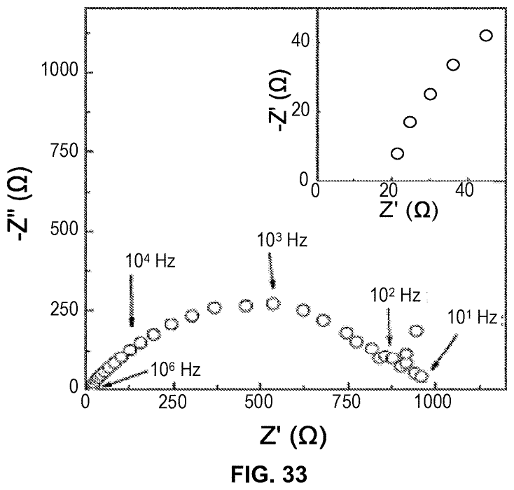

FIG. 33 shows EIS results for a solid state Li cell tested using the Li infiltrated porous scaffold anode, supporting a thin dense SSE layer, and screen printed LiFePO₄ cathode. The high-frequency intercept corresponds to the dense SSE impedance and the low frequency intercept the entire cell impedance.

Bipolar plates can be fabricated by electroplating ˜200 Å Cu on ˜40 μm Al. Given the 3× lower density of Al vs. Cu the resulting plate will have same weight as the sum of the ˜10 μm Al and Cu foils used in conventional batteries. However, with 3× the strength (due to ˜9× higher strength-to-weight ratio of Al vs. Cu). Increases in strength can be achieved by simply increasing Al plate thickness with negligible effect on gravimetric and volumetric energy density or cost. The repeat unit (SSLiB/bipolar plate) can be stacked in series to obtain desired battery pack voltage (e.g., fifty 6V SSLiBs for a 300V battery pack would be <1 cm thick).

In terms of performance and cost:

The energy density of SSLiBs shown in FIG. 31 is ˜600 Wh/kg based on a 6 V cell. A Li₂FeMn₃O₈ cathode has a voltage of 5.5 V vs. Li. With this cathode, energy density of 550 Wh/kg can be achieved.

The calculation for energy density in Table 3 does not include packing for protection of thermal runaway and mechanical damage as this is not necessary for SSLiBs. If 20% packaging is included, the total energy density is still 500 Wh/kg.
The voltage drop of ˜5 mV for C/3 was based on SSE with an ionic conductivity of ˜10⁻² S/cm (using the porous SSE scaffold with dense SSE layer and corresponding small interfacial charge transfer resistance). At an ionic conductivity of 5×10⁻⁴ S/cm, the voltage drop for C/3 rate is only ˜0.1V, which is significantly less than the cell voltage of 6 V.
The materials cost for SSLiBs is only ˜50 $/KWh due to the high SSLiB energy density and corresponding reduction in materials to achieve the same amount of energy. The non-material manufacturing cost is expected, without the need of dry room, for our SSLiBs to be lower than that for current state-of-art LiBs.

The SSE materials can be synthesized using solid state and wet chemical methods. For example, corresponding metal oxides or salts can be mixed as solid-state or solution precursors, dried, and synthesized powders calcined between 700 and 1200° C. in air to obtain phase pure materials. Phase purity can be determined as a function of synthesis method and calcining temperature by powder X-ray diffraction (PXRD, D8, Bruker, Cuka). The structure can be determined by Rietveld refinements. Using structural refinement data, the metal-oxygen bond length and Li—O bond distance can be estimated to determine role of dopant in garnet structure on conductivity. In-situ PXRD can be performed to identify any chemical reactivity between the garnet-SSEs and the Li₂(Fe, Co)Mn₃O₈ high voltage cathodes as a function of temperature. The Li ion conductivity can be determined by electrochemical impedance spectroscopy (EIS-Solartron 1260) and DC (Solartron Potentiostat 1287) four-point methods. The electrical conductivity can be investigated using both Li⁺ blocking Au electrodes and reversible elemental Li electrodes. The Li reversible electrode measurement will provide information about the SSE/electrode interface impedance in addition to ionic conductivity of the electrolyte, while the blocking electrode will provide information as to any electronic conduction (transference number determination). The concentration of Li⁺ and other metal ions can be determined using inductively coupled plasma (ICP) and electron energy loss spectroscopy (EELS) to understand the role of Li content on ionic conductivity. The actual amount of Li and its distribution in the three different crystallographic sites of the garnet structure can be important to improve the conductivity and the concentration of mobile Li ions will be optimized to reach the RT conductivity value of 10⁻² S/cm.

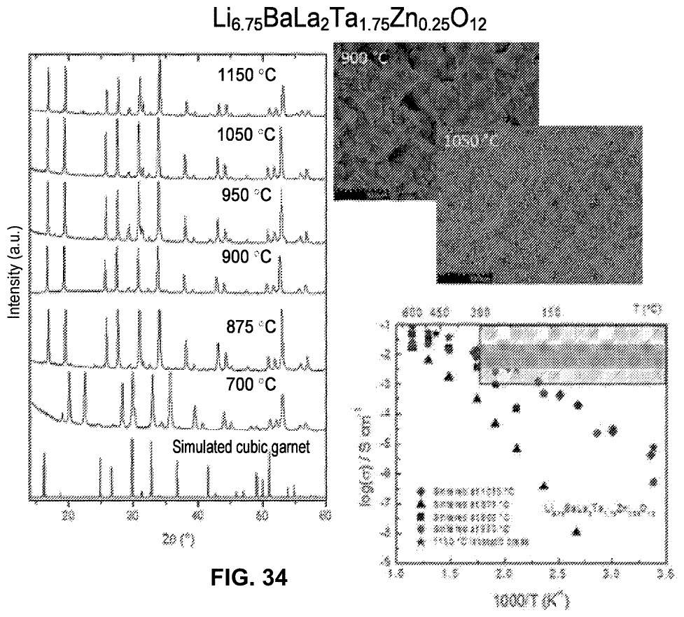

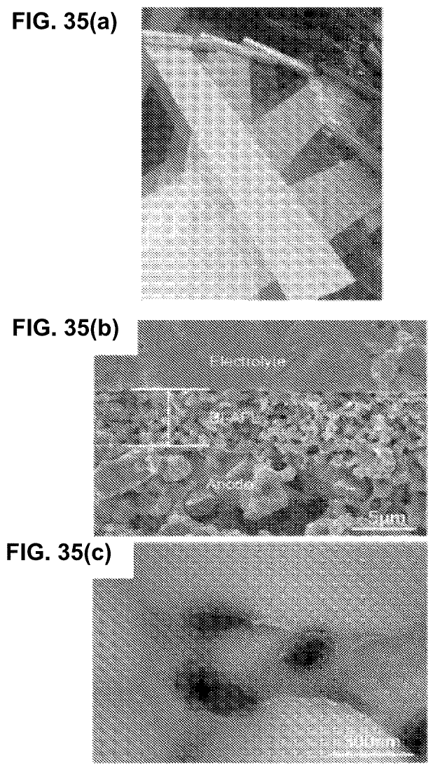

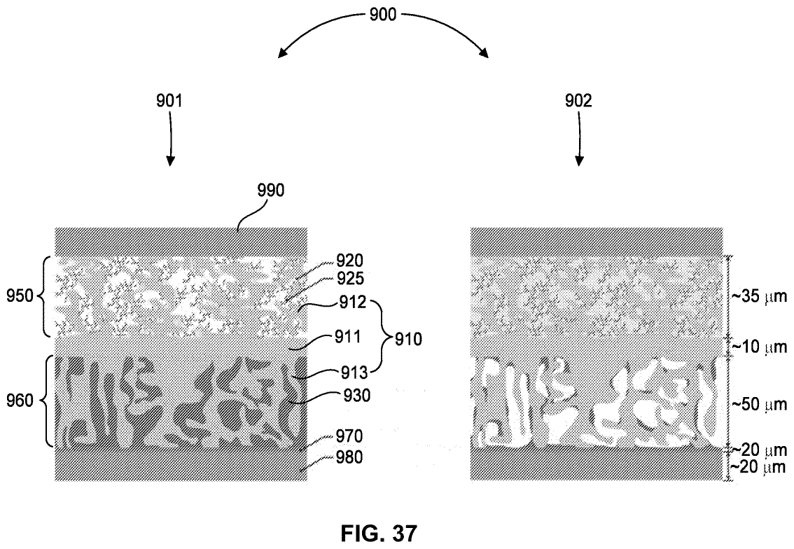

Sintering of low-density Li-garnet samples is responsible for a lot of the literature variability in conductivity (e.g., as shown in FIG. 34). The primary issue in obtaining dense SSEs is starting with submicron (or nano-scale) powders. By starting with nano-scale powders it is expected that the sintering temperature necessary to obtain fully dense electrolytes can be lowered. The nanoscale electrolyte and electrode powders can be made using co-precipitation, reverse-strike co-precipitation, glycine-nitrate, and other wet synthesis methods. These methods can be used to make desired Li-garnet compositions and to obtain submicron SSE powders. The submicron SSE powders can then be used in ink/paste formulations by mixing with appropriate binders and solvents to achieve desired viscosity and solids content. Dense thin-film (˜10 μm) garnet SSEs on porous SSE scaffolds (e.g., FIG. 37) can be formed by tape casting (FIG. 35(a)), colloidal deposition, and sintering. The methods described can be used to create nano-dimensional electrode/electrolyte interfacial areas to minimize interfacial polarization (e.g., FIG. 35(c)). The symmetric scaffold/SSE/scaffold structure shown in FIG. 31 can be achieved by laminating a scaffold/SSE layer with another scaffold layer in the green state (prior to sintering) using a heated lamination press.

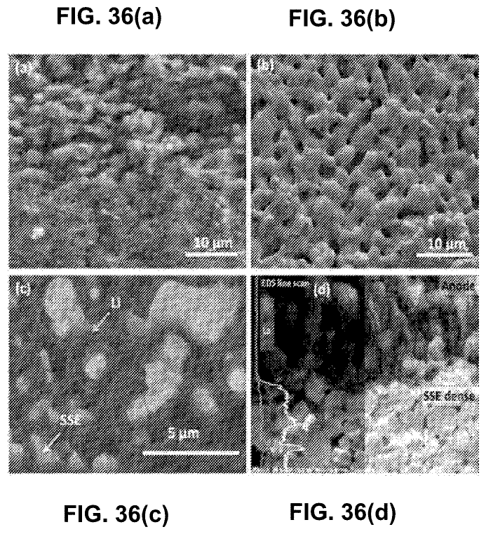

Cathode and anode integration. Nanosized (˜100 nm) cathode materials Li₂MMn₃O₈ (M=Fe, Co) can be synthesized. With the SSE that is stable up to 6V, a specific capacity of 300 mAh/g is expected. Slurries of cathode materials can be prepared by dispersing nanoparticles in N-Methyl-2-pyrrolidone (NMP) solution, with 10% (weight) carbon black and 5% (weight) Polyvinylidene fluoride (PVDF) polymer binder. The battery slurry can be applied to cathode side of porous SSE scaffold by drop casting. SSE with cathode materials can be heated at 100° C. for 2 hours to dry out the solvent and enhance electrode-electrolyte interfacial contact. Additional heat processing may be needed to optimize the interface. The viscosity of the slurry will be controlled by modifying solids content and binder/solvent concentrations to achieve a desired filling. The cathode particle size can be changed to control the pore filling in the SSE. In an example, all of the mobile Li will come from cathode (the anode SSE scaffold may be coated with a thin layer of graphitic material by solution processing to “start-up” electronic conduction in the cell). In another example, a thin layer of Li metal will be infiltrated and conformally coated inside anode SSE scaffold. Mild heating (˜400° C.) of Li metal foil or commercial nanoparticles can be used to melt and infiltrate the Li. Excellent wetting between Li-metal and SSE is important and was obtained by modifying the surface of the SSE scaffold (FIG. 36(a)-36(d)). To fill the SSE pores in the anode side with highly conductive graphitic materials, a graphene dispersion can be prepared by known methods. For example, 1 mg/mL graphene flakes can be dispersed in water/IPA solvent by matching the surface energy between graphene and the mixed solvent. Drop coating can be used to deposit conductive graphene with a thickness of ˜10 nm inside the porous SSE anode scaffold. After successfully filling the scaffold pores, the cell can be finished with metal current collectors. Al foil can be used for the cathode and Cu foil for the anode. Bipolar metals can be used for cell stacking and integration. To improve the electrical contact between electrodes and current collectors, a thin graphene layer may be applied. The finished device may be heated up to 100° C. for 10 minutes to further improve the electrical contact between the layers. The electrochemical performance of the SSLiB can be evaluated by cyclic voltammetry, galvanostatic charge-discharge at different rates, electrochemical impedance spectroscopy (EIS), and cycling performance at C/3. EIS can be used in a broad frequency range, from 1 MHz to 0.1 mHz, to investigate the various contributions to the device impedance, and reveal the interfacial impedance between the cathode and SSE by comparing the EIS of symmetrical cells with Li-metal electrodes. The energy density, power density, rate dependence, and cycling performance of each cell, as a function of SSE, electrode, SSE-electrolyte interface, and current collector-electrode interface can be determined.

Multi-cell (2-3 cells in series) SSLiBs with Al/Cu bipolar plates can be fabricated. The energy/power density and mechanical strength can be determined as a function of layer thicknesses and area.

### Example 8

In some embodiments, 3D Li—S batteries are based on a tri-layer solid state electrolyte structure. This battery configuration is shown in FIG. 37.

FIG. 37 shows an example of a solid state lithium sulfur battery 900 in different states. Battery 901 is in a charging state. Battery 902 is in a discharging state.

Battery 900 includes a tri-layer solid state scaffold 910. Tri-layer solid state scaffold 910 includes a dense central layer 911, a first porous electrolyte material 912 having a first network of pores therein, and a second porous electrolyte material 913 having a second network of pores therein. Dense central layer 911 has a first surface on which first porous electrolyte material 912 is disposed, and a second surface opposite the first surface on which second porous electrolyte material 913 is disposed.

A cathode material 920 is infiltrated throughout the first network of pores. A carbon material 925, for example carbon nanofibers, is also infiltrated throughout the first network of pores. Collectively, first porous electrolyte material 912, cathode material 920, and carbon material 925 form a first electrode 950. Each of first porous electrode material 912 and cathode material 920 percolate through first electrode 950—in other words, there are conduction pathways through first electrode 950 in each of first porous electrode material 912 and cathode material 920. In some embodiments, cathode material 920 is a solid material, preferably S or Li₂S. As the battery charges and discharges, Li ions move through scaffold 910. So, in a charged state, cathode material 920 may be S, and in a discharged state, cathode material may be Li₂S.

An anode material 930 is infiltrated throughout the second network of pores. Collectively, second porous electrode material 913 and anode material 930 form a second electrode 960. Each of second porous electrode material 913 and anode material 930 percolate through second electrode 960—in other words, there are conduction pathways through second electrode 960 in each of second porous electrode material 913 and anode material 930. In some embodiments, anode material 930 is Li.

Battery 900 may include other features, such as a first current collector 970, a second current collector 980, and a third current collector 990. These current collectors may be made of any suitable material, for example Cu and Ti for first current collector 970 and second current collector 980, respectively.

Dense central layer 911 may have a thickness of 5 to 30 microns, preferably 10 to 30 microns. At smaller thicknesses, the likelihood of an undesirable pinhole or pathway through the layer increases. At greater thicknesses, the resistance across the battery may undesirably increase without any corresponding benefit. The most desirable thickness may be affected by factors such as the specific electrolyte material used in dense central layer 911, and the density of that material the layer.

First electrode 950 may have a thickness between 20 and 200 microns. The energy density of the first electrode increases with thicknesses. At lower thicknesses, the energy density may be undesirably low. But, if the thickness is too high, ions may have difficulty migrating across the electrode, which undesirably increases resistance. Second electrode 960 may have a thickness in the same range, for the same reasons. But, the thicknesses of the first electrode 950 and second electrode 960. The thicknesses of first electrode 950 and second electrode 960 may be adjusted such that the two electrodes have similar energy densities. As illustrated in FIG. 37, first electrode 950 has a thickness of 35 microns, dense central layer 911 has a thickness of 10 microns, second electrode 960 has a thickness of 50 microns, first current collector 970 has a thickness of 20 microns, and second current collector 980 has a thickness of 20 microns.

The 3D Li—S batteries are based on a tri-layer structure with the following attributes: The battery consists of three components: tri-layer solid state electrolyte, cathode, and lithium metal anode. The tri-layer solid state electrolytes have a supported thin-film dense layer in the middle, and a thicker porous scaffold support layer on the cathode side and anode side, respectively. The porous scaffold on the cathode side is designed to host sulfur based materials, which can be solid cathode (S, Li₂S), or liquid cathode (polysulfide Li₂Sx, 8>x>2). The infiltration method could be liquid penetration or gas infusion. In the anode side, Li metal is infiltrated into the pores of scaffold. This highly porous scaffold provides large interface area to enable better contact with cathode and anode, which can significantly decrease cell impedance. This solid state Li—S battery can effectively increase the energy density of batteries, and prevent lithium dendrite penetration through the dense solid state electrolyte. Conductive contents are added in the two outer layers of SSE scaffold to improve electron transport. These conductive materials can be conductive polymer or porous carbon nanotubes (CNT)/fibers, or other conducting carbon materials. Charge/discharge cycles in the 3D networked SSE scaffolds occur by pore filling/emptying thus removing electrode cycling fatigue and allowing for tight cell dimensional tolerances since electrodes don't expand or shrink when cycled. An exemplary cell was fabricated. The cell had a triple layer ceramic lithium conductor Li₇La_{2.75}Ca_{0.25}Zr_{1.75}Nb_{0.25}O₁₂ with liquid cathode (polysulfide and single-walled CNT) infiltrated in cathode and Li metal infiltrated in anode. The cell was fabricated following the below procedures: Synthesized the Li₇La_{2.75}Ca_{0.25}Zr_{1.75}Nb_{0.25}O₁₂ powder by solid state reaction.

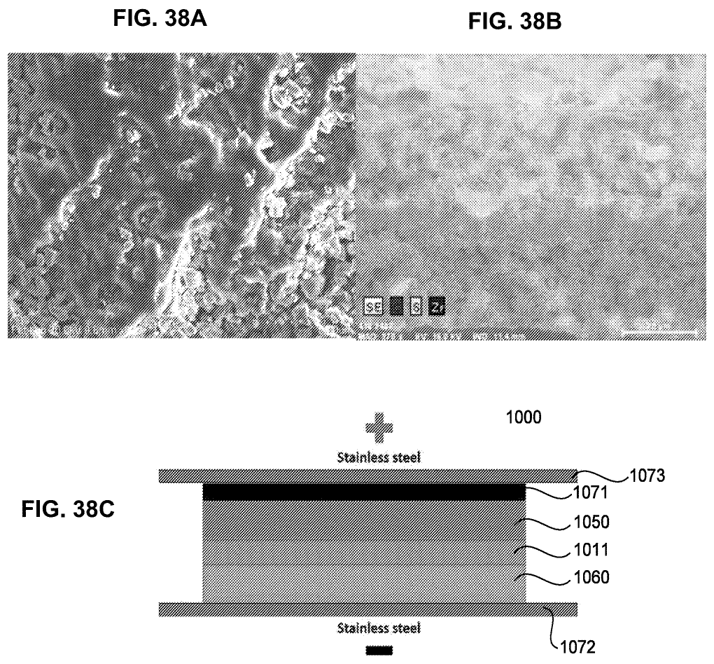

Fabricated the trilayer SSE by tape casting method and firing at 1050° C. in O₂ to achieve ideal structure. Infiltrated Li metal by pressing lithium foil onto one side of the trilayer SSE and heating at 300° C. for 1 hour. The whole process was carried out in an argon-filled glove box. FIG. 38A shows the cross-section SEM of porous garnet infiltrated with Li metal. Infiltrated cathode by two steps. In the first step, CNT was added as conductive material to improve the electronic conductivity in cathode. Generally, CNT was dispersed in isopropyl alcohol (IPA) with a concentration of 1 mg/ml and stirred overnight to achieve uniform CNT solution. This CNT solution was then added to the other side of the fore-mentioned trilayer SSE dropwise, following by drying in at 100° C. in argon-filled furnace for 1 hour. In the second step, Sulfur/carbon disulfide (S/CS₂) solution was added to the CNT coated porous garnet and dried at 100° C. in argon-filled furnace to remove the bulk sulfur on surface. FIG. 38B shows the elemental mapping on a cross section SEM image of a S/C filled trilayer SSE. A tiny amount of ionic liquid, 1M lithium bis(trifluoromethanesulfonyl)imide [LiTFSI] in a mixture of 1:1 volume ratio of tetraethylene glycol dimethyl ether and n-methyl-(n-butyl) pyrrolidinium bis(trifluoromethanesulfonyl)imide, was added to sulfur cathode to increase the interfacial ionic conductivity and charge transfer between sulfur and garnet. The prepared cell was assembled into a standard 2032 coin cell battery following the configuration design shown in FIG. 38C.

FIG. 38C shows a schematic of a cell assembly 1000 for electrochemical testing. Cell assembly 1000 includes, stacked in order, stainless steel plate 1072, second electrode 1060, dense central layer 1011, first electrode 1050, carbon nanofiber layer 1071, and stainless steel plate 1073. Second electrode 1060, dense central layer 1011, and first electrode 1050 have structures analogous to second electrode 960, dense central layer 911, and first electrode 950 of FIG. 37, respectively.

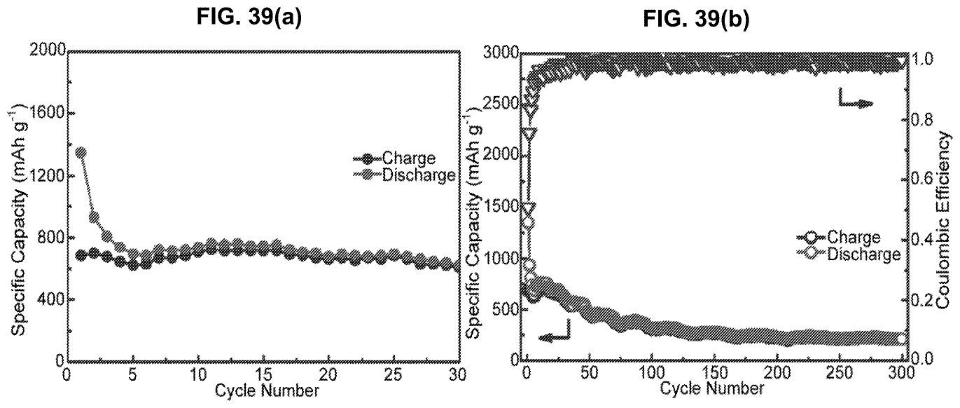

The cell was tested in a voltage window between 1-3 V with a current density of 1 mA/mg-S. The cycling performance of the cell for 30 cycles is shown in FIG. 39(a). In the first cycle, the discharge capacity was more than 1300 mAh/g and charge capacity was around 700 mA/g, with a coulombic efficiency of 54%. In the following cycles, discharge capacities were stabilized to 700 mAh/g. The capacity remained at 700 mAh/g to the 30th cycle. FIG. 39(b) shows the battery cycling performance for 300 cycles. After 100th cycle, capacity maintained at a stable level 230 mAh/g till 300th cycle. Note that the coulombic efficiency was stable at 99%, demonstrating no polysulfide shuttling effect occurred to this solid-state Li—S cell.

In some embodiments, a Li-garnet enabled Li—S battery has several advantages which are desirable for practical energy storage application including superior coulombic efficiency, high power density and wide operating temperature and pressure capability. In some embodiments, batteries described herein may be used in: electric vehicles (EVs), consumer electronics (cell phone, camera, laptop, etc.), drones (unmanned aerial vehicle, UAV), and stationary energy storage for renewable energies (wind, and solar).

### Example 9

### Exemplary Solid State Li—S Cell Design

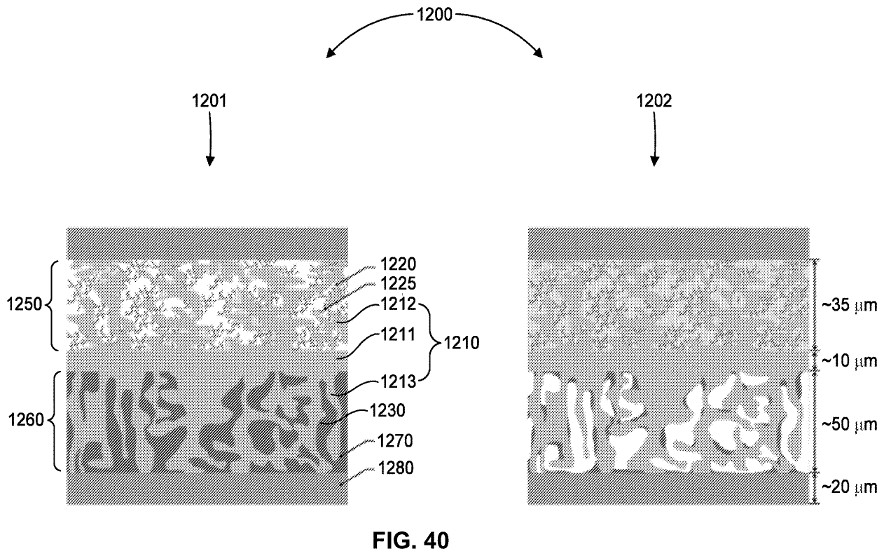

A “Very High Specific Energy Device” of some embodiments is shown in FIG. 40. The device of FIG. 40 integrates Li-garnet based solid-state electrolytes (SSE) with maximum theoretical capacity Li metal anodes and high capacity S cathodes, in a unique trilayer porous/dense/porous structure using desirable ceramic fuel cell fabrication techniques.

FIG. 40 shows an example of a solid state lithium sulfur battery 1200 in different states. Battery 1200 is similar to battery 900, with battery 901, battery 902, tri-layer solid state scaffold 910, dense central layer 911, first porous electrolyte material 912, second porous electrolyte material 913, cathode material 920, carbon material 925, first electrode 950, anode material 930, second electrode 960, and first current collector 970 corresponding to battery 1200, with battery 1201, battery 1202, tri-layer solid state scaffold 1210, dense central layer 1211, first porous electrolyte material 1212, second porous electrolyte material 1213, cathode material 1220, carbon material 1225, first electrode 1250, anode material 1230, second electrode 1260, and first current collector 1270. Battery 1200 differs from battery 900 in that battery 1200 lacks a second current collector corresponding to second current collector 980 of battery 900, and in that first current collector 1270 of battery 1200 is 10 microns thick and made of Ti.

The use of garnet SSEs provides several desirable advantages: high RT bulk conductivity (˜10⁻³ S/cm)⁵⁻⁶ comparable to liquid/polymer electrolytes, but ceramic SSE is inflammable. High electrochemical stability from Li metal to high voltage (6 V). Excellent chemical stability in contact with elemental and molten Li anodes up to 400° C. Wide operating temperature capability, maintaining appreciable conductivity below 0° C. and increasing with temperature reaching 0.1 Scm⁻¹ at 300° C.

Further, the trilayer garnet structure provides additional desirable advantages: the porous SSE scaffold on either side of trilayer provides structural support for fabrication of very thin dense center layer with corresponding low area specific resistance (2 Ω·cm²). The porous 3D networked SSE scaffold layers provide dramatically increased electrolyte/electrode contact area thus decreasing electrode interfacial impedance. Charge/discharge cycles in the 3D networked SSE scaffolds occur by pore filling/emptying thus removing electrode cycling fatigue and allowing for tight cell dimensional tolerances since electrodes don't expand or shrink when cycled. The supported dense ceramic SSE layer prevents dendrite shorting.

In some embodiments, various desirable features are incorporated into a battery. These desirable features include:

1. Higher Conductivity and Lower Sintering Temperature Garnet Compositions

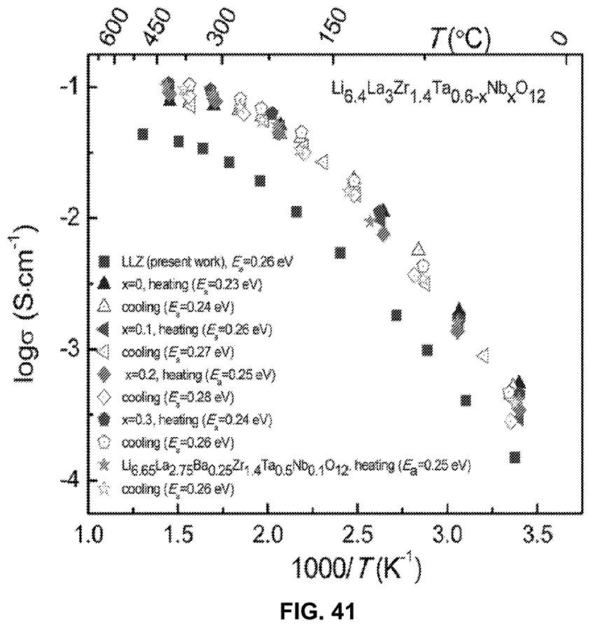

In some embodiments, specific garnet-type SSE are used. Several garnet-type SSE compositions were developed to both lower the sintering temperature and improve the ionic conductivity. Li₇La_{2.75}Ca_{0.25}Zr_{1.75}Nb_{0.25}O₁₂ (LLCZN) was successfully synthesized by solid state reaction and sol-gel methods. It was demonstrated that LLCZN can be sintered at significantly lower temperature (1050° C.) and still yield high Li-ion conductivity (˜0.4 mS/cm at room temperature). The lower LLCZN sintering temperature reduces lithium loss and improves the trilayer fabrication process. Higher ionic conductive Li-based garnets were developed by La³⁺-sites substitution with Ba²⁺ and Zr⁴⁺-sites with Ta⁵⁺ and Nb⁵⁺. As shown in FIG. 41, Li_{6.4}La₃Zr₁₄Ta_{0.5}NbₓO₁₂ (0≤x≤0.3) and Li_{6.65}La_{2.75} Ba_{0.25}Zr_{1.4}Ta_{0.5}Nb_{0.1}O₁₂ show significantly higher conductivity than LLZ, achieving a Li ion conductivity of 0.72 mS/cm at 25° C.

### Example 10

### Development of Scalable Trilayer Garnet Fabrication Process

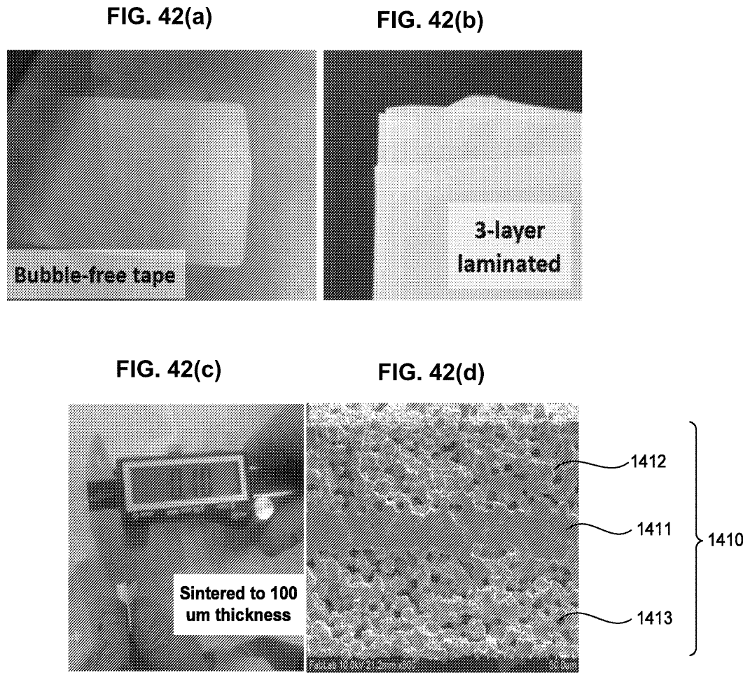

In some embodiments, trilayer (porous-dense-porous) garnet SSEs (consistent with FIG. 40) fabricated by tape casting are used. Tapes were prepared from calcined LLCZN powder slurries, with PMMA spheres added as sacrificial pore formers for the outer 2 layer tapes. FIG. 42(a) shows a typical 2 m long garnet tape, which is flexible and pinhole free. The inset to FIG. 42(a) shows tape flexibility. Trilayer green tapes were prepared by laminating 2 porous tapes and central dense tape (see FIG. 42(b)). The sintered trilayer SSE has a total thickness of 100 μm (See FIG. 42(c)) with the desired thin (10 μm) dense center layer and porous outer layers (See FIG. 42(d)).

FIG. 42(d) shows an SEM image of a sintered tri-layer scaffold 1410. Scaffold 1410 includes dense central layer 1411, first porous electrolyte material 1412, and second porous electrolyte material 1413.

### Example 11

### Overcame Liₘₑₜₐₗ-Garnet Interfacial Impedance

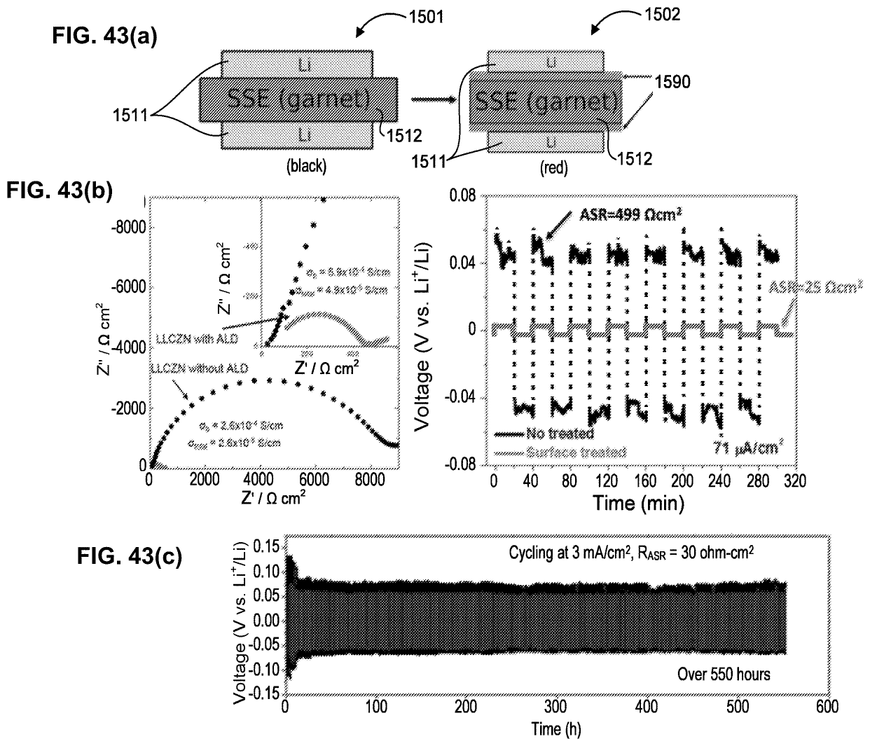

In some embodiments, an interface layer is used to reduce Liₘₑₜₐₗ-Garnet Interfacial Impedance. While there is tremendous interest in solid-state batteries and progress has been made on increasing the lithium ion conductivity of SSEs, there has been little success on the development of high-performance batteries using these SSEs. A major issue is the high interfacial impedance between SSEs and solid electrode materials. This interfacial impedance between Li metal and the garnet SSE may be reduced using an ultrathin Al₂O₃ interface layer, deposited by atomic layer deposition (ALD), as illustrated in FIG. 43(a)-(c).

Two dense (150 μm thick) garnet pellets were prepared, one with and one without the ALD Al₂O₃, and a Liₘₑₜₐₗ foil applied to both sides of each pellet, FIGS. 42(a)-(c). The 1 nm Al₂O₃ layer resulted in about a twenty fold decrease in impedance relative to the pellet without the Al₂O₃ layer, both using electrochemical impedance spectroscopy (EIS), and by DC cycling (See FIG. 43(b)). The area specific resistance (ASR) includes both two Liₘₑₜₐₗ-garnet interfaces and the bulk impedance of the garnet pellet itself. After subtracting the bulk garnet contribution (using its known conductivity and thickness), the Liₘₑ-garnet interfacial impedance is essentially zero, indicating that the 1 nm Al₂O₃ layer effectively negates the Liₘₑₜₐₗ-garnet interfacial impedance. Further, stable cycling for 800 cycles with no change in impedance was observed (See FIG. 43(c)), confirming the stable interface between the Liₘₑₜₐₗ and Al₂O₃ coated garnet SSE.

FIG. 43(a) shows schematics of symmetric cells 1501 and 1502. Cell 1501 includes a dense central layer 1511, a first electrode 1550, and a second electrode 1560. Cell 1502 includes the same layers as cell 1501, and additionally includes a 1 nm ALD-AL₂O₃ coating 1590. Dense central layer 1511 is made of LLCZN. First electrode 1550 and second electrode 1560 are both made of Li.

### Example 12

### High Current Density and Depth of Discharge Cycling of Liₘₑₜₐₗ

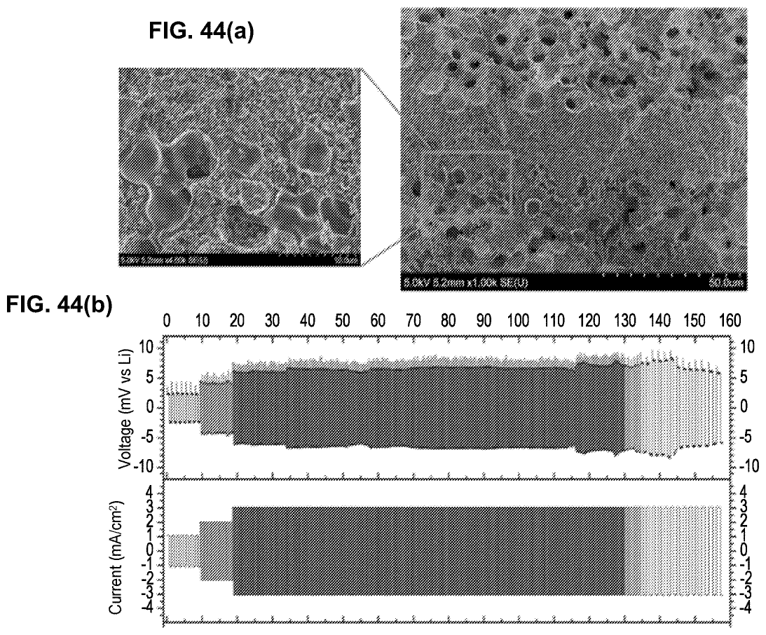

In some embodiments, a high current density (3 mA/cm²) and high depth of discharge (95%) cycling of Liₘₑₜₐₗ across trilayer (porous-dense-porous) garnet SSE structures has been demonstrated with a ˜17 μm dense center layer and ˜50 μm porous layer on either side (See FIGS. 44(a) and (b)). Stable Galvanostatic cycling was observed for over 360 cycles at high current densities. From 1 to 3 mA/cm² the ASR remained essentially constant at only ˜2 Ωcm² (which includes both the electrolyte and two symmetric Liₘₑₜₐₗ electrodes), and did not increase with either increasing current density or depth of discharge (See FIG. 44(b)). SEM imaging after cycling demonstrates that the Li metal filled the garnet pores (See FIG. 44(a)), consistent with our cell design concept (See FIG. 40). Further, the SEMs demonstrate that with our Al₂O₃ coating the Li metal wets the garnet surface as it fills the pores. Moreover, no Li dendrite formation was observed from either electrochemical cycling data or extensive SEM imaging of the dense garnet layer interface across the sample width.

### Example 13

### Sulfur and Carbon Co-Infiltrated into Porous Garnet Scaffold

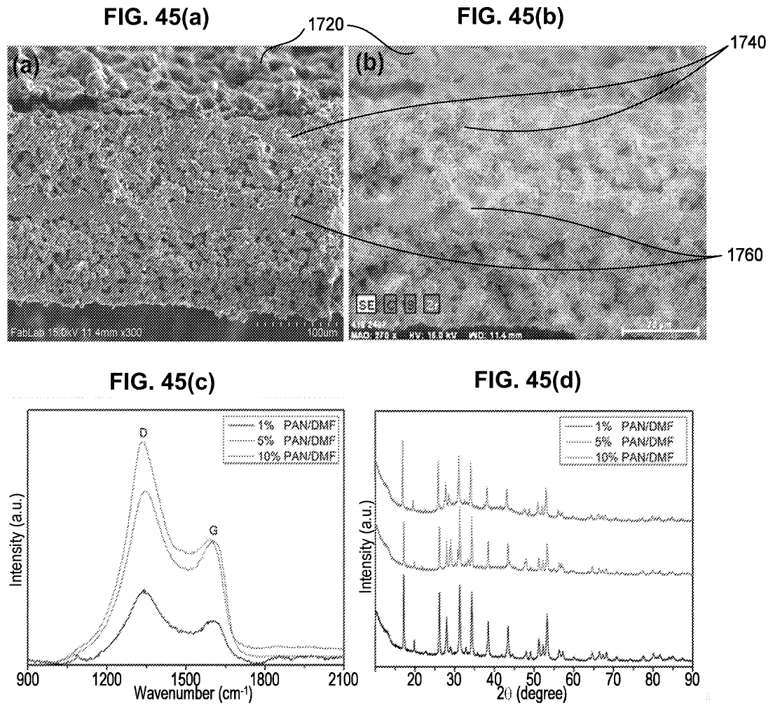

In some embodiments, sulfur (S) and carbon (C) were successfully infiltrated in porous garnet SSEs using both vapor (600° C. under vacuum) and liquid (2 M Li₂Sg with PAN in DMF) infiltration methods. Sulfur infiltrated using liquid Li₂S-PAN in DMF is co-infiltrated with C. A uniform distribution of the three phases: electronically conductive C, Li-storage S, and ionically conductive garnet, has been achieved (See FIGS. 45(a) and 45(b)), which will enable fast charge transfer kinetics for sulfur cathodes. Raman spectroscopy in FIG. 45(c) indicates that the infiltrated carbon exhibits an amorphous structure of graphitic layers, and XRD (See FIG. 45(d)) demonstrates that the garnet SSE is stable during the high temperature carbonization process. Thus we have achieved everything necessary to employ this cathode.

The sulfur and carbon infiltration into a porous garnet SSE described herein may be advantageously used as a cathode in combination with a wide variety of battery structures. Such structures include, but are not limited to, batteries with a lithium-containing anode. Such structures include, but are not limited to, batteries with an anode comprising an anode material infiltrated into a porous structure. For example, an anode without a porous structure may be used. In a preferred embodiment, which exhibits unexpectedly superior performance, a solid state battery has the structure shown in FIG. 40. This structure uses a SSE scaffold comprising a garnet material, with a central dense layer and porous layers on both sides. In one of the porous layers, lithium is infiltrated to form an anode. In the other porous layer, sulfur and carbon are infiltrated to form an anode. This combination of features shows unexpectedly superior results. Other variables, such as layer thicknesses, specific material selections, etc. may further multiply these unexpected results. But, the unexpectedly superior results of the basic structure still exist when compared to other structures.

### Example 14

### Working Cells with All-Solid-State Li—S Chemistry

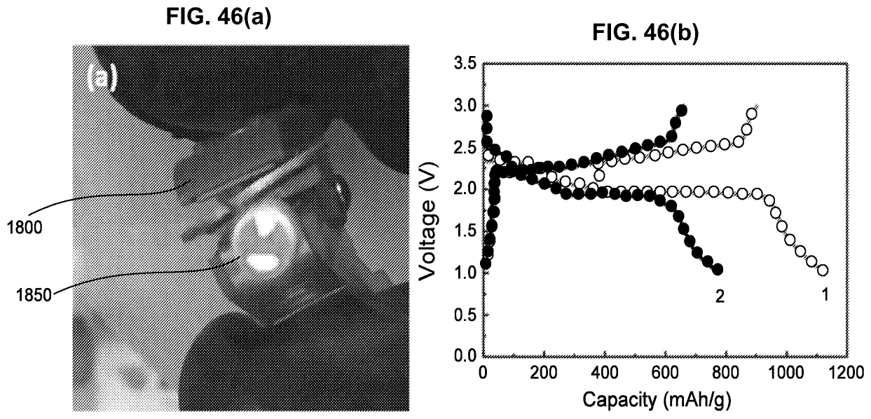

Working cells with Li—S chemistry and the garnet SSE trilayer structure have-been demonstrated. In some embodiments, the garnet surface was ALD coated to improve Liₘₑₜₐₗ wetting. A sulfur cathode was them infiltrated on one side, followed by infiltration of a Liₘₑₜₐₗ anode on the other side. A thin carbon nanotube sponge was placed between metal foil current collectors and the garnet to improve electrical contact. FIGS. 46(a) and (b) demonstrates that the cell works, and exhibits S voltage plateaus. Note that the S mass loading for this cell was only 3 mg/cm². A significant increase in capacity and cycling stability may be achieved by increasing sulfur mass loading in future. However, these results clearly demonstrate the feasibility of solid-state Li—S cells described herein.

FIG. 46(a) shows a working Li—S cell 1800 with a garnet electrolyte that lights up a LED device 1850.

### Example 15

### Cell and Pack Performance

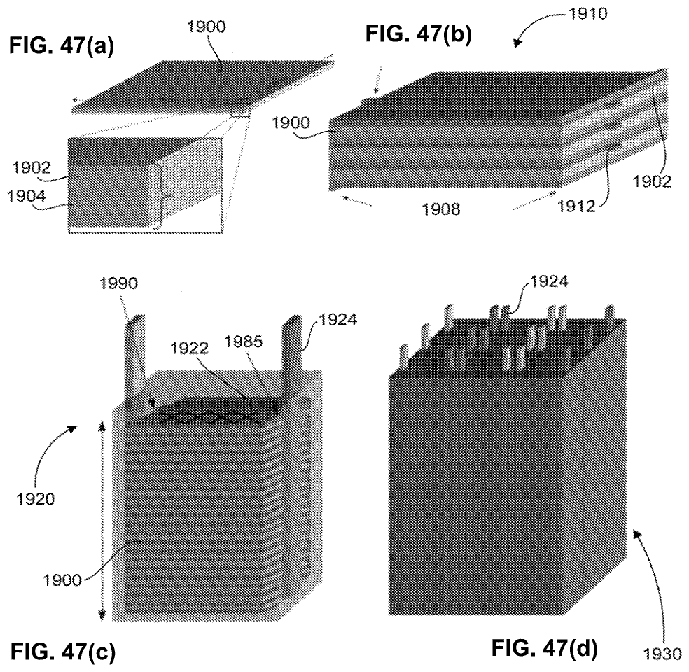

In some embodiments, full format cells with a dimension of 10 cm×10 cm may be fabricated, with an energy density of 541 Wh/kg. Scalable processes may be used to fabricate these full format cells. Current collector, sealing, and packaging features may be added. Multi-cell stack of full format cells may be fabricated. Packs may be designed. SOFC fabrication techniques may be used for cell scale-up. Table B shows the dimensions and thickness of the layers for some embodiments. Due to the excellent mechanical strength and safety of the Li—S batteries with garnet SSE, the performance at the battery pack level is expected to be similar to the value at the cell level. In some embodiments, 14 cells may be stacked in series to achieve 28 V stacks (See FIG. 47(a)). These stacks will then be stacked in series with parallel current collection to form “piles” (See FIGS. 47(b) and 47(c)). In some embodiments, 9 such piles may be used to achieve a total Pack energy of 53 kWh and mass of 100 kg (See FIG. 47(d)).

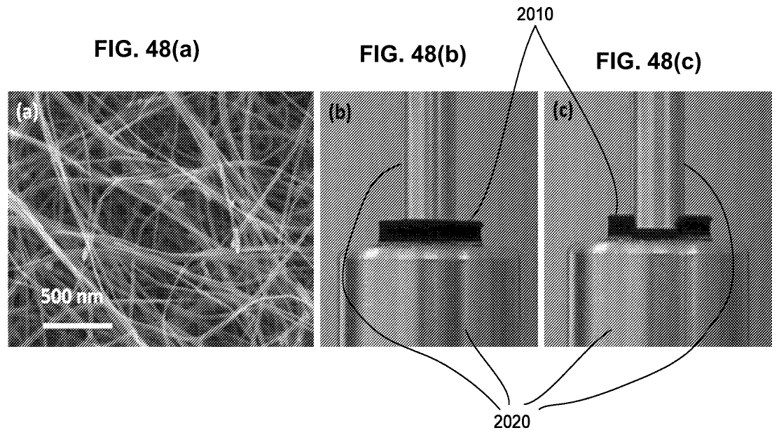

FIG. 48(b) shows a first picture of a compressible carbon nanotube (CNT) sponge 2010. Compression device 2020 is not compressing sponge 2010. FIG. 48(c) shows a second picture of compressible carbon nanotube (CNT) sponge 2010. Compression device 2020 is compressing sponge 2010.

### Example 16

### Relevance to Space Flight Systems and Infusion Potential

Solid-state batteries have the potential to provide a transformative solution to crucial energy storage needs for multiple mission applications associated with both robotic science and human exploration of space. Garnet electrolytes are highly conductive across a wide temperature range. It is expected that solid-state batteries described herein will be able to operate over a wide temperature range, far exceeding a desired range of −10 to 30° C., especially at the upper end, without the need for cumbersome and complex temperature control, thus uniquely providing the large operating temperature range needed for multiple space related applications. In terms of energy density, solid-state Li—S energy storage technology described herein is expected to exceed desirable parameters. For example, the projected energy density of some embodiments is 541 Wh/kg at the cell level (See Table B). Moreover, due to the garnet SSE materials lack of need for temperature control, as well as designs described herein that utilize the intrinsic garnet SSE strength, the projected energy density at the Pack level will be essentially the same, far exceeding desirable parameters. In addition, our unique design allows the Liₘₑₜₐₗ anode and S cathode to expand and contract inside the porous garnet scaffold during cell cycling, resulting in no volume change on the macroscopic battery scale. This provides not only exceptional cycling stability, but also a disruptive solution for space related applications where dimensional tolerances are critical.

In some embodiments, the following results are achieved: synthesis of highly conductive garnet SSEs; fabrication of trilayer porous/dense/porous SSE structures; modification of the SSE surface to negate interfacial impedance; infiltration of porous SSE layer with Liₘₑₜₐₗ-anode and ability to cycle Li repeatedly with no degradation or dendrite growth; infiltration of porous SSE layer with C and S-cathode; and demonstration of working solid-state Li—S battery.

### Example 17

### Improvement of Porous-Dense-Porous Trilayer Garnet Electrolyte

As shown conceptually in FIG. 40, trilayer SSE may be fabricated as both the electrolyte and mechanical support for the individual cells. Highly conductive garnet SSEs as a thin, dense (to avoid shorting the Li anode and S cathode) layer in the center with porous layers on both sides (See FIGS. 42(d), 44(a) and 45(a)) have been demonstrated.

Trilayer Fabrication Process—While numerous trilayer SSE structures have been made, a systematic investigation may improve the process and increase its reproducibility. For example, improvements may increase yield by decreasing trilayer from curling and cracking during sintering. This includes improving tape formulation and firing conditions of sintering ramp rate (1 to 10° C./min), firing time (10 min to 12 h) and gas ambient (Ar, O₂ and air), followed by structural (XRD, SEM, TEM, and FIB/SEM) and compositional analysis (XRD, ICP, EDS).

Porous Layer Structure—Each of the porous layers in the asymmetric trilayer SSE may have different parameters in terms of pore volume and thickness to balance Li/S capacity. Pore size and distribution may be adjusted to improve initial electrode filling as well as charge/discharge rate and mechanical strength.

Large Batch Processing—Reproducibility and quantity may be improved in each batch to ensure sufficient supply for full cell investigations and cell scale-up.

### Example 18

### Integration and Improvement of Sulfur Cathode

The uniform distribution of S, C, and garnet in the cathode contributes to high energy and power density, due to negligible ionic and electronic conductivity of S. S and C have been uniformly infiltrated within the porous layer using vapor and liquid methods (as shown in FIG. 45(a)-(d)). Further improvements may include:

Improved Solution Based S and C Co-Infiltration—The Li₂S₈ and PAN solution composition may be adjusted to to achieve balanced ionic and electronic conductivity in the porous garnet and high S loading. The porosity of the garnet SSE, and the relative amount of Li₂S₈ and PAN in the DMF solution may be adjusted to balance S loading, electronic/ionic conduction, and resident porosity. For example, it is desirable to balance S loading in the cathode to accommodate a large S volume change (79%) during discharge. The PAN carbonization temperature may also be adjusted to obtain a highly electronic-conductive infiltrated carbon, without reacting with the garnet during carbonization.

Improved Vapor-Based S and C Co-Infiltration—C may be infiltrated in the porous garnet SSE layers to obtain sufficient electronic conductivity. Then, the amount of infiltrated S as function of temperature, pressure, and duration may be determined to obtain improved C and S infiltration.

Evaluation of S and C Co-Infiltrated Cathodes—The ionic and electronic conductivity of S-C-infiltrated garnet SSE cathodes may be determined using EIS and blocking electrodes. The electrochemical performance of S-C-garnet cathodes may be evaluated in Li/garnet/S-C-garnet coin cells, and related to ionic/electronic conductivity, garnet pore structure, and S/C loading. The structure-performance relationships may be used to improve the S cathodes.

### Example 19

### Integration and Improvement of Li Metal Anode

In some embodiments, an interface layer may be used to effectively negate the Liₘₑₜₐₗ-garnet interfacial impedance (as shown in FIGS. 43(a)-(c) and 44(a), 44(b)). Improvements may include:

Conformal Coating of Nano-Carbon Inside Porous Garnet—The carbonization of PAN inside porous garnet process in terms of conductivity and structure/mesopore filling may be improved by adjusting ink concentration, drying time, and temperature.

Improvement of Al₂O₃ Layer—The effect of Al₂O₃ thickness may be determined using an ALD process. Al₂O₃layer deposition using sol-gel may be more scalable. For example, aluminum sulfate may be dissolved in isopropanol followed by immersion of garnet pellets in the above solution and vacuum infiltration. The wetted garnet pellets may then be dried at room temperature and sintered at 750° C. for 3 hours. The coating layer thickness may be controlled by the precursor solution concentration.

Improvement of Li Metal Filling of Porous Garnet—Li metal filling is a function of garnet SSE pore structure and Li infiltration conditions. Li metal foil may be applied under varying pressure as Al₂O₃ coated garnet SSE is heated up to 200° C. SEM, EIS and current cycling may be used to characterize the Li anodes.

### Example 20

### Assembly and Validation of Li—S Coin Cells

In some embodiments, full coin cells include garnet SSE, Liₘₑₜₐₗ-anode and S-cathode.

Assemble Full Cells—Starting with trilayer garnet, pores on one side may be filled with a S/C-cathode, and pores on the other side of the dense central layer may be filled with Liₘₑₜₐₗ-anode. Ti is electrochemically stable for both Li and S. So, Ti foil current collectors may be be attached on both Li anode and S/C cathode sides. To improve electrical contact between electrodes and current collectors, a thin compressible CNT-sponge layer may be applied.

Full Cell Testing—The electrochemical performance of the coin cell may be evaluated by cyclic voltammetry, galvanostatic charge-discharge at different rates, and cycling performance at C/10. EIS, from 1 MHz to 0.1 mHz, may be used determine any sources of device impedance, and reveal the interfacial impedance between the cathode and SSE by comparing the EIS of symmetrical cells with Liₘₑₜₐₗ electrodes. The energy density, power density, rate capability, and cycling performance of each cell may be characterized as a function of SSE, electrode, SSE-electrolyte interface, and current collector-electrode interface. The electrode-electrolyte interface, and its role in cell impedance and battery degradation, may be characterized using EIS, SEM, and TEM of dissembled cells to understand any degradation mechanisms. Electrochemical performance tests may be conducted in an environmental chamber with a temperature range of −10° C. to 30° C.

### Example 21

### Scale-Up to Full Format 10 cm×10 cm Cells

In some embodiments, working Li—S batteries are provided, using full format cells with an energy density of 540 Wh/g, and 80% retention of capacity after 200 cycles. Battery cells described herein may be scaled-up into full format (10 cm×10 cm) cells to achieve such results, as follows:

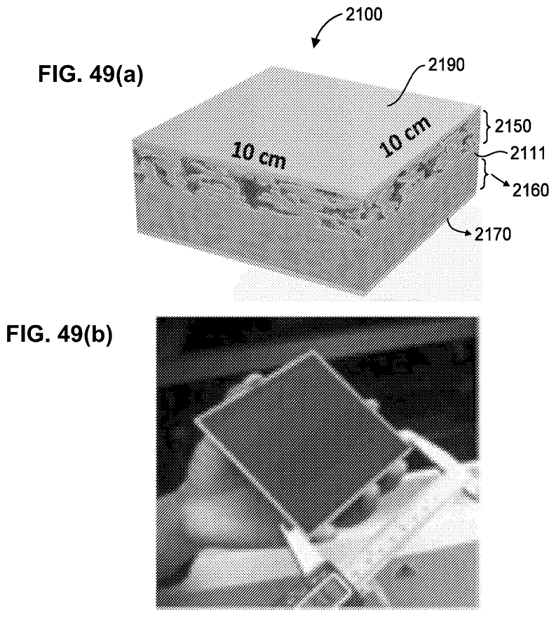

Fabricate 10 cm×10 cm Trilayer Garnet Cells—In some embodiments, scaled up the cells with dimensions of 10 cm×10 cm may be fabricated, as illustrated in FIG. 49(a). This SSE scaling up may involve improvement of and better quality control of tape casting, lamination, and sintering processes to improve yield by reducing cracking, curling and anisotropic shrinkage. For example, a green trilayer tape may be cut into 13 cm×13 cm squares, allowing 25% shrinkage in both dimensions. The cutout green tape may be pre-sintered to release stress and remove organic content, followed by high temperature sintering in a powder bed to achieve desire porous-dense-porous structure. To improve flatness, a porous alumina plate may be used to apply appropriate force on the trilayer plate while sintering. Desirable features that may be improved include the continuity of dense layer and the uniformity of the porous layer. One side of the sintered full format trilayer garnet may then be surface treated to achieve an ultrathin surface layer of Al₂O₃ inside the porous SSE scaffold.

FIG. 49(a) shows a schematic of 10 cm×10 cm Li—S cell 2100 with tri-layer Garnet. Cell 2100 includes a dense central layer 2111, a first electrode 2150, a second electrode 2160, a first current collector 2170, and a second current collector 2190. Dense central layer 2111, first electrode 2150, second electrode 2160, and first current collector 2170 are similar to dense central layer 911, first electrode 950, second electrode 960, first current collector 970, and third current collector 990 of FIG. 37.

Infiltration of S Cathode and Li Metal Anode—The vacuum and solution methods for S infiltration described herein may be scaled up. For the vacuum process, S infiltration can be done for 10 cm×10 cm garnet by simply increasing the tube size. The uniformity and amount of S infiltration may be evaluated after scaling up. After S infiltration, scaled up Li metal infiltration may be done by pressure contacting a 10 cm×10 cm size commercial Li foil on top of the anode side of the garnet trilayer and heating to 200° C.

Test Full Format Cells—After successfully integrating Liₘₑₜₐₗ-anode and S-cathode in the trilayer garnet, Ti current collectors may be applied to ensure good electric contact. Electrochemical performance may be evaluated at a rate of C/10 in an environmental chamber with a temperature range of −10° C. to 30° C.

### Example 22

### Development of Packaging and Bipolar Plates for Full Format Cells

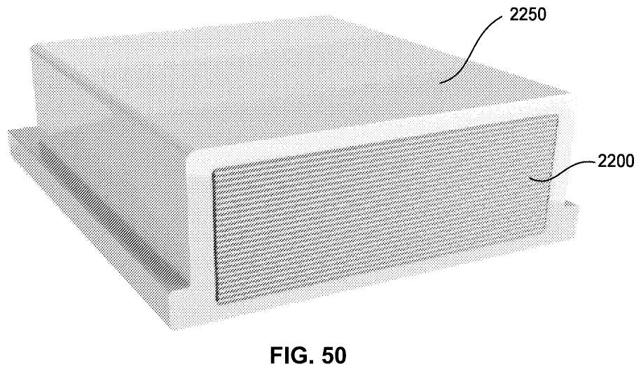

In some embodiments, packaging, bipolar plates and contacts may be used for stacking the cells in series. For example, commercial heat sealable pouch cells may be used. Or, custom 3D printed packaging may be used to pack the cells (see FIG. 50) with integrated hermetic sealing.

FIG. 50 shows a packaging design for stacked cells 2200 in series. Cells 2200 are enclosed by 3D printed integrated hermetic sealing packaging 2250.

In some embodiments, Ti foils with a thickness of 10 μm may be used as the bipolar plates, i.e. as current collector for both anodes and cathodes. The Ti tabs will extend out as outsides electrical leads. Due to intrinsic thermal stability of garnet in large range of temperatures, no thermal management is required for a garnet Li—S battery.

### Example 23

### Assembly and Testing of Full-Format Multi-Cell Stack

Stacking of 3 Cells (10 cm×10 cm)—In some embodiments, many cells may be stacked in series to form a battery pack. For example, a 28 V battery pack with a total weight of 100 Kg may be formed by stacking 3 full format (10 cm×10 cm) cells in series. FIG. 50 shows an exterior view of three flat full format cells assembled in series, with Ti bipolar plates, and sealed inside initially pouch cells and then the 3D printed plastic containers.

Test Stacked Cells (−10° C. to 30° C.)—Electrochemical characterization tests (as described above for coin cells) may be performed in an environmental chamber over −10° C. to 30° C. temperature range.

Thermal Expansion, Bipolar Plate and Contact Issues—Organic electrolyte systems may have a wide range of thermal challenges. For the Liₘₑₜₐₗ-anode and S-cathode in the trilayer garnet structures described herein, thermal challenges are more limited, and include expansion mismatches between cells, bipolar plates and packaging.

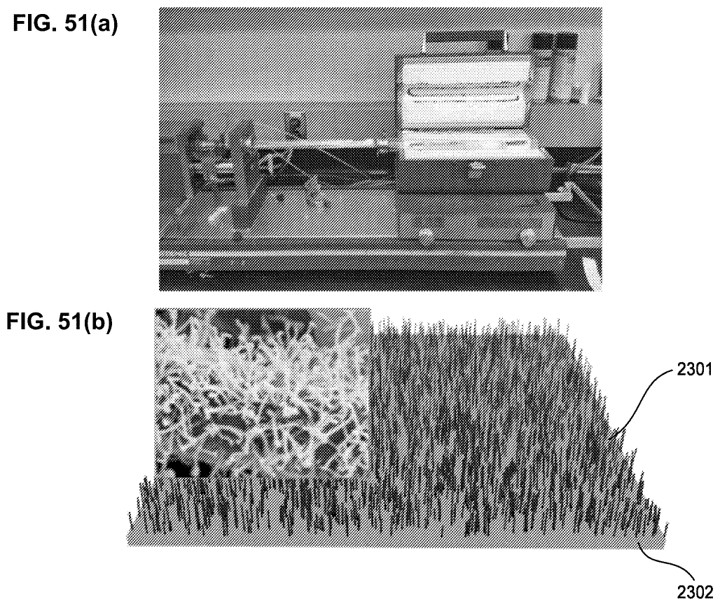

Thermal Related Issues—Dimensional change vs. temperature may be measured using a dilatometer (See FIG. 51(a)). EIS may be used to measure interface impedance during thermal fatigue tests with thermal expansion mismatch of the various layers.

Methods to Address Contact Issues—In some embodiments, interface problems between current collector and the Li-anode/S-cathode may be addressed in a variety of ways. For example, a fast, microwave method may be used to grow vertical carbon nanofibers on metal foil within a minute (See FIG. 51(b)). The vertical carbon nanofibers can function as a mechanical buffer, like a spring, to improve the interface and interface stability between metal and the electrode materials.

FIG. 51(b) shows carbon nanotube (CNT) growth on metal plate. Carbon nanotubes 2301 have grown on plate 2302.

Package a Full Format Multi-Cell Stack—2 full format multi-cell battery stacks have been successfully fabricated and packaged.

### Example 24

### Innovative Energy Storage that is Intrinsically Safe and High-Performance Garnet Electrolytes

To overcome issues related to liquid organic electrolytes, such as safety and degradation, numerous solid-state inorganic Li⁺ electrolytes, including perovskite Li_{0.36}La_{0.55}□_{0.09}TiO₃ (□=vacancy), layered Li₃N and Li-β-alumina, Li₁₄ZnGe₄O₁₆ (Lithium Super-ionic Conductors, (LISICON)), Li_{2.88}PO_{3.86}N_{0.14} (LiPON), Li₉AlSiO₈ and Li₁₀GeP₂S₁₂, are possibilities to replace liquid organic LIB electrolytes. However, each of these solid electrolytes has significant issues: Li₃N—Non-isotropic conductivity and stable only up to 0.44 Vat room temperature (RT). Li-β-alumina-Hygroscopic, difficult to prepare as pure phase, and non-isotropic conductivity Li₁₄ZnGe₄O₁₆—Moderate Li⁺ conductivity at RT, not chemically stable in ambient air and long-term stability in contact with Li anode is unknown. Li_{1.3}Ti_{1.7}Al_{0.3}P₃O₁₂-Unstable with Liₘₑₜₐₗ due to reduction of Ti⁴⁺ to Ti³⁺, resulting in electronic short circuit between anode and cathode, and exhibits large grain-boundary impedance. Li_{0.36}La_{0.55}□_{0.09}TiO₃—Bulk conductivity of ˜10⁻³ Scm⁻¹ but unstable with Liₘₑₜₐₗ undergoing reduction of Ti⁴⁺ to Ti³⁺ and has large grain-boundary impedance. Li_{2.88}PO_{3.86}N_{0.14} (LiPON)—Low ionic conductivity (10⁻⁶ S cm⁻¹), difficult to control chemical composition, and typically requires costly sputtering techniques to prepare. Li₉AlSiO₈—Stable in contact with Li but only moderate Li⁺ conductivity at RT. Li₁₀GeP₂S₁₂—High Li-ion conductivity, but the long-term chemical stability at high voltage cathodes (>5) and reproducibility of data are unknown.

Moreover, solid state Li-ion batteries (SSLiBs) incorporating these solid state electrolytes (SSEs) suffer from high interfacial impedance due to their low surface area, planar electrode/electrolyte interfaces.

### Example 25

### Disruptive Materials—Li-Stuffed Garnet SSEs

A group of materials usable for SSE is Li-Garnet-type metal oxides, such as Li₅La₃M₂O₁₂ (M=Nb, Ta). The conductivity of these SSEs has been greatly improved by us and other groups through judicious doping to increase the Li content (“stuffing”) of the Garnet structure. These Li-stuffed Garnets exhibit promising physical and chemical properties for SSEs including:The highest known RT bulk conductivity (for example, about 10⁻³ S/cm for cubic Li₇La₃Zr₂O₁₂). Highly electrochemical stability for high voltage cathodes (up to 6 V), about 2 V higher than current liquid organic electrolytes and about 1 V higher than the most desirable LiPON. Excellent chemical stability in contact with elemental and molten Li anodes up to 400° C., unlike NASICON-type LiTi₂P₃O₁₂ and perovskite-type La_{(2/3)-x}Li₃ₓ□_{(1/3)-2x}TiO₃Li⁺ transference number is close to 1.00, which is critical to battery cycle efficiency, while typical liquid and polymer electrolytes are only about 0.35Wide operating temperature capability, electrical conductivity increases with increasing temperature reaching 0.1 Scm⁻¹ at 300° C., and maintains appreciable conductivity below 0° C. In contrast, polymer electrolytes are flammable at a high temperature. Synthesizable by simple mixed oxide powders and annealing in air, hence is easy to scale up for mass production at a low-cost.

However, challenges exist in Garnet based electrolytes, which has previously limited the success of Garnet electrolytes. These challenges include:
(1) High interfacial resistance between electrode particle-electrolyte particle, between electrode particles, and between electrolyte particles;
(2) Poor structure interface integrity during cycling as Garnet SSEs are typically fragile;
(3) High temperature processing that is not compatible with most anode and cathode materials.

### Example 26

### Li—S Design Based on Novel Garnet Electrolyte

In some embodiments, a Li—S battery configuration includes Garnet electrolytes, as shown in FIG. 37. Such a 3D Li—S batteries may be based on a tri-layer Garnet structure with the following attributes:
(1) The cell is fabricated from a Garnet triple-layer structure, with a supported thin-film (about 10 μm) dense SSE layer in the middle, a thicker (about 35 μm) porous scaffold support layer on the cathode side, and a thicker (about 50 μm) porous scaffold support layer on the anode side.
(2) The Garnet electrolyte has an ionic conductivity of about 10⁻³ S/cm.
(3) Li metal fills the porous anode scaffold layer and S fills the porous cathode scaffold layer.
(4) Highly conductive, porous carbon nanotubes/fibers are incorporated in the two outer layers of Garnet scaffold through solution coating or microwave growth to improve electron transport.
(5) Garnet electrolytes are fabricated with low-cost tape casting methods usable, for example, for solid oxide fuel cell (SOFC) production.
(6) The highly porous Garnet electrolyte scaffolds provide large electrolyte-electrode interfaces that will decrease the interface impedance.
(7) Interface impedances between S and Garnet electrolyte, and between Li anode and Garnet electrode are minimized by interface engineering methods to achieve ˜1-10 Ohm/cm².
(8) During lithium charging and discharging processes, the Garnet scaffold maintains its structural integrity during charging and discharging.
(9) The expected voltage of the full cell is 2V, and the targeted energy density is 600 Wh/kg at a C rate of C/10.

The first demonstration of all-solid-state Li—S batteries with Garnet electrolytes is described herein. While there are many challenges as seen in other solid-state battery chemistries, in some embodiments porous Garnet and Li—Li₂MnFe₃O₈ chemistry overcome such challenges. Table B shows the dimensions and thickness of the layers of some embodiments.

### Example 27

### Relevance to Space Flight System and Strong Infusion Potential

Energy storage technology based on solid-state Li—S chemistry is well-suited for, inter alia, robotic science and human exploration of space. As shown in Table B, the theoretical energy density is 1212 Wh/kg. Current efforts are directed to demonstrating a working full cell with an energy density of 600 Wh/kg, which exceeds the energy density needed for some space exploration efforts. Solid state storage will be desirable for multiple mission applications associated with both robotic science and human exploration of space. Garnet electrolytes are highly conductive across a wide temperature range, and solid-state batteries should operate over a wide temperature range as well.

During device operation, Li metal anode and S cathode expands and contracts inside the carbon nanofibers (CNFs) filled Garnet scaffold, with the CNFs and Garnet scaffold maintaining electronic and ionic conduction, while the space in the carbon-Garnet scaffold accommodates the respective volume changes. This process results in no volume change on the macroscopic battery scale, thus an excellent cycling stability is expected.

### Example 28

### Overall Strategy and Approaches

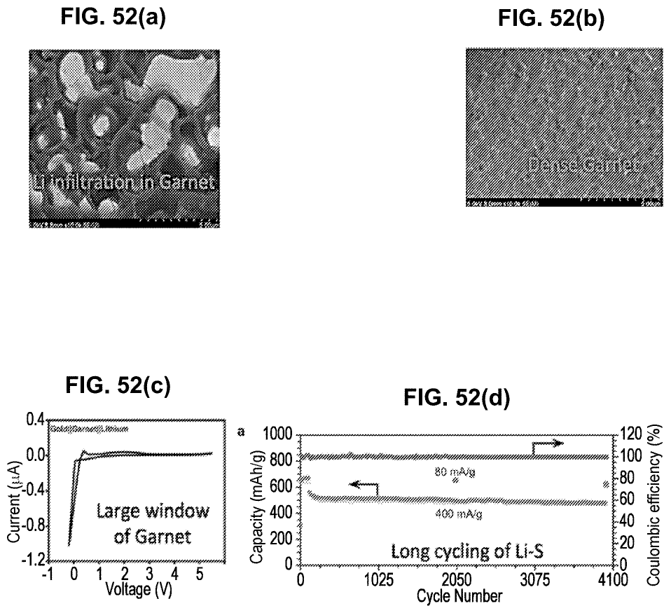

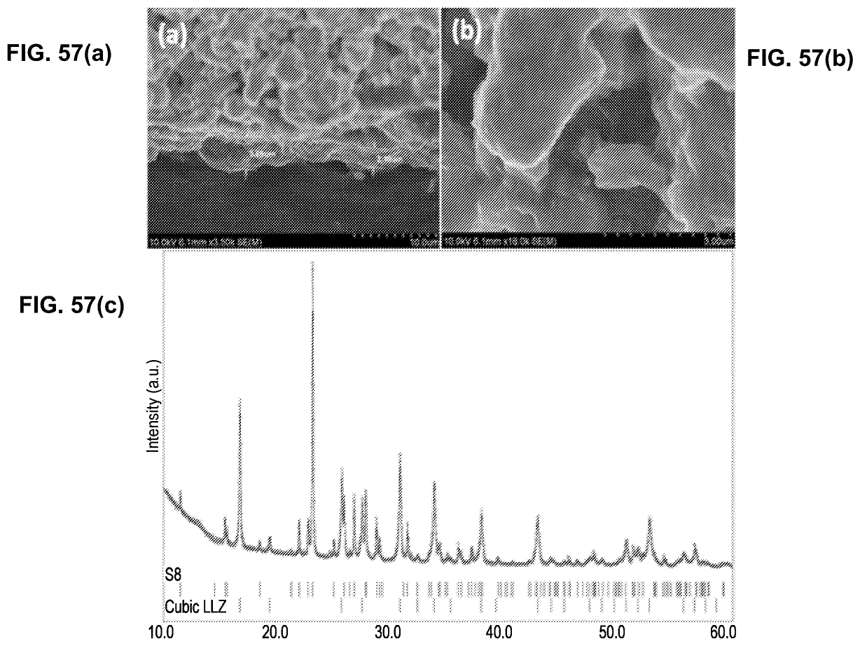

In some embodiments, synthesis of pore-dense-pore triple layer Garnet SSEs using scalable tape casting methods may be used. In some embodiments, a Li/Garnet/S structure is used. Li/Garnet/S has much higher energy density than Li/Garnet/Li₂MnFe₃O₈. In some embodiments, a S cathode is used. Sulfur infiltration, interface engineering and electrochemical performance evaluation are desirable aspects of such a S cathode. Short-chain S₂/C composite cathodes may be used to completely avoid the shuttle reaction of liquid organic electrolytes, thus achieving high Coulombic efficiency and long cycling stability. This unique S cathode delivers 600 mAh/g capacity for 4020 cycles (0.0014% loss per cycle) in liquid carbonate electrolyte, with 100% Coulombic efficiency and the absence of self-discharge. Based on the success in liquid electrolyte Li—S cell, this S₂/C technology may be transferred to all-solid-state Li—S batteries by infusing S₂ gas into the CNF filled porous garnet layer in vacuum at 600° C. Experiments demonstrate that Garnet does not react with S even at 600° C. in vacuum as evidenced by XRD measurement (See FIG. 57C). In some embodiments, a Li anode is used. Li anode fabrication, full cell integration and performance evaluations are desirable aspects of such Li anode use. Lithium has been infiltrated into Garnet electrolytes. Either or both of solution based and microwave methods may be used to conformally coat porous Garnet with conductive carbon. Conformal coating of carbon nanotube and graphene inside porous Garnet electrolyte has already been demonstrated. FIG. 52(a)-(d) shows experimental results relating to Garnet electrolytes with C/S cathodes.

### Example 29

### Dense-Porous Triple Layer Garnet Electrolyte

As shown in FIG. 37, in some embodiments, a triple-layer Garnet electrolyte may be fabricated as both the separator and mechanical support for the individual cells. Highly conductive Garnet electrolytes may be formed as a thin, dense layer in the center with porous layers on both sides. The dense layer has negligible porosity to avoid shorting the Li anode and S cathode. In some embodiments, one porous layer will have a porosity of 70% to be filled with Li metal anode, and the other porous layer will have a porosity of 70% to be filled with S cathode. The porous structure will increase the surface area and decrease the interfacial and charge transport impedances.

### Example 30

Various compositions of lithium conductive garnets have been investigated. Preferred compositions include: Li₇La₃Zr₃O₁₂ (LLZ) and Li₇La_{2,75}Ca_{0.25}Zr_{1.75}Nb_{0.25}O₁₂ (LLCZN). LLZ has a higher conductivity, close to 10⁻³ Scm⁻¹ when sintered at temperature around 1200° C. However, lithium loss during high sintering temperature can be an issue when densifying the structure. By using nanosized LLZ particles, high density at lower temperature. In comparison, LLCZN shows lithium ion conductivity half of that of LLZ (4*10⁻⁴Scm⁻¹). The advantage of LLCZN is a lower sintering temperature of 1050° C., which will reduce lithium loss making it easier to fabricate the triple-layer structure.

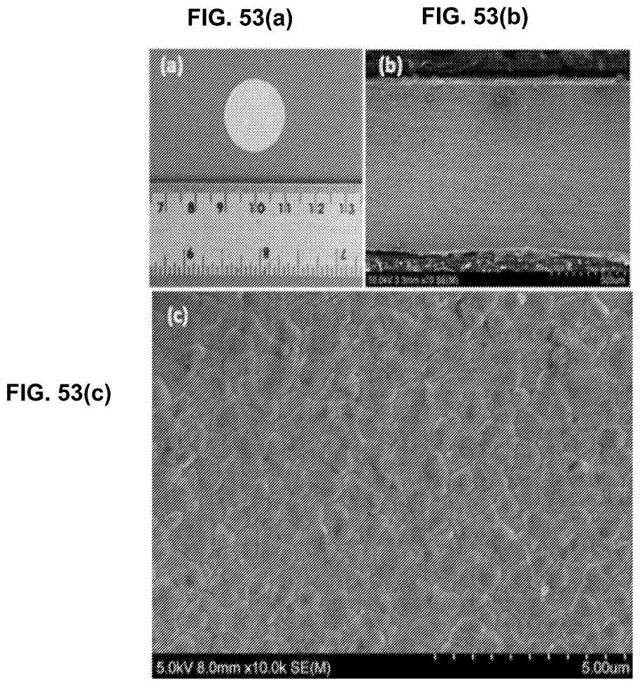

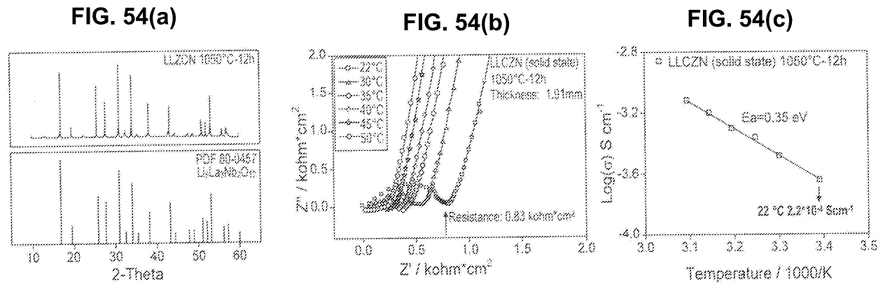

Fabrication of Dense Layer In some embodiments, garnet powders are prepared by solid state reaction and sol-gel methods. FIGS. 53(a) and 53(b) show an LLCZN garnet pellet sintered at 1050° C. for 12h. The garnet has a dense microstructure with few isolated closed pores (See FIG. 53(c)), which makes it possible to fabricate thin and dense electrolytes on porous support layers.

The synthesized LLCZN dense electrolyte layer shows the cubic garnet phase and a wide electrochemical window up to 5.5 Volt as illustrated in FIG. 52(c). The impedance of the electrolyte was measured from room temperature to 50° C. The conductivity was 2.2 Scm⁻¹ at room temperature with activation energy of 0.35 eV. Colloidal deposition methods may be used to fabricate dense electrolyte layers on the porous scaffold support layer. The slurry may be made with fully-calcined LLZ or LLCZN powders, Solsperse dispersant, PVB, and BBP in toluene and ethanol. This slurry is milled for at least one week before use to fully mill and disperse the garnet. The milled slurry may then be drop-cast onto a porous scaffold and sintered at the appropriate temperature for one hour. The LLCZN dense electrolyte layers produced had a thickness of 40 um thick. A preferred range is 10-20 um. Further dilutions of the slurry should produce pore free films within this preferred range.

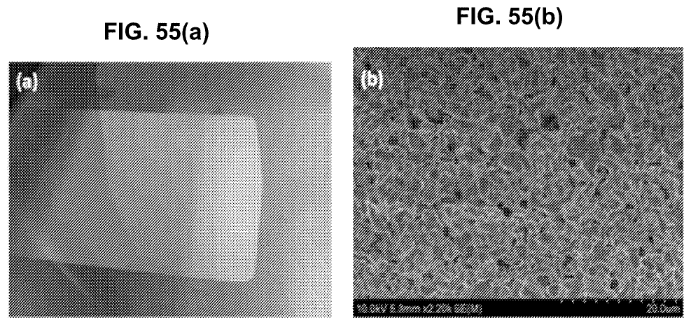

Fabrication of Porous Layers Porous garnet anode supports for 1 inch diameter button cells may be fabricated using technologies available for the synthesis of SOFC's. Such supports may be scaled up to 10 cm×10 cm. Relevant parameters include slurry composition, tape casting procedures, and sintering conditions. Tape slurries of SOFC materials generally begin with well-milled materials in their desired phase. For this reason, fully calcined LLZ was used as a starting material. This starting material was added with fish oil as a dispersant to toluene & ethanol. Polyvinyl butyral (PVB) and butyl benzyl phthalate (BBP) were added as binder and plasticizer and allowed to mill overnight. Varying the amount of binder and solvent in relation to the amount of garnet ultimately led to the desired rheology. To eliminate bubbles, tape slurries were degassed by stirring in a vacuum chamber for two hours immediately prior to casting. The slurry was poured into a holding chamber with a 330 um slot through which the slurry was pulled on a mylar sheet. After casting, the tape was dried on a 120° C. bed for one hour. FIG. 55(a) shows a finished Garnet tape, which is appropriately flexible and free of bubbles.

The microstructure of a porous LLCZN support layer is shown in FIG. 55(b). The porosity in the structure was induced by burning off PMMA pore formers at elevated temperature. PMMA was confirmed to be an appropriate pore former because of its uniform particle distribution. Porosity and microstructure of the LLCZN supporting layer can be easily controlled by varying the diameter and amount of PMMA, and also the heating treatment. Sections of tape were cut for sintering and placed between two porous alumina plates. A study of firing times and temperatures determined a one hour hold time at 1175° C. produces strong, porous tapes as seen in FIG. 55(a) and FIG. 55(b). This microstructure is well suited to infiltration for cathodes and anodes.

Scalable Fabrication of Garnet Triple Layers In some embodiments, finished porous and dense tapes may be laminated together to form the desired porous-dense-porous triple layer and then co-sintered. The porous layers may be formed from thicker tapes with pore former. The dense center layer may be formed from a very thin tape without pore former. These layers may be pressed, for example, at 160° C. and 50 MPa for ten minutes. Shrinkage during sintering occurs at a similar rate for all layers because they are all formed from the same garnet material. After sintering, the trilayer has the desired microstructure and is ready for anode and cathode infiltration.

Tape casting and laminating are inexpensive and scalable industrial processes. Even on a lab scale, tapes are commonly two meters long, allowing for the creation of an entire 28V stack of 10 cm×10 cm cells with one tape of each layer. On an industrial level, flexible tapes enable roll-to-roll processing which could theoretically produce a continuous line of tape. Individual cells may then be punched from the tape before sintering.

### Example 31

### Integration of S Cathode into Porous Garnet as Cathode

Methods In some embodiments, S may be filled into Garnet pores. Suitable methods include S gas vacuum infusion at 600° C., and liquid S-CS2 penetration at room temperature. Due to the low electronic and ionic conductivity of S and sulfides, a highly electronic conductive CNF-web (carbon nano-fiber web) will be formed in the pores of the highly ionically conductive Garnet scaffold before S infusion to enhance the utilization of S and reaction kinetics. Due to the large volume change (˜80%), it is preferred to fill the S-C composite to only about 50% by volume of the porous Garnet on the cathode side to accommodate the volume change upon charging.

Methods and Data

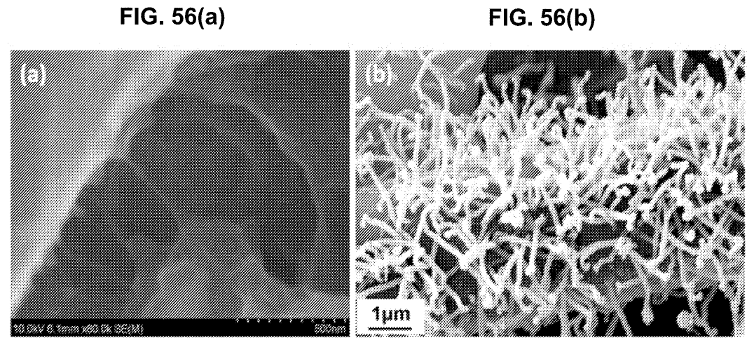

Conformal Nanocarbon Coating in the Cathode and Anode Pores: In some embodiments, a porous, conformal conductive coating is formed on porous Garnet. Suitable methods include use of solution based carbon nanotube, and use of graphene. Since the pore size of Garnet electrolyte is larger than the size of short carbon nanotube (CNTs) or graphene flakes, CNTs and graphene solution can easily penetrate into the pore of garnet scaffold layer. CNTs have been successfully filled into a garnet scaffold layer. In some embodiments, a microwave synthesis method may be used to grow CNF, which is cheaper than CNT and graphene, inside pores of Garnet electrolyte before filling S cathode and Li metal anode. FIG. 56(b) shows conductive nanofibers grown by a microwave method. This microwave approach has high carbonization efficiency and targeted heating capability, providing a facile and ultrafast technique to obtain three dimensional nanomaterial growth on various engineering material substrates. It only takes 15-30 sec to grow CNF on top of a wide selection of substrate surfaces. The process can be performed within a conventional microwave oven, at room temperature and ambient conditions, without the any inert gas protection or high vacuum. Multi-component and multi-dimensional nanomaterials synthesized by this approach are good candidates for energy and electrochemical applications.

Sulfur Cathode in Porous Garnet: In some embodiments, S may be infiltrated into porous Garnet that was previously filled with CNF or nanotubes. Suitable S infiltration methods include vacuum and solution methods.

One suitable way to infuse S gas under vacuum uses a sealed vacuum glass tube technique. Sulfur powder and the garnet scaffold are added into a one-end sealed glass tube. The resulting glass tube is evacuated with a vacuum pump over a 6 h period. The vacuumed glass tube is then sealed by melting the open-end with a high temperature flame. The sealed glass tube is transferred to an oven for annealing at 600° C. for 3 h, and then cooled to room temperature. Afterwards the sulfur is infiltrated into the Garnet pores, and the sealed glass tube is opened. This method has been used to successfully infiltrate S into porous CNT-Garnet, as shown in FIGS. 57A and 57B. XRD after vacuum filtration of S inside carbon-coated porous Garnet has been performed. The XRD results show that Garnet SSE maintains its cubic structure with a high ionic conductivity. See FIG. 57C. And, the XRD results show confirm the successful infiltration of S in Garnet, and that no reaction happens between S and Garnet electrolyte.

One suitable way to infuse liquid S involves dissolving S into CS2 to form a solution. The S-CS2 solution may be dip impregnated into the pores of Garnet scaffold at room temperature, followed by CS2 evaporation. The S loading can be manipulated by multiple dip impregnations. The formed sulfur integrated porous garnet is then ready for battery tests. The porous anode side of the triple-layer Garnet electrolyte may be sealed during these processes.

In some embodiments, the cathode may be evaluated using a gel electrolyte on the anode side to minimize anode interfacial impedance. The inventors have recently successfully demonstrated that a gel-electrolyte can effectively decrease the impedance resistance of Li metal anodes in Garnet based batteries. In some embodiments, a full cell may be fabricated that uses S/carbon filled porous garnet as cathode, dense Garnet as the electrolyte and Li metal as the anode. These cells may be used to evaluate interfacial impedance between S cathode and Garnet electrolyte, and the electron transport with CNFs fabricated with different microwave conditions, S loading, and thermal treatment. It is expected that the impedance between electrode and electrolyte will decrease after initial conditioning.

### Example 32

### Li-infiltration into Porous Garnet Anode

In some embodiments, Li-metal may be used as a high capacity anode in a high energy density battery. The Li anode may be filled inside the porous Garnet with minimized interfacial impedance. A thin layer of conductive carbon such as CNFs may be conformally coated on porous Garnet electrolyte. Relevant parameters include infiltration temperatures, and surface modifications before Li filling to the pores of the anode side of triple-layer Garnet electrolyte.

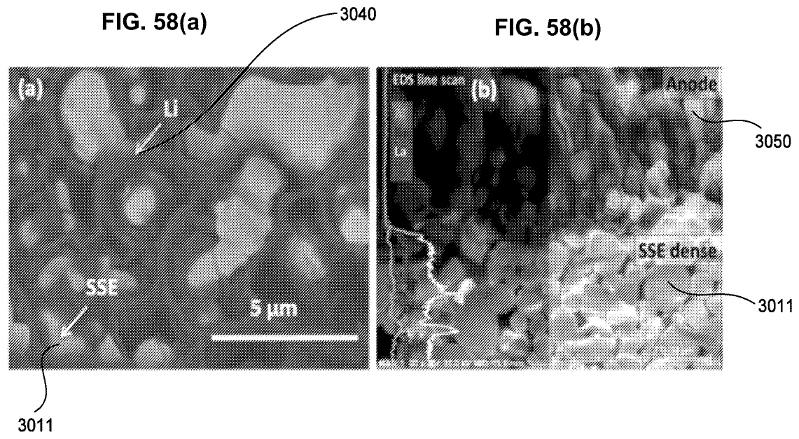

Infiltration of Li in Porous Garnet In some embodiments, a conformal coating of lithium is infiltrated into a porous CNT (or CNF) filled Garnet scaffold to fabricate of a Li—S battery. The CNTs in the garnet pores is to maintain the electronic pathway (conduction) even when the Li is consumed during deep discharge, thus enhancing Li utilization. A major challenge of solid state batteries is the interfacial resistance between electrodes and electrolyte. It is desirable that melted lithium not only fully penetrate each pore, but remain in contact with the garnet surface and CNTs after cooling. The low surface energy of ceramics presents a difficulty. When lithium was melted onto a 70% porosity pellet in an argon atmosphere, the lithium formed a bead and did not penetrate. There are, however, some strategies that can be employed to increase lithium infiltration. For example, heating the Garnet scaffold in an argon atmosphere for an extended period of time before applying the lithium has been demonstrated to enable the lithium to quickly penetrate the porous scaffold. And, good contact was maintained after cooling. See FIGS. 58(a) and 58(b).

FIG. 58(a) shows an SEM image of lithium-infiltrated lithium garnet scaffold showing an anode material 3040 (dark), in this case metallic lithium, conformally coating a first porous electrolyte material 3011, made of Garnet (light).

FIG. 58(b) shows a cross section at Li-metal-dense SSE interface. The image shows a dense central layer 3011 and a porous first electrode 950. The images show that excellent Li wetting of the SSE was obtained in first electrode 950.

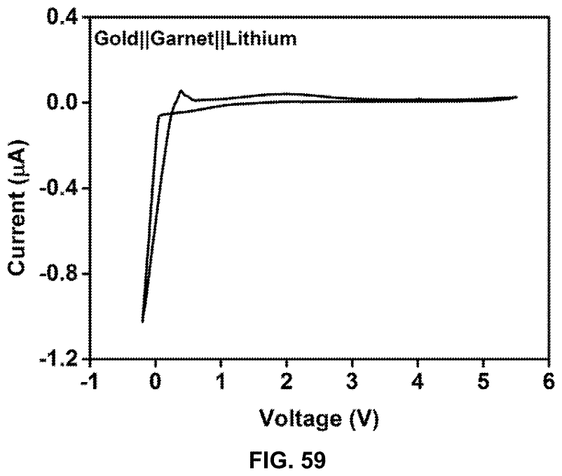

Characterizations Characterization of the Li—Garnet interface assists in understanding the stability of Garnet electrolyte against Li metal, and the contributors to interfacial impedance at the anode. Impedance may be measured with varying scaffold porosities to estimate interfacial impedance per real surface area. Interface surface engineering methods such as various ALD materials (e.g., Al₂O₃) and thickness may be evaluated to decrease interface resistance. CV may be used to evaluate the electrochemical stability of Garnet electrolyte when contacting with Li metal anode. Measured results indicate that Li metal is very stable with Garnet up to 5.5 V. See FIG. 59.

### Example 33

### Full Cell Assembly and Evaluations

In some embodiments, full cells are fabricated and evaluated. Contact resistance between current collectors and the electrode materials may be minimized. Mechanical properties may be improved to ensure high mechanical device strength. The interface between the SSE and the electrode may be improved to achieve stable cycling performance. Energy density, power density, rate performance, cycling, degradation performance, etc. of lab scale solid state batteries may be determined through electrochemical measurements. In some embodiments, working Li—S batteries have 10 cm by 10 cm dimensions and an energy density of 600 Wh/g, and 80% retention of capacity after 200 cycles.

Full Cell Assembly In some embodiments, a triple-layer Garnet is used as a membrane. S cathode is vacuum filled on one side, followed by Li metal on the other side. After successfully filling the scaffold pores with Li anode and S cathode in the lab scale, Ti foil coated with 20 nm Cu may be used for the current collectors and bipolar plate. These plates may be assembled in a battery stack to achieve high voltage. To improve the electrical contact between electrodes and current collectors, a thin graphene layer may be applied. For example, low-cost graphene ink may be used. The finished device may be heated up to 100° C. for 10 minutes to further improve the electrical contact between layers.

Full Cell Testing In some embodiments, the electrochemical performance of the SSLiB may be evaluated by cyclic voltammetry, galvanostatic charge-discharge at different rates, electrochemical impedance spectroscopy (EIS), and cycling performance at C/3. EIS in a broad frequency range, from 1 MHz to 0.1 mHz, may be used to investigate the various contributions to the device impedance, and reveal the interfacial impedance between the cathode and SSE by comparing the EIS of symmetrical cells with Liₘₑₜₐₗ electrodes. The energy density, power density, rate dependence, and cycling performance of each cell may be fully characterized as a function of SSE, electrode, SSE-electrolyte interface, and current collector-electrode interface. Structure-process-property relationships may be analyzed and improved to achieve the best performance SSLiBs. The electrode-electrolyte interface and its role in cell impedance and battery degradation may be characterized using EIS, SEM, and TEM of dissembled cells to better understand any degradation mechanisms.

Battery Stack: In some embodiments, a battery stack is made using 10 cm by 10 cm cells. For example, 14 cells may be stacked in series as a stack to achieve 28 V. See FIG. 47(a). A 10 cm by 10 cm pile may then be fabricated with 160 individual cells as shown in FIG. 47(c). 9 piles may be used to achieve a total energy of 119 kWh, and a total mass of 100.27 kg. See FIG. 47 (d).

FIG. 47(a) shows the structure of a 28 V stack 1900 having 14 cells 1902 in series with titanium bipolar layers 1904 between cells. Stack 1900 has a length of 10 cm, a width of 10 cm, and a thickness of 3 mm.

47. 19(b) shows 3 stacks 1900 stacked to form a pile 1910. Pile 1910 includes tabs 1912 for electrical contact. Pile 1910 also includes 10 micron thick LDPE layers 1914 for electronic separation and padding between stacks 1900.

FIG. 47(c) shows a pile 1920. Pile 1920 is similar to pile 1910, but includes 159 stacks 1900, with a total thickness of 47 cm. Pile 920 weighs 11.1 kg, can provide 6.56 kWh (kilowatt hours) of energy, and has a volume of 4.7 L. Pile 1920 includes a spring cell 1922 to keep cells in contact and allow for thermal expansion. Pile 1920 also includes rails 1924 that are in contact with tabs 1912. Lips 1908 on LDPE layer 1914 ensure that collectors from adjacent cells do not touch.

FIG. 47(d) shows a battery device 1930. Battery device 1930 includes 9 piles 1920. Tabs 1924 from each of the 9 piles are visible. Battery device 1930 weighs 100 kg, can provide 119 kWh of energy, and has dimensions of 30 cm×30 cm×47 cm.

Table A shows one set of parameters for a battery cell similar to battery cell 1902. Table B shows a set of parameters a battery device 1930 made up of the cells of Table A. Table C shows another set of parameters for a battery cell similar to battery cell 1902. Table D shows a set of parameters a battery device 1930 made up of the cells of Table C.

TABLE A
Performance Metrics
10 cm × 10 cm Cell

| | | |
|---|---|---|
| Voltage | 2.1 | V |
| Energy | 1313 | mAh |
| Energy density | | |
| (Mass) | 541 | Wh/kg |
| (Volume) | 1304 | Wh/L |

Stack

| Design voltage | 28 | V |
|---|---|---|
| 3 Cells required | 14 | |
| Thickness | 3.0 | mm |
| Actual voltage | 29.4 | V |
| Energy | 38.6 | Wh |

Pile

| Design mass | 11.1 | kg |
|---|---|---|
| # Stacks required | 153 | |
| Thickness | 45.8 | cm |
| Energy | 5.9 | kWh |
| Volume | 4.6 | L |

Device (9 Pile)

| | | |
|---|---|---|
| Design mass | 100 | kg |
| Energy | 53.1 | kWh |
| Volume | 41.1 | L |
| Energy density | 530 | Wh/kg |
| (Mass) | 120- | Wh/L |

TABLE B

| | | | | | | Specific | |
|---|---|---|---|---|---|---|---|
| | | Volume | Volume | Density | Mass | Capacity | Capacity |
| | Material | ratio | (cm3) | (g/cm3) | (g) | (mAh/g) | (mAh) |
| Cathode | Garnet | 30% | 0.300 | 4.97 | 1.491 | 0 | 0.0 |
| 100 um | Sulfur | 40% | 0.400 | 1.96 | 0.784 | 1,675 | 1,313.2 |
| | CNT | 10% | 0.100 | 1.7 | 0.170 | 0 | 0.0 |
| | Empty | 20% | 0.200 | 0 | 0.00 | 0 | 0.0 |
| Electrolyte | Garnet | 100% | 0.100 | 4.97 | 0.497 | 0 | 0.0 |
| 10 um | | | | | | | |
| Anode | Garnet | 30% | 0.274 | 4.97 | 1.363 | 0 | 0.0 |
| 91.4 um | Lithium | 70% | 0.640 | 0.54 | 0.346 | 3,800 | 1,313.2 |
| | Empty | 0% | 0.000 | 0 | 0.000 | 0 | 0.0 |
| Current collector | Titanium | 100% | 0.100 | 4.43 | 0.443 | 0 | 0.0 |
| 10 um | | | | | | | |
| | | Totals: | 2.114 | | 5.09 | | 1,313.2 |

| | | |
|---|---|---|
| Energy | 541.4 | Wh/kg |
| Density | 1,304.4 | W/L |

TABLE C
Stack

| Design voltage | 28 | V |
|---|---|---|
| # cells required | 14 | |
| Actual voltage | 29.4 | V |
| Mass | 68.24 | g |
| Volume | 29.26 | cm3 |
| Thickness | 0.2926 | cm |
| Energy | 82.7513568 | Wh |

10 cm × 10 cm Pile

| Energy desired | 13.22 | kWh |
|---|---|---|
| Battery stacks needed | 160 | |
| LDPE thickness | 0.01 | mm |
| LDPE density | 2.2 | g/gm\hat{ }3 |
| Cu thickness | 0.01 | mm |
| Cu density | 8.96 | g/cm\hat{ }3 |
| Al thickness | 0.01 | mm |
| Al density | 2.7 | g/cm\hat{ }3 |
| Pile thickness | 47.3 | cm |
| Pile mass | 11.14 | kg |
| Pile volume | 4.73 | L |

30 cm × 30 cm × 4.3 cm Device

| Design energy | 119 | kWh |
|---|---|---|
| Piles used | 9 | |
| Total battery mass | 100.27 | kg |
| Total battery volume | 42.57 | L |
| | 600 | |
| Device energy density | Wh/kg | |
| Device energy density | 2795.63 | Wh/L |

TABLE D

| | | | | | | Specific | |
|---|---|---|---|---|---|---|---|
| | | Volume | Volume | Density | Mass | Capacity | Capacity |
| | Material | ratio | (cm3) | (g/cm3) | (g) | (mAh/g) | (mAh) |
| Cathode | Garnet | 30% | 0.300 | 4.97 | 1.49 | 0 | 0.0 |
| 100 um | Sulfur | 40% | 0.400 | 2.1 | 0.84 | 1,675 | 1,407.0 |
| | CNT | 10% | 0.100 | 1.7 | 0.17 | 0 | 0.0 |
| | Empty | 20% | 0.200 | 0 | 0.00 | 0 | 0.0 |
| Electrolyte | Garnet | 100% | 0.100 | 4.97 | 0.50 | 0 | 0.0 |
| 10 um | | | | | | | |
| Anode | Garnet | 30% | 0.294 | 4.97 | 1.46 | 0 | 0.0 |
| 98 um | Lithium | 70% | 0.686 | 0.54 | 0.37 | 3,800 | 1,407.7 |
| | Empty | 0% | 0.000 | 0 | 0.000 | 0 | 0.0 |
| Current collector | Titanium | 100% | 0.010 | 4.5 | 0.05 | 0 | 0.0 |
| 1 um | | | | | | | |
| | | Totals: | 2.090 | | 4.87 | | 1,407.0 |

| | | |
|---|---|---|
| Energy | 606.1 | Wh/kg |
| Density | 1,413.7 | W/L |

### Example 34

### Interfacial Resistance

One issue is large interfacial resistance between electrodes and Garnet electrolytes. Various interface-engineering methods such as atomic layer deposition (ALD) or gel electrolytes may be used to improve the charge transport between the interfaces and improve the mechanical integrity during battery charging/discharging processes.

### Example 35

### Integration of S and C into Porous Garnet for Cathode

A two step method was developed to co-integrate Sulfur and Carbon into one porous layer of porous-dense-porous triple-layer garnet electrolyte. The method may also be used to co-integrate Sulfur and Carbon into a porous layer of any garnet electrolyte, for example a garnet electrolyte having only one porous layer into which Sulfur and Carbon are integrated, and a non-porous interface with the anode.

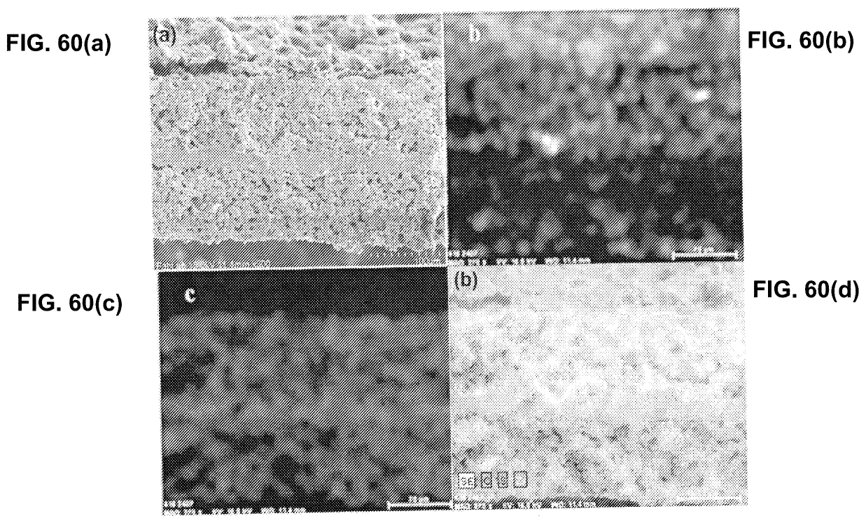

PAN (polyacrylonitrile) in DMF as the source of carbon was prepared, infiltrated into the porous-dense-porous triple layer porous garnet electrolyte and carbonized at 600° C.; for 1 hour. Sulfur was then successfully infiltrated into the triple layer porous garnet electrolyte at 250° C.; for 1 hour in argon atmosphere furnace. According to elemental mappings, sulfur and carbon were uniformly distributed in the cathode side of porous garnet electrolyte, shown in FIG. 60 (a)-(d). The main work during this step was focused on fabrication of lithium-sulfur garnet electrolyte cell, testing the electrochemical performance of Li—S garnet cell, and examination of the interfacial behaviors between the sulfur and garnet electrolyte.

### Example 36

### Assembling Coin Cell and Testing the Electrochemical Performance of Li—S Garnet Electrolyte Battery

A sulfur-cathode and lithium-anode garnet electrolyte battery was fabricated, and assembled in a coin cell with carbon sponge for deformable contact. The electrochemical performance was tested in an Arbin instrument at a current density of 50 uA/cm². The procedure for assembling the coin cell was the following:

Step 1, Cathode fabrication: Carbon was infiltrated to improve electrical conductivity of cathode. 10% PAN with concentration of 10% in weight was dissolved in DMF solution, stirring overnight in glove box, then coated onto cathode side of the triple-layer porous garnet electrolyte several times with a paint brush, keeping in vacuum after coating each time. The PAN/DMF coated garnet sample was heated up to 600° C. with 2-5° C./min rate, and annealed for 1-2 hours in argon-filled glove box for carbonization. Sulfur/carbon disulfide (S/CS₂) solution with a concentration of 1 mol/L was prepared for the sulfur infiltration, stirring for 1-2 hours. The solution was dropped onto the carbonized porous garnet electrolyte sample, followed by drying in vacuum for 1-2 hours.

Step 2, Anode fabrication: Lithium foil was attached to the anode side of the triple layer garnet electrolyte and covered with a stainless steel disk. The sample was heated at 150° C. for 10-30 minutes, then heated at 300° C. for 10-30 minutes in an Argon-filled glovebox for lithium penetration into the porous anode garnet layer.

Step 3, Assembling coin cell: the triple layer garnet electrolyte with sulfur-carbon cathode and lithium anode was packaged in a coin cell. Carbon sponges were attached to the cathode for better electrical contact and to protect the garnet electrolyte from mechanical pressure. The coin cell was then sealed in argon-filled glove box using Epoxy Adhesive (AB Glue) for isolation from air.

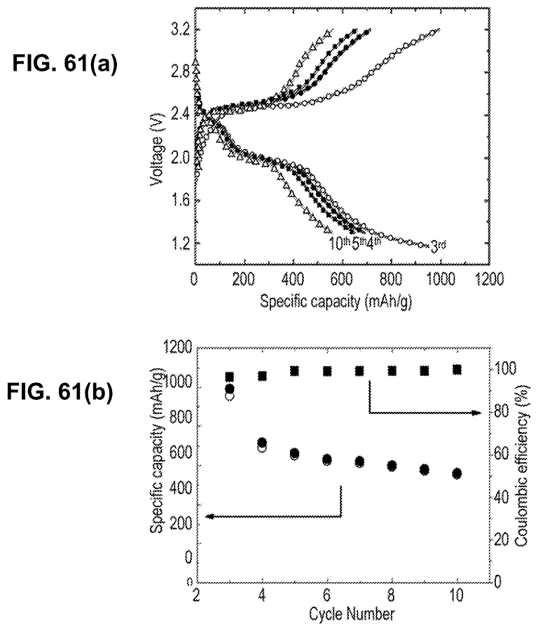

In this cell, the mass density of sulfur loaded into the cathode side of the triple layer garnet was 0.5 mg/cm², the mass density of carbon infiltrated was 0.5 mg/cm², lithium foil was 15 mg, and the garnet electrolyte was 100 mg. The 3^{rd}, 4^{th}, 5^{th} and 10^{th} charge-discharge curves of lithium-sulfur garnet electrolyte battery are shown in FIG. 61(a). Two plateaus were observed, corresponding to typical lithium-sulfur reaction. Until this report, 10 charge-discharge cycles were conducted for this cell. The specific capacity of the cell decayed with cycle number to 560 mAh/g after 10^{th} cycle, see FIG. 61(b). The coulombic efficiency was still ˜100% during charge-discharge cycles, displaying reversible high electrical energy utilization ratio in this cell.

### Example 37

### Interfacial Behavior Between the Sulfur Cathode and Garnet Electrolyte

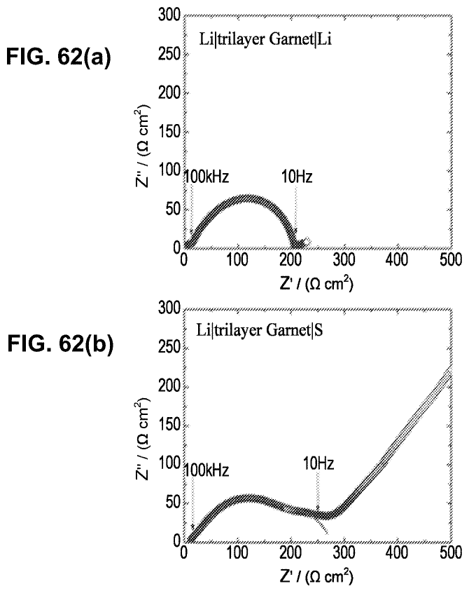

Electrochemical Impedance Spectroscopy (EIS) was used to evaluate the interfacial resistance of the sulfur cathode and garnet electrolyte. A lithium∥triple layer garnets lithium symmetric cell was fabricated to test the interface resistance between lithium and triple layer garnet. However, this was done without the ALD Al₂O₃ layer that was demonstrated previously to negate the Li-garnet interfacial impedance. Lithium foil was attached to both sides of the triple layer garnet pellet, and the symmetric electrodes were assembled in a Swagelok cell module. The EIS measurement was performed with a Gamry instruments EIS and tested from 1 MHz to 0.02 Hz. FIG. 62(a) shows the EIS results of the lithium∥triple layer garnet∥lithium symmetry electrode. An asymmetric semicircle was obtained, corresponding to the impedance of lithium-triple layer garnet interface and garnet bulk. The EIS fitting results indicated that the interface resistance of lithium-garnet was 80 ohm cm², which was much higher than the data we reported before. The reason was that the surface of triple layer garnet was not coated with the Al₂O₃ atomic layer deposition, and thus the interface resistance was significantly higher.

A lithium triple layer garnets I sulfur-carbon cell electrode was then fabricated to measure the interface resistance of the sulfur cathode and the triple layer garnet electrolyte. Lithium foil was attached onto the anode side of a triple layer garnet pellet, and the sulfur and carbon were co-infiltrated into the cathode side of the garnet electrolyte, then the cell electrode was assembled in Swagelok cell module. The EIS measurement was performed as before. FIG. 62(b) shows the EIS results of the lithium∥triple layer garnet∥sulfur-carbon cell. Around 10 Hz, an additional impedance semicircle was observed due to the interface of the sulfur cathode and garnet electrolyte, as compared to the EIS of lithium∥triple layer garnet∥lithium symmetry electrode. The interface resistance of sulfur-carbon co-infiltrated cathode and garnet electrolyte was 146 ohm cm², significantly higher than the Li-garnet symmetric interface cell. Therefore, this specific cell appears to have some issues with contact between the sulfur and the garnet electrolyte that could be improved upon.

### Example 38

### Initial Electrochemical Performance of Li—S Garnet Electrolyte Batteries

Cell #1

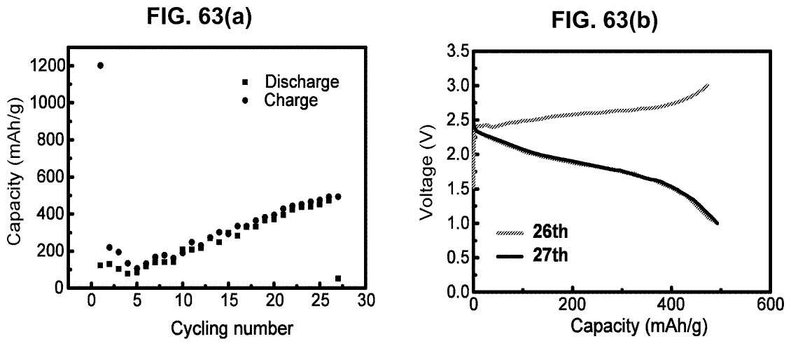

Cell No. 1 was fabricated with mass loading of sulfur was 0.2 mg, carbon mass was 0.6 mg, lithium foil mass was 16.7 mg, and garnet electrolyte mass was 100 mg. The cell performance examination was pre-conducted over 27 cycles, and the initial performance is shown in FIG. 63(a). The cell improves in performance with each charge/discharge cycle until it was stopped in the 27^{th} cycle as shown in FIG. 63(b).

Cell#2

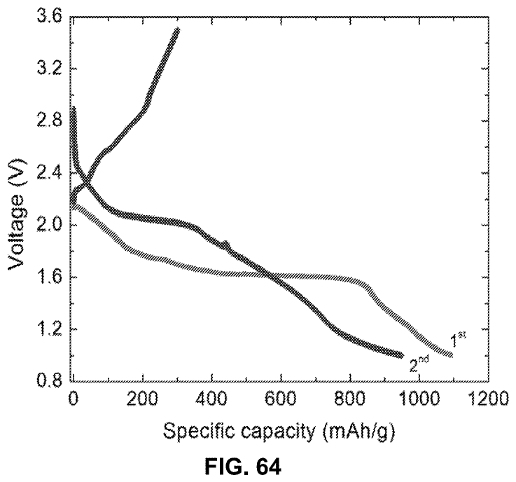

Cell No. 2 was fabricated according to the methods described above in the section “Assembling coin cell and testing the electrochemical performance of Li—S garnet electrolyte battery.” The mass loading of sulfur was 0.5 mg, carbon mass was 0.5 mg, lithium foil mass was 13.0 mg, and garnet electrolyte mass was 100 mg. The cell performance examination was pre-conducted for 2 cycles, and the charge-discharge curves are shown in FIG. 64. These show a very high initial capacity.

As used herein, a “dense” layer of an electrolyte material does not have any pathways through the dense layer, such as a pinhole or series of pores extending from one surface of the dense layer to an opposite surface. This may be achieved, for example, by creating a layer where the amount of electrolyte material present in the layer is not less than 95% of the maximum theoretical amount of electrolyte material that could fit in the volume of the dense layer.

As used herein, “S” refers to elemental sulfur. For example, S may have the chemical formula S₈ at 1 atm pressure at 25° C.

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure.

Ranges of values are disclosed herein. The ranges set out a lower limit value and an upper limit value. Unless otherwise stated, the ranges include all values to the magnitude of the smallest value (either lower limit value or upper limit value) and ranges between the values of the stated range.

All ranges disclosed herein are inclusive of their upper and lower limits, and include each value there between to the hundredth decimal place, and all ranges within those limits.

Although the present disclosure has been described with respect to one or more particular embodiments and/or examples, it will be understood that other embodiments and/or examples of the present disclosure may be made without departing from the scope of the present disclosure.

As used herein, the words “approximately”, “about”, “substantially”, “near” and other similar words and phrasings are to be understood by a person of skill in the art as allowing for an amount of variation not substantially affecting the working of the device, example or embodiment. In those situations where further guidance is necessary, the degree of variation should be understood as being 10% or less.

Having now described the invention in accordance with the requirements of the patent statutes, those skilled in this art will understand how to make changes and modifications to the present invention to meet their specific requirements or conditions. Such changes and modifications may be made without departing from the scope and spirit of the invention as disclosed herein.

The foregoing Detailed Description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Use of the word “or” should be understood to also include the meaning “and”, except where the context indicates otherwise. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the Claims

We claim:

1. A battery, comprising:
a dense central layer comprising a dense electrolyte material, the dense central layer having a first surface, and a second surface opposite the first surface;
a first electrode disposed on the first surface of the dense central layer, the first electrode hosting a sulfur-based material, the first electrode comprising:
a first porous electrolyte material having a first network of pores therein and conductive material comprising carbon located on a surface of the pores;
a cathode material infiltrated throughout the first network of pores and deposited on the conductive material comprising carbon, wherein each of the first porous electrolyte material and the cathode material percolate through the first electrode;
a second electrode disposed on the second surface of the dense central layer, the second electrode being a lithium-metal anode comprising:
a second porous electrolyte material having a second network of pores therein;
an anode material infiltrated throughout the second network of pores, the anode material comprising lithium, wherein each of the second porous electrolyte material and the anode material percolate through the second electrode;
wherein each of the dense electrolyte material, the first porous electrolyte material, and the second porous electrolyte material are independently selected from garnet materials, and the first porous electrolyte material and the second porous electrolyte material and the dense central layer are sintered together.

2. The battery of claim 1, wherein each of the dense electrolyte material, the first porous electrolyte material, and the second porous electrolyte material are the same.

3. The battery of claim 1, wherein each of the dense electrolyte material, the first porous electrolyte material, and the second porous electrolyte material are different.

4. The battery of claim 1, wherein the dense central layer has a thickness of 1 to 30 microns, the first electrode has a thickness of 10 to 200 microns, and the second electrode has a thickness of 10 to 200 microns.

5. The battery of claim 1, wherein each of the dense electrolyte material, the first porous electrolyte material, and the second porous electrolyte material are independently selected from cation-doped Li₅ La₃M¹₂O₁₂, where M¹ is Nb, Zr, Ta, or combinations thereof, cation-doped Li₆La₂BaTa₂O₁₂, cation-doped Li₇La₃Zr₂O₁₂, and cation-doped Li₆BaY₂M¹₂O₁₂, where cation dopants are barium, yttrium, zinc, iron, gallium, and combinations thereof.

6. The battery of claim 1, wherein each of the dense electrolyte material, the first porous electrolyte material, and the second porous electrolyte material are independently selected from Li₅La₃Nb₂O₁₂, Li₅La₃Ta₂O₁₂, Li₇La₃Zr₂O₁₂, Li₆La₂SrNb₂O₁₂, Li₆La₂BaNb₂O₁₂, Li₆La₂SrTa₂O₁₂, Li₆La₂BaTa₂O₁₂, Li₇Y₃Zr₂O₁₂, Li_{6.4}Y₃Z₁₄Ta_{0.6}O₁₂, Li_{6.5}La_{2.5}Ba_{0.5}TaZrO₁₂, Li₆BaY₂M¹₂O₁₂, Li₇Y₃Zr₂O₁₂, Li_{6.75}BaLa₂Nb_{1.75}Zn_{0.25}O₁₂, or Li_{6.75}BaLa₂Ta_{1.75}Zn_{0.25}O₁₂, and combinations thereof.

7. The battery of claim 1, wherein
the anode material is Li metal, or
the anode material is Li metal and the cathode material is S.

8. The battery of claim 1, wherein
(i) the sulfur-based material is selected from the group consisting of: sulfides, S, Li₂S, Li₂S₂, Li₂S₃Li₂S₄, Li₂S₆, and Li₂S₈, and combinations thereof,
(ii) the sulfur-based material is selected from the group consisting of: sulfides, S, Li₂S, Li₂S₂ Li₂S₃, Li₂S₄, Li₂S₆, and Li₂S₈, and combinations thereof and the cathode further comprises a conductive material comprising carbon, or
(iii) the sulfur-based material is selected from the group consisting of: sulfides, S, Li₂S, Li₂S₂, Li₂S₃, Li₂S₄ Li₂S₆, and Li₂S₈, and combinations thereof and the cathode further comprises a conductive material selected from the group consisting of conductive polymers, carbon nanotubes, or carbon fibers.

9. The battery of claim 1 further comprising a current collector wherein the current collector is attached to the first or second electrode with a carbon sponge.

10. The battery of claim 1, wherein the conductive material comprising carbon is selected from the group consisting of conductive polymers, carbon nanotubes, and carbon fibers.

11. The battery of claim 8, wherein the cathode material and the conductive material comprising carbon together are filled to 40 to 60 percent of the volume of the pores in the first porous electrolyte material.

12. The battery of claim 11, wherein the cathode material is S.

13. The battery of claim 1, wherein the conductive material comprising carbon forms a coating on the surface of the pores.

14. The battery of claim 13, wherein the coating is a conformal coating.

15. A method of fabricating a battery or a battery component having a solid state electrolyte, the method comprising:
providing a scaffold comprising:
a dense central layer comprising a dense electrolyte material, the dense central layer having a first surface, and a second surface opposite the first surface;
a first porous layer comprising a first porous electrolyte material, the first porous layer disposed on the first surface of the dense central layer, the
first porous electrolyte material having a first network of pores therein;
wherein each of the dense electrolyte material and the first porous electrolyte material are independently selected from garnet materials;
locating a conductive material comprising carbon on a surface of the pores of the first porous layer;
infiltrating sulfur-based material into the first porous layer to deposit on the conductive material comprising carbon and form a cathode;
wherein the dense central layer and the first porous layer are sintered together.

16. The method of claim 15, wherein infiltrating sulfur-based material into the first porous layer is performed after infiltrating carbon into the first porous layer.

17. The method of claim 15, wherein infiltrating carbon into the first porous layer comprises:
(i) exposing the first porous layer to carbon nanotubes in solution;
(ii) growing carbon nanofibers inside the first porous layer by microwave synthesis;
(iii) exposing the first porous layer to graphene flakes in solution;
(iv) exposing the first porous layer to a solution of polyacrylonitrile in dimethylformamide, and subsequently carbonizing the polyacrylonitrile by exposure to heat, or
(v) exposing the first porous layer to a solution of polyacrylonitrile in dimethylformamide, and subsequently carbonizing the polyacrylonitrile by exposure to a temperature of 500 to 700° C. for time period in the range of 30 minutes to 3 hours.

18. The method of claim 15, wherein infiltrating sulfur-based material into the first porous layer is performed:
(i) by vapor deposition;
(ii) by exposure to gaseous sulfur;
(iii) by exposure to gaseous sulfur in an inert atmosphere or vacuum for a time period of 30 minutes to 6 hours;
(iv) by exposure to gaseous sulfur in an inert atmosphere or vacuum for a time period of 30 minutes to 6 hours at a temperature of 225 to 700° C.;
(v) by exposure to gaseous sulfur in an argon atmosphere at a temperature of 200 to 300° C. for a time period in the range of 30 minutes to 2 hours;
(vi) by contacting the first porous layer with a sulfur-containing liquid;
(vii) by contacting the first porous layer with a solution of S dissolved in CS₂; or
(viii) by contacting the first porous layer with a solution of S dissolved in CS₂, followed by evaporating the CS₂ by vacuum drying.

19. The method of claim 15, wherein, after infiltrating carbon into the first porous layer and infiltrating the sulfur-based material into the first porous layer, the cathode material and the conductive material comprising carbon together fill 40 to 60 percent of the volume of pores in the first porous electrolyte material.

20. The method of claim 19, wherein, the cathode material is S.

21. The method of claim 15, wherein:
the scaffold further comprises a second porous layer comprising a second porous electrolyte material, the second porous layer disposed on the second surface of the dense central layer, the second porous electrolyte material having a second network of pores therein;
the method further comprising infiltrating lithium into the second porous layer.

22. The method of claim 15, wherein the sulfur infiltrated into the first porous layer is S, Li₂S, and combinations thereof.
